(19) United States
(12) Patent Application Publication
(10) Pub. No.: US 2026/0298959 A1
(43) Pub. Date: Oct. 1, 2026

(54) SAMPLE ANALYZER AND REAGENT CONTAINER

(71) Applicant: SYSMEX CORPORATION, Hyogo (JP)

(72) Inventors: Noriyuki Nakanishi, Hyogo (JP); Takaaki Nagai, Hyogo (JP); Ryosuke Fujii, Hyogo (JP)

(73) Assignee: SYSMEX CORPORATION, Hyogo (JP)

(21) Appl. No.: 19/578,901

(22) Filed: Mar. 26, 2026

(30) Foreign Application Priority Data
Mar. 28, 2025 (JP) 2025-056502

(51) Int. Cl. G01N 35/00; B01L 3/00; G01N 35/10

(52) U.S. Cl. CPC G01N 35/0099; B01L 3/52; G01N 35/1002; G01N 35/1009; G01N 35/1079; B01L 2300/044

(57) ABSTRACT

A sample analyzer includes: a measurement sample preparator configured to prepare a measurement sample from a sample aspirated by a sample aspiration tube and a reagent aspirated by a reagent aspiration tube from a reagent container; and a reagent container holder configured to hold the reagent container inserted therein. The reagent container includes: a reagent storage bag configured to contain the reagent, the reagent storage bag being made of flexible material and having an opening that allows the reagent aspiration tube to enter the reagent storage bag, and a sealing plug configured to seal the opening, the sealing plug being penetrable by the reagent aspiration tube. The sample analyzer further includes: a pressing part configured to press the reagent storage bag from an outside in a state where the reagent storage bag is in the reagent container holder and the opening is sealed by the sealing plug.

### CROSS REFERENCE TO RELATED APPLICATIONS

This application claims priority from prior Japanese Patent Application No. 2025-056502, filed on Mar. 28, 2025, entitled “SAMPLE ANALYZER AND REAGENT CONTAINER”, the entire content of which is incorporated herein by reference.

### TECHNICAL FIELD

The present disclosure relates to a sample analyzer, and more particularly to a sample analyzer and a reagent container in which a flexible reagent storage bag is used.

### BACKGROUND

International Publication No. WO 2011/105247 discloses a sample analyzer comprising: a reagent container holder configured to hold a reagent container; and a reagent aspiration tube configured to enter an aspiration tube entry part of the reagent container held by the reagent container holder from above and to aspirate a reagent in the reagent container.

In a sample analyzer disclosed in International Publication No. WO 2011/105247, a reagent aspiration tube is inserted into a reagent container held in a reagent container holder, and a reagent is aspirated from the reagent container each time a sample is measured. However, when the reagent is aspirated from the reagent container each time the sample is measured, outside air flows into the reagent container as the remaining amount of the reagent decreases, and the reagent remaining in the reagent container comes into contact with the outside air. The outside air may contain bacteria, which promotes deterioration of the reagent.

### SUMMARY

An embodiment of the disclosure provides a sample analyzer comprising: a measurement sample preparator comprising a sample aspiration tube configured to aspirate a sample from a sample container and a reagent aspiration tube configured to aspirate a reagent from a reagent container, the measurement sample preparator configured to prepare a measurement sample from the sample aspirated by the sample aspiration tube and the reagent aspirated by the reagent aspiration tube; a detector configured to detect signals corresponding to analytes in the measurement sample; a controller comprising a processor, the controller configured to analyze the signals detected by the detector; and a reagent container holder configured to hold the reagent container inserted therein, wherein the reagent container includes: a reagent storage bag configured to contain the reagent, the reagent storage bag being made of flexible material and having an opening that allows the reagent aspiration tube to enter the reagent storage bag, and a sealing plug configured to seal the opening, the sealing plug being penetrable by the reagent aspiration tube, and the sample analyzer further comprises: a pressing part configured to press the reagent storage bag from an outside in a state where the reagent storage bag is in the reagent container holder and the opening is sealed by the sealing plug.

According to the sample analyzer of the present disclosure, inflow of air into the reagent container after opening can be suppressed, and the reagent container can be easily handled. According to the sample analyzer of the present disclosure, for example, since a shape of the flexible reagent storage bag is corrected in the reagent container holder, damage to the reagent storage bag caused by the reagent aspiration tube can be effectively suppressed.

### BRIEF DESCRIPTION OF THE DRAWINGS

FIG. 1 is a diagram schematically showing a state in which a reagent container is held in a sample analyzer as an example of an embodiment and an aspiration tube is inserted into the reagent container.

FIG. 2 is a perspective view of a reagent container as an example of an embodiment seen from the front.

FIG. 3 is a perspective view of the reagent container as an example of an embodiment seen from the rear.

FIG. 4 is an exploded perspective view of the reagent container as an example of an embodiment.

FIG. 5 is a cross-sectional view taken along line AA in FIG. 3.

FIG. 6 is a plan view of the reagent container as an example of an embodiment.

FIG. 7 is a view of a large-capacity reagent container (A) and a small-capacity reagent container (B) seen from the front.

FIG. 8 is a side view of the large-capacity reagent container (A) and the small-capacity reagent container (B).

FIG. 9 is a perspective view of a sample analyzer as an example of an embodiment.

FIG. 10 is a schematic diagram for explaining a configuration of the sample analyzer.

FIG. 11 is a schematic diagram for explaining a configuration of the sample analyzer.

FIG. 12 is a perspective view of a reagent aspiration unit of the sample analyzer.

FIG. 13 is a perspective view of the reagent aspiration unit, showing a state where a reagent aspiration tube is at an upper position.

FIG. 14 is a perspective view of the reagent aspiration unit, showing a state where a reagent container is held in a reagent container holder.

FIG. 15 is a diagram showing a part of a cross section taken along line BB in FIG. 14.

FIG. 16 is a diagram showing a state (A) before a protruding member engages with a notch of a frame member and a state (B) where the protruding member has been engaged.

FIG. 17 is a cross-sectional view of a reagent aspiration part (a cross-sectional view cut in a vertical direction along a depth direction of the reagent aspiration part), showing a state where the reagent container is held in the reagent container holder and the reagent aspiration tube is at the upper position.

FIG. 18 is a cross-sectional view of the reagent aspiration part, showing a state where the reagent container is held in the reagent container holder and the reagent aspiration tube is at a lower position.

FIG. 19 is a cross-sectional view showing a state (A) before an opening of the reagent container is sealed by a sealing body of the reagent aspiration tube and a state (B) where the opening has been sealed.

FIG. 20 is a diagram showing a cross section of the reagent container holder of the reagent aspiration unit, cut horizontally along the depth direction.

FIG. 21 is a cross-sectional view of the reagent container holder.

FIG. 22 is a cross-sectional view of the reagent container holder, showing a state where the reagent container is held.

FIG. 23 is a diagram showing inner surface portions of a side wall and a rear wall of the reagent container holder extracted from FIG. 21.

FIG. 24 is a perspective view of the inner surface of the side wall of the reagent container holder on which a pressing part is formed.

FIG. 25 is a diagram showing a first modification of the reagent container holder.

FIG. 26 is a diagram showing a second modification of the reagent container holder.

FIG. 27 is a diagram showing a third modification of the reagent container holder.

FIG. 28 is a diagram showing a fourth modification of the reagent container holder.

FIG. 29 is a diagram showing a fifth modification of the reagent container holder.

FIG. 30 is a perspective view of a reagent kit as an example of an embodiment seen from the front.

FIG. 31 is a perspective view of the reagent kit as an example of an embodiment seen from the rear.

FIG. 32 is a perspective view of a protective member constituting the reagent kit seen from the front.

FIG. 33 is a perspective view of the protective member constituting the reagent kit seen from the rear.

FIG. 34 is a side view of the protective member constituting the reagent kit.

FIG. 35 is a view of the reagent kit seen from the front, showing a stationary state (A) and a state (B) where an external force in a vertical direction is applied.

FIG. 36 is a view of a small-capacity reagent kit as an example of an embodiment seen from the front.

FIG. 37 is a diagram showing a first modification of the reagent kit.

FIG. 38 is a diagram showing a second modification of the reagent kit.

FIG. 39 is a diagram showing a third modification of the reagent kit.

FIG. 40 is a diagram showing a fourth modification of the reagent kit.

FIG. 41 is a diagram showing a fifth modification of the reagent kit.

### DETAILED DESCRIPTION

Embodiments of the present disclosure provide a sample analyzer capable of suppressing inflow of air into a reagent container after opening and facilitating handling of the reagent container.

Embodiments of the sample analyzer according to the present disclosure will be described in detail below with reference to the drawings. The embodiments described below are merely examples, and the present disclosure is not limited to the following embodiments. Furthermore, the present disclosure includes forms in which individual components of a plurality of embodiments and modifications described below are selectively combined.

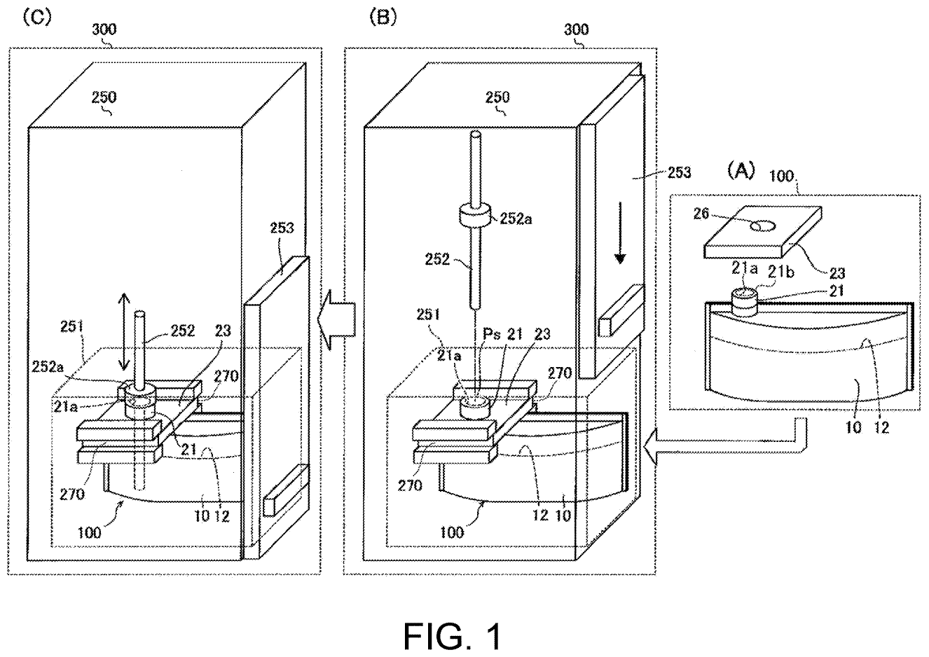

FIG. 1 is a diagram schematically showing a state where a reagent container 100 is held in a sample analyzer 300 as an example of an embodiment. (A) of FIG. 1 is a perspective view of the reagent container 100, (B) of FIG. 1 is a diagram showing a state where the reagent container 100 is held in a reagent container holder 251 of the sample analyzer 300, and (C) of FIG. 1 is a diagram showing a state where a reagent aspiration tube 252 is inserted into the reagent container 100 held in the reagent container holder 251 to aspirate a reagent 12.

As shown in FIG. 1, the sample analyzer 300 is an apparatus in which the reagent container 100 including the flexible reagent storage bag 10 containing the reagent 12 is used, and comprises a reagent aspiration part 250 including the reagent aspiration tube 252 and the reagent container holder 251 configured to hold the reagent container 100. The reagent aspiration part 250 constitutes a part of a measurement sample preparator described later. The measurement sample preparator comprises the reagent aspiration tube 252 configured to aspirate the reagent 12 from the reagent container 100, and prepares a measurement sample using a sample and the reagent 12. The sample is, for example, blood. The reagent container holder 251 is provided at a position accessible from a front of the sample analyzer 300. As will be described in detail later, the sample analyzer 300 is a blood cell counter that detects signals corresponding to blood cells in the measurement sample, analyzes the detection signals, and counts the blood cells.

As shown in (A) of FIG. 1, the reagent container 100 comprises the flexible reagent storage bag 10 having an opening 21a, and a sealing plug 21b configured to seal the opening 21a. The reagent container 100 comprises a cylindrical plug member 21 attached to the reagent storage bag 10, and the opening 21a that allows the reagent aspiration tube 252 to enter the reagent storage bag 10 is formed by the plug member 21. In the reagent storage bag 10, an inside and an outside communicate only through the opening 21a, and the reagent 12 and air cannot pass through parts other than the opening 21a. The plug member 21 is attached to an end portion of the reagent storage bag 10, and the reagent container 100 is handled in a state where the opening 21a of the plug member 21 is directed vertically upward. Hereinafter, a part where the plug member 21 is provided is referred to as an upper portion of the reagent storage bag 10.

The reagent container 100 further comprises a frame member 23 provided on the upper portion of the reagent storage bag 10. The frame member 23 is a member at least partially formed in a plate shape and has a fixing part 26 into which the plug member 21 is inserted. The frame member 23 is attached to the reagent storage bag 10 via the plug member 21. Further, the frame member 23 is made of a material having higher rigidity than the reagent storage bag 10. The plug member 21 is arranged to be offset to one end side in a direction orthogonal to a vertical direction and a thickness direction of the reagent storage bag 10.

As shown in (B) of FIG. 1, the reagent container 100 is inserted into the reagent container holder 251 of the sample analyzer 300 in a state where the opening 21a of the plug member 21 is directed upward. The reagent container 100 is inserted into the reagent container holder 251 with the plug member 21 side of the reagent storage bag 10 as a front end. The reagent aspiration tube 252 is provided immediately above the reagent container holder 251 so as to be movable in the vertical direction. The reagent container 100 is inserted to a set position Ps where a center of the opening 21a and a central axis of the reagent aspiration tube 252 coincide with each other. The reagent container holder 251 is a place for aspirating the reagent 12 and is configured as a part of the reagent aspiration part 250.

The reagent container holder 251 has guide grooves 270 for enabling smooth insertion of the reagent container 100. Each guide groove 270 is a guide structure that guides the frame member 23 so that the reagent container 100 slides into an inside of the reagent container holder 251. In an upper portion of the reagent container holder 251, a pair of guide grooves 270 are provided so as to sandwich the reagent container 100 from both sides in the thickness direction. A position of the reagent container 100 is restricted in the reagent container holder 251 by the frame member 23 fitting into the guide grooves 270. Then, the reagent container 100 is arranged at the set position Ps by a tip of the frame member 23 coming into contact with a groove wall at a back of the guide grooves 270. That is, the frame member 23 has a shape corresponding to an internal shape of the reagent container holder 251.

As shown in (C) of FIG. 1, after the reagent container 100 is held in the reagent container holder 251, by operating an operation part 253, the reagent aspiration tube 252 penetrates the sealing plug 21b and is inserted into the reagent storage bag 10 through the opening 21a. The sample analyzer 300 comprises the operation part 253 configured to move the reagent aspiration tube 252 in the vertical direction. In the present embodiment, the operation part 253 also serves as a front cover that blocks an entrance of the reagent container holder 251. Therefore, after the reagent container 100 is held in the reagent container holder 251, by lowering the operation part 253, which is the front cover, to close the entrance of the reagent container holder 251, the reagent aspiration tube 252 descends and is inserted into the reagent storage bag 10.

The reagent aspiration tube 252 comprises a sealing body 252a that seals the opening 21a in a state where the reagent aspiration tube 252 penetrates the sealing plug 21b and enters the inside of the reagent storage bag 10. Since the reagent aspiration tube 252 has rigidity capable of penetrating the sealing plug 21b of the reagent container 100, the reagent aspiration tube 252 can break through the sealing plug 21b and enter the inside of the reagent storage bag 10 as the reagent aspiration tube 252 descends. At this time, although the sealing plug 21b is opened, the sealing body 252a is pressed against a peripheral edge of the opening 21a to block the opening 21a, whereby contact between the reagent 12 and air outside the reagent storage bag 10 (outside air) can be suppressed.

The sealing body 252a is provided at an intermediate portion in an axial direction of the reagent aspiration tube 252 and at a position where the opening 21a of the plug member 21 can be sealed. The sealing body 252a is made of, for example, elastically deformable rubber and moves in the vertical direction together with the reagent aspiration tube 252.

In the sample analyzer 300, once the reagent aspiration tube 252 is inserted into the opening 21a of an unused reagent container 100 and the sealing body 252a is pressed against the peripheral edge of the opening 21a, the reagent aspiration tube 252 can thereafter remain inserted until the reagent 12 in the reagent storage bag 10 is completely consumed. Although the sealing plug 21b is opened, the inside of the reagent storage bag 10 is hermetically sealed by the sealing body 252a, so that contact between the reagent 12 in the reagent storage bag 10 and the outside air is suppressed. As a result, quality deterioration of the reagent 12 can be suppressed, and the reagent container 100 can be used over a long period of time with the reagent aspiration tube 252 remaining inserted.

Note that in a case where a non-deformable rigid reagent container is used, if reagent aspiration is performed in a sealed state, internal pressure of the reagent container decreases as the reagent decreases, and the internal pressure becomes equilibrated with aspiration pressure, making it impossible to aspirate the reagent; thus, the inside of the container must be open to the atmosphere. Then, as the remaining amount of reagent decreases, outside air flows into the reagent container. In contrast, since the reagent container 100 comprises the flexible reagent storage bag 10, the reagent storage bag 10 itself contracts and deforms upon aspiration of the reagent 12, whereby a decrease in internal pressure can be avoided, and as a result, the reagent 12 can be aspirated even in a sealed state. Accordingly, even if the remaining amount of reagent decreases, outside air does not flow into the reagent container 100. The reagent storage bag 10 is formed of a material and in a shape that are deformable by aspirating the reagent in the sealed state.

As described above, according to the reagent container 100, since the opening 21a is sealed by the sealing body 252a, deterioration of the reagent 12 due to contact of the reagent 12 in the reagent storage bag 10 with outside air can be suppressed. If the use of the reagent 12 can be continued for a longer period with the reagent container 100 installed in the sample analyzer 300, the capacity of the reagent storage bag 10 can be increased, and the reagent can be aspirated from one reagent container 100 a greater number of times. As a result, for example, the replacement frequency of the reagent container 100 can be reduced, and usability is improved.

On the other hand, when the flexible reagent storage bag 10 is used, the position of the opening 21a when inserting the reagent aspiration tube 252 into the reagent storage bag 10 or the position of the opening 21a in a state where the reagent aspiration tube 252 is inserted can be easily changed by an external force. For this reason, positioning of the opening 21a and prevention of displacement of the opening 21a are important in sealing the reagent storage bag 10. In the present embodiment, by the functions of the frame member 23 of the reagent container 100 and the guide grooves 270 of the sample analyzer 300, relative positions of the opening 21a and the sealing body 252a are accurately determined, and the opening 21a can be reliably sealed. Further, since movement of the reagent container 100 is restricted, while the reagent aspiration tube 252 is inserted into the reagent storage bag 10, the sealed state of the reagent storage bag 10 by the sealing body 252a is maintained.

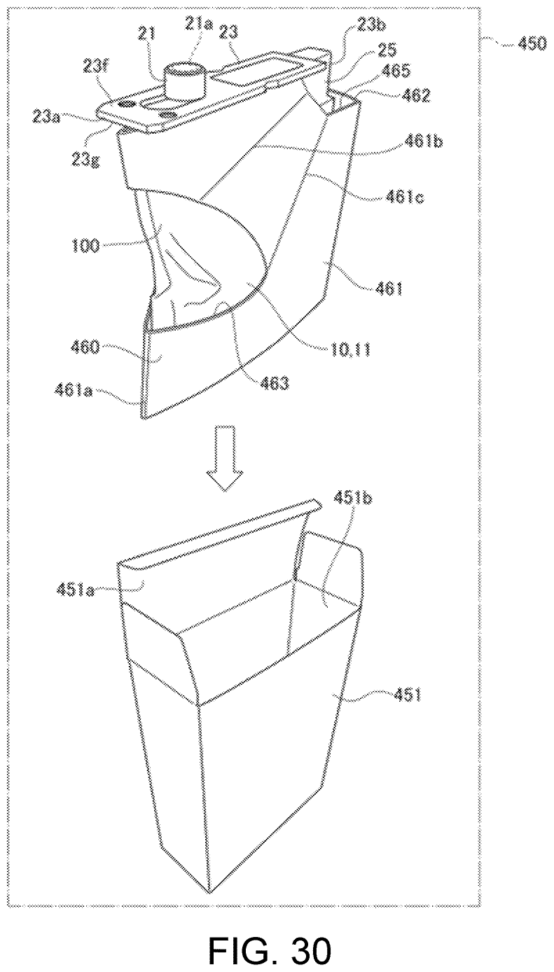

Although details will be described later, a flexible reagent storage bag may deform such that the bag is recessed inward when an external force is applied due to vibration or impact during transportation, for example. If the reagent storage bag is held in the sample analyzer in such a deformed state, the descending reagent aspiration tube may pierce the recessed portion of the bag, potentially damaging the reagent storage bag and causing the reagent to leak. In order to deal with such a problem, the sample analyzer 300 comprises, in the reagent container holder 251, a pressing part that presses the reagent storage bag 10 with the opening 21a sealed from an outside to correct the shape of the reagent storage bag 10. Furthermore, in order to suppress deformation of the reagent storage bag 10 during transportation, the reagent container 100 is protected by a protective member 460 and provided in a state of a reagent kit 450 (see FIG. 30 and the like).

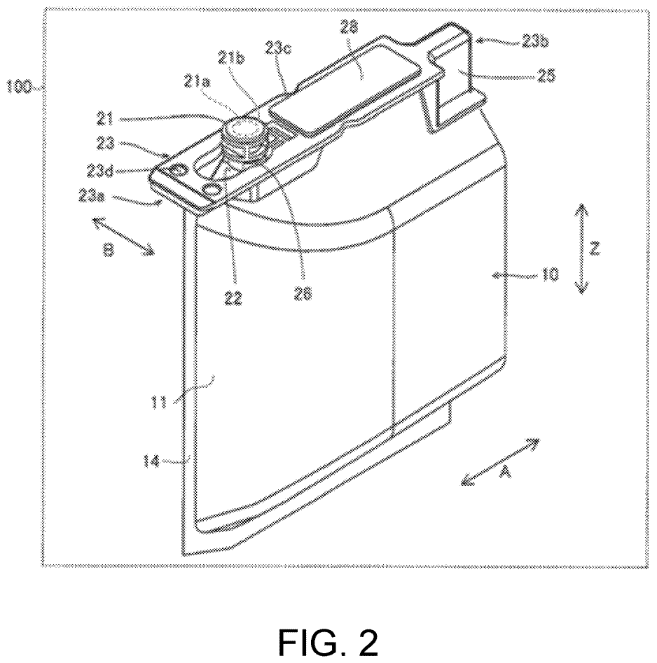

Hereinafter, the configuration of the reagent container 100 will be described in detail with reference to FIGS. 2 to 6.

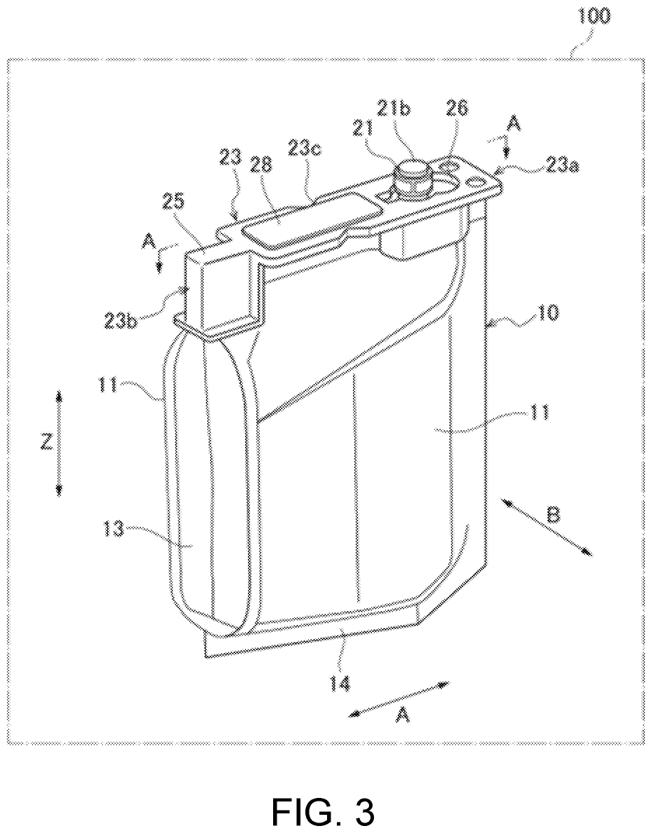

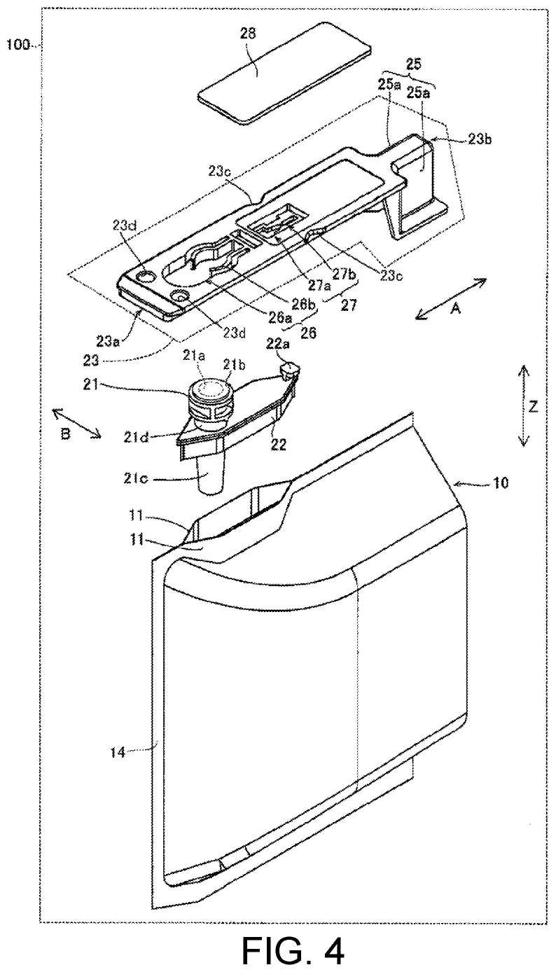

FIG. 2 is a perspective view of the reagent container 100 seen from the front, and FIG. 3 is a perspective view of the reagent container 100 seen from the rear. FIG. 4 is an exploded perspective view of the reagent container 100. Hereinafter, for convenience of description, the vertical direction is referred to as a Z direction, the direction in which the reagent container 100 is inserted into the reagent container holder 251 (see FIG. 1) is referred to as an A direction, and a direction orthogonal to the Z direction and the A direction is referred to as a B direction. Note that the A direction may be referred to as a front-rear direction of the reagent container 100, and the B direction may be referred to as a thickness direction of the reagent container 100.

As shown in FIGS. 2 to 4, the reagent container 100 comprises the reagent storage bag 10, the plug member 21 attached to the reagent storage bag 10, and the frame member 23 attached to the reagent storage bag 10 via the plug member 21. In the present embodiment, as described above, the opening 21a that allows the reagent aspiration tube 252 (see FIG. 1) to enter the reagent storage bag 10 is formed by the plug member 21, and the plug member 21 is provided with the sealing plug 21b that blocks the opening 21a.

The frame member 23 has a rectangular shape in a plan view and is provided above the reagent storage bag 10. A length of the frame member 23 in the A direction is slightly longer than a length of the reagent storage bag 10 in the A direction. On the other hand, since the reagent storage bag 10 bulges in the B direction, the length of the reagent storage bag 10 in the B direction is longer than the length of the frame member 23 in the B direction. Further, the frame member 23 is formed with a grip part 25 to be gripped by a user when handling the reagent container 100.

### Reagent Storage Bag

The reagent storage bag 10 is a soft packaging material container that is easily deformed by an external force, and is a flat container made of a flexible sheet. The reagent storage bag 10 is a flexible bag also called a pouch. The reagent storage bag 10 is a gusset bag having a first surface part, a second surface part opposite to the first surface part, and a gusset folded between the first surface part and the second surface part and functioning as a gusset, and while it can be formed by folding back a single sheet, it is preferably composed of a plurality of sheets. The reagent storage bag 10 is composed of, for example, three sheets. The reagent storage bag 10 has two wall surface sheets 11 constituting a pair of wall surface parts arranged to face each other. The reagent storage bag 10 further comprises a gusset sheet 13 inserted between the two wall surface sheets 11.

The wall surface sheet 11 is, for example, a sheet formed in a substantially rectangular shape. The wall surface sheet 11 may have a substantially square shape or a substantially rectangular shape slightly longer in the vertical direction or the front-rear direction. The two wall surface sheets 11 have the same shape and the same dimensions as each other. The shape of the reagent storage bag 10 mainly depends on the shape of the wall surface sheets 11. The gusset sheet 13 is a sheet smaller than the wall surface sheet 11 and is folded between the two wall surface sheets 11. In the case of a gusset bag, generally, the capacity of the reagent storage bag 10 can be increased by enlarging the gusset sheet 13.

The reagent storage bag 10 has joints 14 where the wall surface sheets 11 are thermally welded to each other, and where the wall surface sheets 11 and the gusset sheet 13 are thermally welded. Note that the joints 14 may be formed using an adhesive, but are preferably formed by thermal welding of each sheet. By bonding these sheets together, an internal space whose peripheral edge is sealed is formed. The gusset sheet 13 is inserted between the two wall surface sheets 11 in a state of being folded in two, and a peripheral edge thereof is joinable to an inner surface of each wall surface sheet 11 so as to be unfoldable. Although details will be described later, the plug member 21 is welded to each sheet in a state where a base part 22 is inserted between the two wall surface sheets 11.

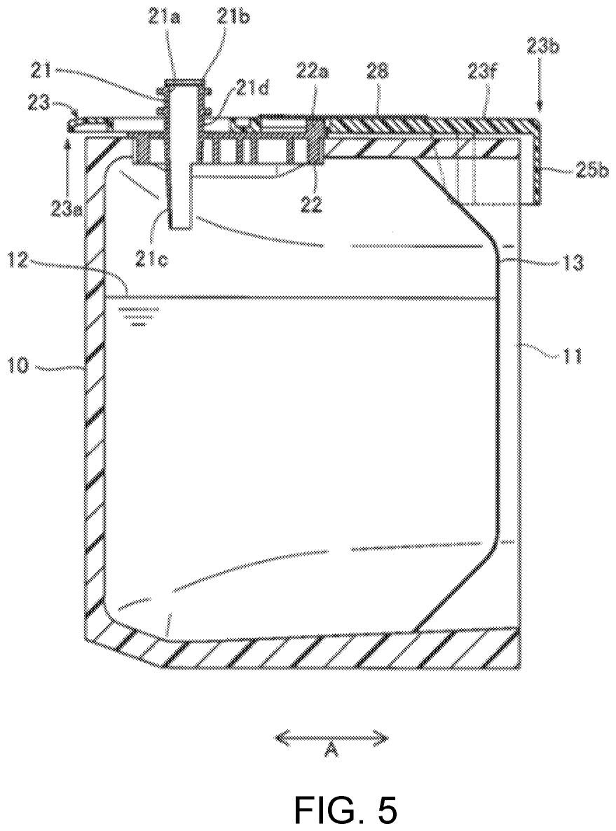

Hereinafter, FIG. 5 will be referred to as appropriate in addition to FIGS. 2 to 4. FIG. 5 is a cross-sectional view taken along line AA in FIG. 3. As shown in FIG. 5, the reagent 12 contained in the reagent storage bag 10 is a liquid. The reagent storage bag 10 is filled with the reagent 12 in an amount of, for example, 60% or more and 90% or less relative to the volume of the internal space of the bag. The reagent 12 is an aqueous solution containing a component corresponding to an analysis item by sample analysis. The reagent container 100 contains a staining liquid for staining predetermined cells as the reagent 12. The staining liquid contains, for example, various fluorescent dyes for staining white blood cells, red blood cells, or platelets in blood, or organelles in blood cells.

A storage period of the reagent 12 is, for example, 75 days or more and one year or less after the reagent aspiration tube 252 is inserted into the opening 21a. The storage period is a length of a period during which measurement accuracy using the reagent 12 by the sample analyzer 300 can be guaranteed. In the present embodiment, in a state where the reagent aspiration tube 252 is inserted into the opening 21a and the inside of the reagent storage bag 10 is hermetically sealed, measurement accuracy is maintained over a period of 75 days or more and one year or less. Since deterioration of the reagent 12 can be suppressed by sealing the reagent storage bag 10, reagent quality can be maintained stably over a longer period. As a result, the replacement frequency of the reagent container 100 can be reduced, and a burden on a user related to the replacement work can be reduced.

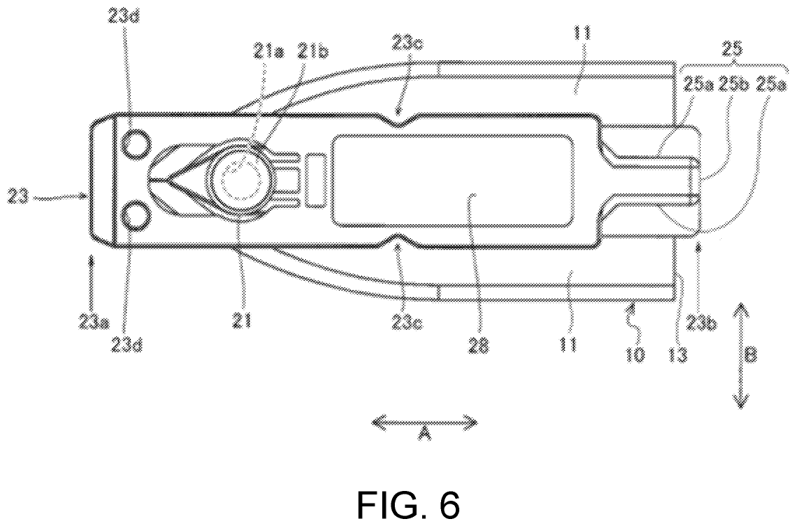

Hereinafter, FIG. 6 will be referred to as appropriate in addition to FIGS. 2 to 4. FIG. 6 is a plan view of the reagent container 100. As shown in FIGS. 3 and 6, the reagent storage bag 10 is configured such that the gusset sheet 13 unfolds by filling the reagent 12, and the two wall surface sheets 11 bulge away from each other. In the present embodiment, a side of the reagent storage bag 10 where the gusset sheet 13 is provided is referred to as a rear side, and a side opposite to the gusset sheet 13 is referred to as a front side; at a front end portion of the reagent storage bag 10, the two wall surface sheets 11 are joined to each other without the gusset sheet 13 interposed therebetween. For this reason, the front end portion of the reagent storage bag 10 and the vicinity thereof have a small thickness and are tapered.

The thickness of the reagent storage bag 10 increases as it moves away from the front end portion, and for example, has a similar thickness from a central portion in the front-rear direction to a rear end portion, or the thickness gradually increases toward the rear end portion. The thickness (length in the B direction) of the reagent storage bag 10 is smaller than the length of the frame member 23 in the B direction at the front end portion of the reagent storage bag 10, but is larger than the length of the frame member 23 in the B direction at the central portion in the front-rear direction. In a plan view of the reagent container 100, the reagent storage bag 10 protrudes outward from both widthwise ends of the frame member 23 except for the front end portion and the vicinity thereof.

The wall surface sheet 11 and the gusset sheet 13 may be composed of a laminated film having gas barrier properties and light-shielding properties. The gas barrier property is a property that makes it difficult for gas to permeate. In the present specification, the gas barrier property refers to the difficulty of air, especially oxygen, to permeate. The light-shielding property is a property that makes it difficult for light to permeate. By using a laminated film having gas barrier properties and light-shielding properties, it is possible to suppress deterioration of the reagent 12 contained in the reagent container 100 due to outside air and deterioration due to extraneous light such as sunlight. As a result, deterioration of the reagent 12 can be suppressed over a long period.

The laminated film includes, for example, at least one base material layer and at least one gas barrier layer. Further, the laminated film preferably includes a light-shielding layer made of a light-shielding material. The laminated film may further include a protective layer that protects an outer surface of the gas barrier layer. When a material having both gas barrier properties and light-shielding properties is used for the gas barrier layer, the gas barrier layer and the light-shielding layer may be the same layer. The number of layers of the laminated film is two or more, but may be 3 to 9 or 10 or more, and is not particularly limited.

The laminated film comprises, for example, a laminated structure of nylon (15 μm)/aluminum foil (9 μm)/polyethylene (9 μm) in order from an outside of the reagent storage bag 10. In this case, nylon functions as a protective layer, the aluminum foil functions as a gas barrier layer and a light-shielding layer, and polyethylene functions as a base material layer. The reagent storage bag 10 is formed in a bag shape by joining the polyethylene layers of each sheet to each other by thermal welding. The laminated film is a metal foil laminate film in which a gas barrier layer made of a metal foil is laminated between resin layers.

In addition to the above, for example, a resin-based multilayer barrier film, a coating-based film, a vapor-deposited film, an organic-inorganic composite film, or the like can be used for the laminated film. The resin-based multilayer barrier film is a film having a structure in which gas barrier layers of a resin material are laminated. Examples of resin materials having excellent gas barrier properties include PVDC (polyvinylidene chloride), PVA (polyvinyl alcohol), and EVOH (ethylene-vinyl alcohol copolymer). The coating-based film is a film having a structure in which a gas barrier material is coated (formed into a film) on a base material layer. Examples of the gas barrier material to be formed into a film include PVDC, PVA, and EVOH. The vapor-deposited film is a film having a structure in which a gas barrier material is vapor-deposited on a base material layer. Examples of the gas barrier material to be vapor-deposited include metals such as aluminum and steel, or inorganic oxides such as alumina and silica. Examples of the organic-inorganic composite film include a laminated film having a structure in which a gas barrier layer of an organic material (resin material) and a gas barrier layer of an inorganic material are separately laminated, and a film provided with a gas barrier layer in which an inorganic material is dispersed in an organic binder.

### Plug Member

As shown in FIGS. 2 to 4, the plug member 21 is attached to the reagent storage bag 10 and forms an opening 21a leading to the inside of the reagent storage bag 10. The plug member 21 has a cylindrical part 21d through which the reagent aspiration tube 252 passes, and a base part 22 sandwiched between the two wall surface sheets 11. The plug member 21 is attached to the reagent storage bag 10 by the base part 22 being joined to each wall surface sheet 11 by the joint 14 of the reagent storage bag 10. In other words, the joint 14 is formed by thermally welding each sheet and the base part 22 in a state where the base part 22 is sandwiched between the two wall surface sheets 11.

As shown in FIGS. 4 and 5, the plug member 21 further comprises an aspiration tube guide part 21c formed at a position aligned with the cylindrical part 21d in the vertical direction. The aspiration tube guide part 21c extends in a direction opposite to the cylindrical part 21d with the base part 22 interposed therebetween, and realizes smooth insertion of the reagent aspiration tube 252 into the reagent storage bag 10. Further, the base part 22 is formed with a protrusion 22a protruding in the same direction as the cylindrical part 21d. The protrusion 22a is used for fixing the frame member 23 together with the cylindrical part 21d.

The plug member 21 is made of hard resin. The resin constituting the plug member 21 is, for example, an injection-moldable thermoplastic resin, and is preferably heat-weldable to the wall surface sheet 11. Examples of the resin constituting the plug member 21 include polyolefins such as polyethylene (PE) and polypropylene (PP), and polytetrafluoroethylene (PET). It is preferable that the aspiration tube guide part 21c, the cylindrical part 21d, and the base part 22 are integrally molded of thermoplastic resin.

The cylindrical part 21d is formed in a substantially cylindrical shape with both axial ends open. One axial end of the cylindrical part 21d is arranged inside the reagent storage bag 10, and the other axial end is arranged outside the reagent storage bag 10, and an opening of the cylindrical part 21d serves as an opening 21a that allows the reagent aspiration tube 252 to enter. A sealing plug 21b is provided at the one axial end portion of the cylindrical part 21d, and seals the opening 21a so that the reagent 12 does not leak from the opening 21a. The sealing plug 21b is, for example, a sealing film that can be punctured by the reagent aspiration tube 252, and is attached to a peripheral edge of the opening 21a so as to cover the entire opening 21a.

The sealing plug 21b is opened by puncturing with the reagent aspiration tube 252, but the opening 21a is sealed by pressing the sealing body 252a (see FIG. 1) of the reagent aspiration tube 252 against the peripheral edge of the opening 21a, and the inside of the reagent storage bag 10 is hermetically sealed. Note that the sealing plug 21b may be a plug inserted into the cylindrical part 21d or a plug fitted onto the outside of the cylindrical part 21d. However, it is preferable that the sealing plug 21b is penetrable by the reagent aspiration tube 252 and does not require removal by a user.

The base part 22 is formed in a boat shape as a whole, is a portion whose width is reduced toward both ends in the longitudinal direction, and has a hexagonal shape in a plan view. In the present embodiment, an outer peripheral surface of the base part 22 is thermally welded to the wall surface sheet 11. Thereby, the plug member 21 is attached to the end portion of the reagent storage bag 10 without a gap between the wall surface sheet 11 and the plug member 21. Further, the plug member 21 has a structure in which the cylindrical part 21d and the aspiration tube guide part 21c protrude from one longitudinal end side of the base part 22, and a protrusion 22a protrudes in the same direction as the cylindrical part 21d from the other longitudinal end side.

The cylindrical part 21d extends from the base part 22 toward the outside of the reagent storage bag 10, and the aspiration tube guide part 21c extends from the base part 22 toward the inside of the reagent storage bag 10. The cylindrical part 21d has a root portion whose diameter is reduced more than its upper portion. Further, the protrusion 22a has a root portion thinner than its upper portion, and has a substantially T-shape when viewed from the longitudinal direction of the base part 22. As will be described in detail later, the frame member 23 is fixed to the reagent storage bag 10 by the cylindrical part 21d and the protrusion 22a fitting into through holes of the frame member 23.

The plug member 21 is arranged on a side opposite to the gusset sheet 13 (one end side in the A direction/front end side) in the A direction of the reagent storage bag 10. Further, the cylindrical part 21d of the plug member 21 is located closer to the front end side of the reagent storage bag 10 than the protrusion 22a. As described above, the other end side (rear end side) portion in the A direction of the reagent storage bag 10 bulges greatly in the B direction (thickness direction) as the gusset sheet 13 unfolds, but since no gusset sheet exists at the front end portion of the reagent storage bag 10, the front end side portion has a smaller bulge.

In the reagent storage bag 10, as described above, the thickness of the front end side portion where the cylindrical part 21d of the plug member 21 is provided is small. For this reason, if the reagent aspiration tube 252 is inserted in an inclined manner with respect to the central axis of the cylindrical part 21d, it is expected that the tip of the reagent aspiration tube 252 will contact the inner surface of the reagent storage bag 10. In order to deal with this problem, the plug member 21 is provided with an aspiration tube guide part 21c extending inside the reagent storage bag 10. The aspiration tube guide part 21c is formed in a wall shape so as to partition the reagent aspiration tube 252 inserted from the opening 21a and an inner surface of the wall surface sheet 11. Thereby, even when the reagent aspiration tube 252 is inserted in an inclined manner with respect to the central axis of the cylindrical part 21d, contact between the tip of the reagent aspiration tube 252 and the wall surface sheet 11 can be suppressed.

On the other hand, since the thickness of the reagent storage bag 10 is large on the side of the central portion in the front-rear direction and the possibility of contact between the tip of the reagent aspiration tube 252 and the inner surface of the wall surface sheet 11 is low, the aspiration tube guide part 21c is not formed closer to the central portion in the front-rear direction than the opening 21a. The aspiration tube guide part 21c is formed in a C-shaped cross-section so as to surround a part around the reagent aspiration tube 252 inserted from the opening 21a. In addition, although details will be described later, in the present embodiment, measures are taken to suppress deformation of the reagent storage bag 10 at the set position Ps (see FIG. 1) of the reagent container holder 251, and contact between the tip of the reagent aspiration tube 252 and the wall surface sheet 11 can be suppressed more reliably.

### Frame Member

As shown in FIGS. 2 to 4, the frame member 23 is a plate-like member attached to the upper portion of the reagent storage bag 10, is inserted into a guide groove 270 (see FIG. 1) of the reagent container holder 251, and enables smooth insertion into the reagent container holder 251. Further, the frame member 23 is used for positioning the reagent container 100 in the reagent container holder 251. The frame member 23 is a position restricting member configured to restrict the position of the reagent container 100 by coming into contact with a groove wall of the guide groove 270. Thereby, positional displacement between the reagent aspiration tube 252 and the opening 21a can be suppressed, and the sealed state of the reagent storage bag 10 can be effectively maintained after opening the sealing plug 21b.

As shown in FIG. 6, the frame member 23 is formed in a rectangular shape in a plan view, and is arranged in a state where long sides of the rectangle extend in the front-rear direction of the reagent storage bag 10 and short sides extend in the thickness direction of the reagent storage bag 10 above the upper portion of the reagent storage bag 10. A fixing part 26 into which the cylindrical part 21d of the plug member 21 is inserted is formed at one longitudinal end side of the frame member 23, and a grip part 25 is formed at the other longitudinal end portion of the frame member 23. Most of the frame member 23 is formed in a flat plate shape, but the other longitudinal end portion extends in the thickness direction of the flat plate to serve as the grip part 25 that can be gripped with fingers.

The frame member 23 is made of hard resin. The resin constituting the frame member 23 is, for example, an injection-moldable thermoplastic resin. Examples of the resin constituting the frame member 23 include polyolefins such as polyethylene (PE) and polypropylene (PP), and polytetrafluoroethylene (PET). It is preferable that the entire frame member 23 including the grip part 25 is integrally molded of thermoplastic resin.

As shown in FIG. 4, the frame member 23 has a fixing part 26 into which the cylindrical part 21d of the plug member 21 is inserted, and a support part 27 into which the protrusion 22a is inserted. The fixing part 26 and the support part 27 are through holes formed in a flat plate portion of the frame member 23. As will be described in detail later, the frame member 23 is stably attached to the reagent storage bag 10 by the fixing part 26 engaging with the cylindrical part 21d and the support part 27 engaging with the protrusion 22a. Further, the frame member 23 is provided with an information recording medium 28 on which information of the reagent 12 is recorded. The information recording medium 28 is arranged at a longitudinal center portion of the frame member 23 so as to cover the support part 27.

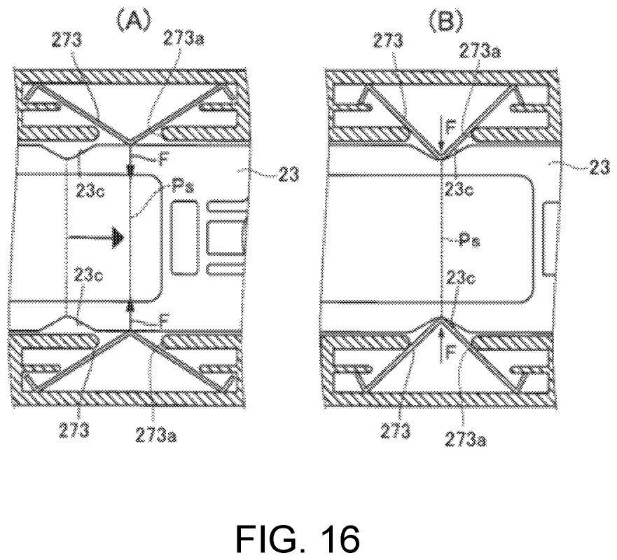

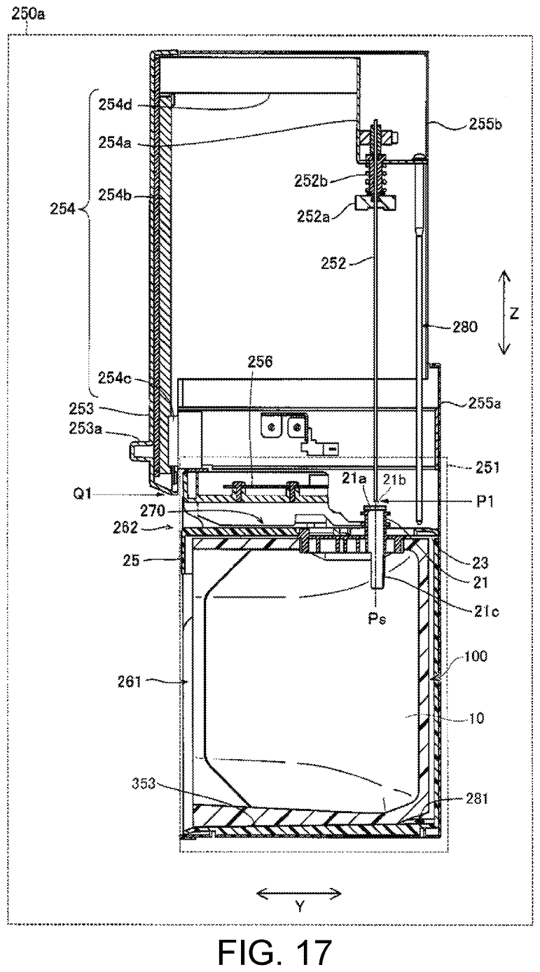

The frame member 23 further has notches 23c. Each notch 23c is a recess into which a protruding member 273 (see FIG. 16 described later) of the sample analyzer 300 fits, and is formed at an end along a long side in the longitudinal center portion of the frame member 23. The notch 23c has a triangular shape in a plan view, and two notches 23c are formed on both widthwise sides aligned in the width direction of the frame member 23. Further, the frame member 23 has through holes 23d formed between a front end 23a and the fixing part 26. Each through hole 23d is a part into which a fixing pin 280 (see FIG. 17 described later) of the sample analyzer 300 is inserted, and two through holes 23d are formed aligned in the width direction of the frame member 23. Note that the numbers of the notches 23c and the through holes 23d are not limited to two.

The frame member 23 is attached such that, in the front-rear direction of the reagent container 100, the grip part 25 is located on an opposite side to the plug member 21, in other words, on the gusset sheet 13 side. When inserting the reagent container 100 into the reagent container holder 251, a user holds the grip part 25 and inserts it in a horizontal direction with the plug member 21 side as a leading end. In the reagent storage bag 10, the grip part 25 side bulges in the thickness direction due to the expansion of the gusset sheet 13, but the thickness on the plug member 21 side is small and tapered. Therefore, if the reagent container 100 is inserted into the reagent container holder 251 from the plug member 21 side first, the insertion of the reagent container 100 is smooth.

The grip part 25 is formed with a length that is easy to grip with fingers from a rear end 23b of the frame member 23. Therefore, when inserting the reagent container 100 into the reagent container holder 251, it is not necessary to insert fingers deep into the reagent container holder 251, handling of the reagent container 100 is easy, and contact of fingers with the reagent aspiration tube 252 can be prevented. The grip part 25 is formed with a pair of grip side surfaces 25a extending in the A direction and the Z direction. Thereby, the grip part 25 can be gripped so as to be sandwiched from the left and right. The gripping form of sandwiching with fingers makes it easy for a user to apply force even in a relatively small area, and the reagent container 100 can be stably gripped.

The grip part 25 is formed at a widthwise center portion with a predetermined length in the front-rear direction from the rear end 23b of the frame member 23. A width of the grip part 25 (a distance between a pair of grip side surfaces 25a) is smaller than a width of a portion of the frame member 23 formed in a flat plate shape. A wall portion 25b is provided on the rear end 23b side of the pair of grip side surfaces 25a. An inner space surrounded by the pair of grip side surfaces 25a and the wall portion 25b is hollow, and a corner of the reagent storage bag 10 is housed in this inner space. Therefore, in the vicinity of the grip part 25, the corner of the reagent storage bag 10 is not exposed, and the user does not come into contact with the corner of the reagent storage bag 10 when gripping the grip part 25.

The frame member 23 functions as a position restricting member in the reagent container holder 251, and also functions as a support member for supporting a weight of the reagent storage bag 10 when carrying the reagent container 100. The frame member 23 has a fixing part 26 that engages with the cylindrical part 21d of the plug member 21 and a support part 27 that engages with the protrusion 22a of the plug member 21 at a position away from the cylindrical part 21d, and when carrying the reagent container 100, the reagent storage bag 10 can be supported so as to be hung at a plurality of locations of the fixing part 26 and the support part 27. Since the weight of the reagent storage bag 10 acts in a distributed manner on the plurality of locations of the frame member 23, it can be stably supported even if the capacity of the reagent storage bag 10 is increased. Further, since the user does not have to grip the easily deformable reagent storage bag 10, handling of the reagent container 100 becomes easy.

The fixing part 26 is provided between a longitudinal center portion and the front end 23a of the frame member 23. The fixing part 26 is a through hole penetrating the frame member 23 in a thickness direction (vertical direction), and includes a first hole portion 26a through which an upper portion of the cylindrical part 21d can pass, and a second hole portion 26b that engages with a root portion having a diameter smaller than the upper portion of the cylindrical part 21d. The second hole portion 26b is smaller than the first hole portion 26a and is connected to the first hole portion 26a. The second hole portion 26b is formed with a size capable of sandwiching the root portion of the cylindrical part 21d.

The support part 27 is provided at the longitudinal center portion of the frame member 23. The support part 27 is a through hole penetrating the frame member 23 in the thickness direction, and includes a first hole portion 27a through which an upper portion of the protrusion 22a can pass, and a second hole portion 27b that engages with a root portion thinner than the upper portion of the protrusion 22a. The second hole portion 27b is smaller than the first hole portion 27a and is connected to the first hole portion 27a. The second hole portion 27b is formed with a size capable of sandwiching the root portion of the protrusion 22a.

Here, a method for attaching the frame member 23 to the plug member 21 will be described. With the horizontal positions of the first hole portion 26a of the fixing part 26 and the first hole portion 27a of the support part 27 aligned with the cylindrical part 21d and the protrusion 22a of the plug member 21, the frame member 23 is brought closer from above the plug member 21. Thereby, the cylindrical part 21d is inserted into the first hole portion 26a, and the protrusion 22a is inserted into the first hole portion 27a. Then, the frame member 23 is moved relative to the plug member 21 in the A direction. Thereby, the root portion of the cylindrical part 21d enters the second hole portion 26b from the first hole portion 26a and is sandwiched by an edge portion of the second hole portion 26b. Further, the root portion of the protrusion 22a enters the second hole portion 27b from the first hole portion 27a and is sandwiched by an edge portion of the second hole portion 27b.

The information recording medium 28 is a medium in which information of the reagent 12 is recorded, and is, for example, an RFID (radio frequency identifier) tag. Thereby, when the reagent container 100 is set in the reagent container holder 251, the sample analyzer 300 can read the information of the reagent 12 from the information recording medium 28. The information recording medium 28 has a flat plate shape and is provided on an upper surface 23f of the frame member 23. Further, the information recording medium 28 is provided so as to cover the support part 27 of the frame member 23.

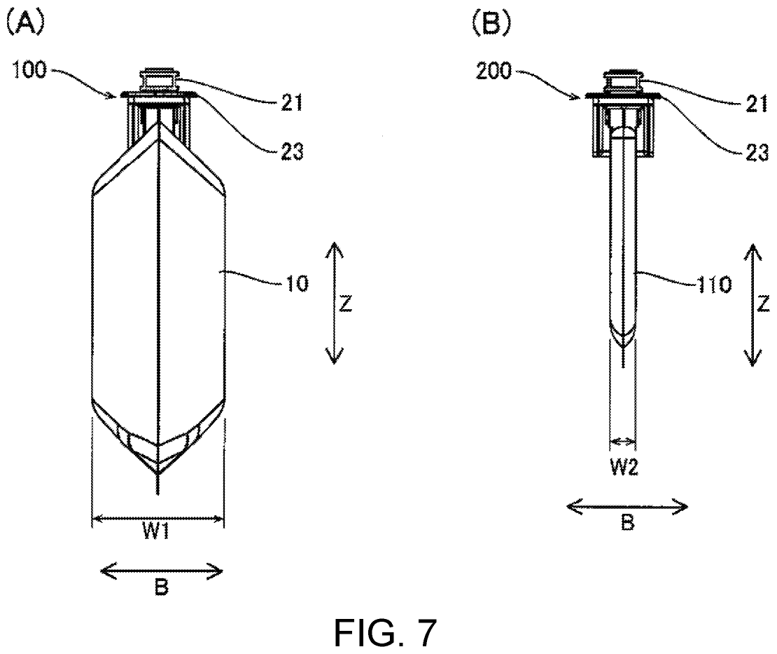

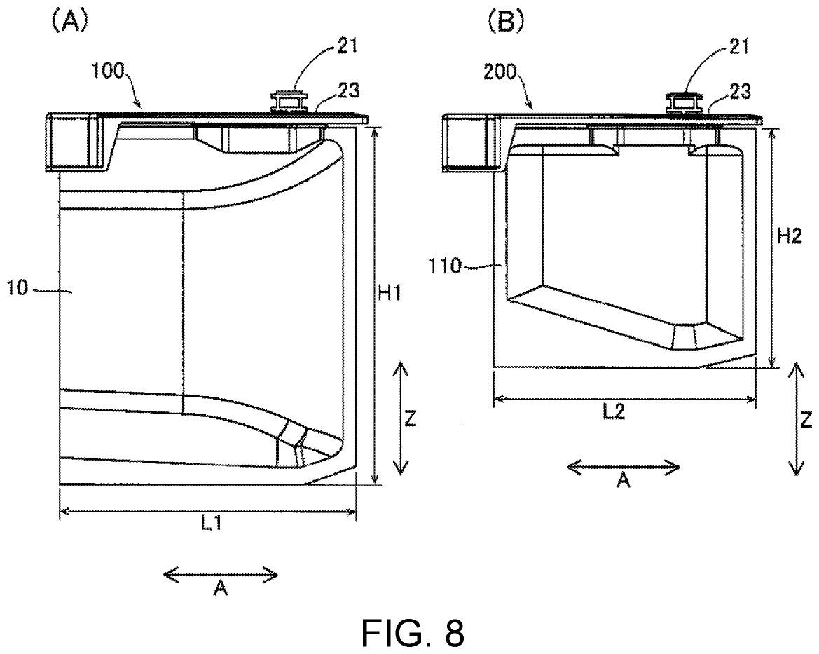

FIGS. 7 and 8 are diagrams showing two types of reagent containers 100 and 200. FIG. 7 shows a front view (A) of the reagent container 100 described above and a front view (B) of the reagent container 200. FIG. 8 shows a side view (A) of the reagent container 100 and a side view (B) of the reagent container 200.

As shown in FIGS. 7 and 8, the reagent container 100 is larger than the reagent container 200 and is a large-capacity container in which a larger amount of the reagent 12 can be contained than in the reagent container 200. The reagent storage bag 10 of the reagent container 100 contains the reagent 12 in an amount of, for example, 100 mL or more and 500 mL or less, or 200 mL or more and 500 mL or less. According to the large-capacity reagent storage bag 10, the replacement frequency of the reagent container 100 in the sample analyzer 300 is reduced. On the other hand, although there is a concern about deterioration of the reagent 12 due to contact with air over a long period with the reagent aspiration tube 252 inserted, in the present embodiment, the reagent storage bag 10 is sealed by the sealing body 252a, so that the quality of the reagent 12 can be maintained even if the usage period of the reagent 12 is prolonged. Further, by setting the capacity of the reagent 12 to 100 mL or more or 200 mL or more, the weight of the reagent storage bag 10 containing the reagent 12 increases, and the shape when the reagent storage bag 10 is pressed from the outside by a pressing part 350 described later can be effectively corrected. By setting the capacity of the reagent 12 to 500 mL or less, an increase in size of the sample analyzer can be suppressed.

The reagent storage bag 110 of the reagent container 200 contains the reagent 12 in an amount of, for example, 20 mL or more and 100 mL or less. For the small-capacity reagent container 200, deterioration of the reagent 12 can also be suppressed by sealing the reagent storage bag 110. Note that the reagent storage bag 10 has the gusset sheet 13 functioning as a gusset, but the reagent storage bag 110 does not have a gusset sheet. For this reason, in a state where the reagent 12 is filled, the reagent storage bag 110 is smaller in thickness and flatter than the reagent storage bag 10.

When the reagent storage bag 10 and the reagent storage bag 110 are compared, an A-direction length (front-rear direction length) L1, a B-direction length (thickness) W1, and a Z-direction length (vertical direction length) H1 of the reagent storage bag 10 are all larger than an A-direction length L2, a B-direction length W2, and a Z-direction length H2 of the reagent storage bag 110. On the other hand, both the reagent containers 100 and 200 are provided with the frame member 23 of the same shape and size, and have a partially common structure. By using the same frame member 23 for the reagent containers 100 and 200, the number of parts can be reduced, and the position restricting structure of the reagent containers 100 and 200 in the reagent container holder 251 can be standardized. In the reagent container 100, the B-direction length W1 of the reagent storage bag 10 is larger than the B-direction length of the frame member 23, but in the reagent container 200, the B-direction length W2 of the reagent storage bag 110 is smaller than the B-direction length of the frame member 23.

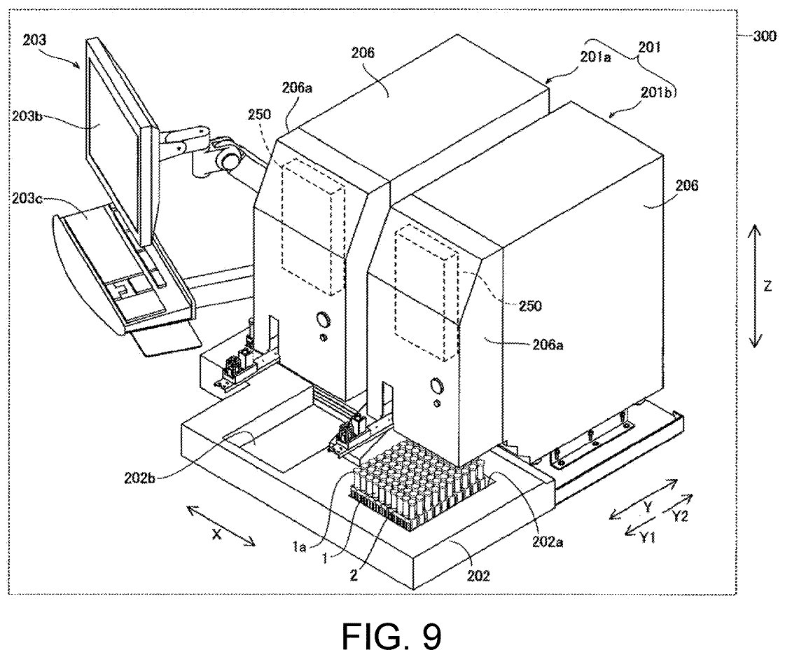

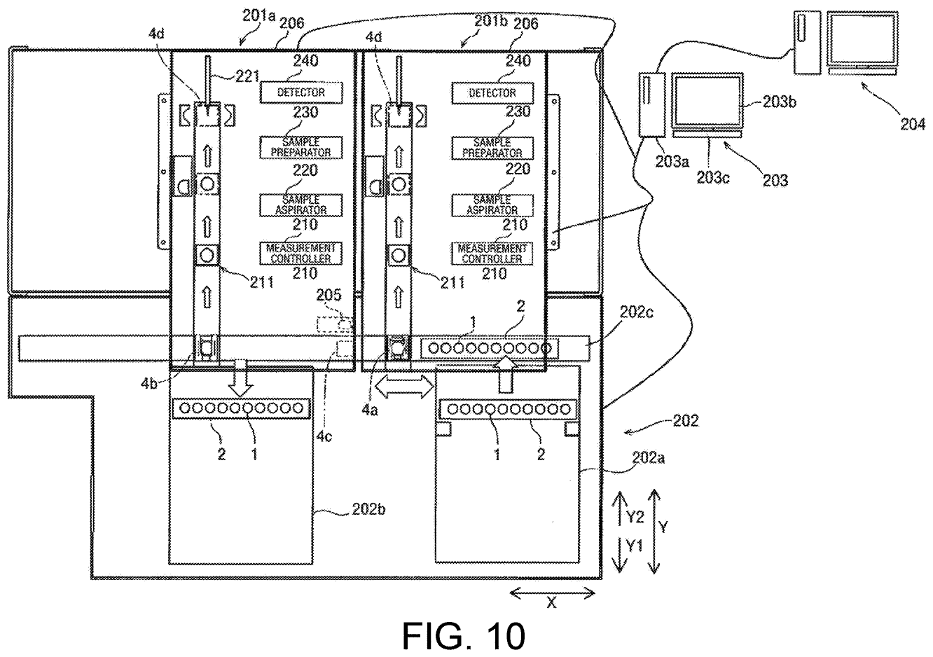

Hereinafter, a schematic configuration of the sample analyzer 300 will be described with reference to FIGS. 9 to 11. FIG. 9 is a perspective view of the sample analyzer 300. FIG. 10 is a schematic diagram for explaining the schematic configuration of the sample analyzer 300. Hereinafter, for convenience of description, a horizontal direction of the sample analyzer 300 is referred to as an X direction, and a front-rear direction (depth direction) of the sample analyzer 300 is referred to as a Y direction.

As shown in FIGS. 9 and 10, the sample analyzer 300 comprises measurement units 201, a conveyer 202 arranged on a front side (Y1 direction side) of the measurement units 201, and an analysis part 203 composed of a computer (PC) electrically connected to each measurement unit 201 and the conveyer 202. FIGS. 9 and 10 show an example in which the sample analyzer 300 comprises two measurement units 201 arranged in the X direction. The two measurement units 201 are referred to as a first measurement unit 201a and a second measurement unit 201b, respectively. The second measurement unit 201b may perform analysis of measurement items different from those of the first measurement unit 201a.

Each measurement unit 201 has a unit cover 206 for housing a measurement mechanism therein. The reagent aspiration part 250 is arranged inside the unit cover 206. An openable/closable front cover 206a is provided on a front side of the unit cover 206. The reagent container holder 251 is arranged at an upper front part of the measurement unit 201, and is exposed to the outside by opening the front cover 206a. Thereby, the user can easily insert the reagent containers 100 and 200 into the reagent container holder 251 of the reagent aspiration part 250, and can easily replace the reagent containers 100 and 200.

The conveyer 202 includes a pre-analysis rack holder 202a capable of holding a plurality of racks 2 on which sample containers 1 containing samples before analysis are held, a post-analysis rack holder 202b capable of holding a plurality of racks 2 on which sample containers 1 containing samples after analysis are held, a rack transport part 202c for horizontally moving the rack 2 linearly in the X direction, and a barcode reader 205. The conveyer 202 is configured to move the racks 2 held in the pre-analysis rack holder 202a one by one onto the rack transport part 202c.

The conveyer 202 is configured to transport the rack 2 on the rack transport part 202c in the X direction to place the sample container 1 held in the rack at an intake position 4b where the first measurement unit 201a takes in the sample container 1, an intake position 4a where the second measurement unit 201b takes in the sample container 1, and a reading position 4c where the barcode reader 205 reads a barcode of the sample container 1. Further, the conveyer 202 is configured to transport the rack 2 after analysis from the rack transport part 202c to the post-analysis rack holder 202b.

The analysis part 203 is, for example, a computer (PC), and comprises a controller 203a (see FIG. 10) including a CPU, a RAM, and the like, a display 203b, and an input device 203c. The display 203b is provided for displaying analysis results obtained by analyzing data of digital signals transmitted from the first measurement unit 201a and the second measurement unit 201b. The analysis part 203 is connected to a host computer 204.

The controller 203a includes a CPU, a RAM, a solid state drive, an input/output interface, a communication interface, and the like, and the computer functions as the analysis part 203 by the CPU executing an application program. The operations of the respective parts of the first measurement unit 201a, the second measurement unit 201b, and the conveyer 202 are controlled by the controller 203a. A measurement result database is also stored in the solid state drive or the like of the controller 203a.

The controller 203a is configured to analyze particles in the measurement sample using the measurement results transmitted from the first measurement unit 201a and the second measurement unit 201b, and to obtain analysis results (red blood cell count, platelet count, hemoglobin amount, white blood cell count, etc.). Thus, the sample analyzer 300 of the present embodiment is a blood cell counter that counts particles in a measurement sample.

As shown in FIG. 10, each measurement unit 201 (201a, 201b) comprises a measurement controller 210, a sample aspirator 220, a sample preparator 230, and a detector 240. The sample aspirator 220 has an aspiration needle 221 which is a sample aspiration tube. The sample preparator 230 comprises the reagent aspiration tube 252 for aspirating the reagent 12 from the reagent container 100, and prepares a measurement sample using a sample and the reagent 12. The detector 240 detects signals corresponding to particles in the measurement sample. In the present embodiment, the detector 240 detects signals corresponding to blood cells in the measurement sample, and the analysis part 203 analyzes detection signals from the detector 240 to count the blood cells.

The measurement controller 210 includes a processor, a memory, a driver circuit, an input/output interface, a communication interface, and the like. The measurement controller 210 communicates with the controller 203a of the analysis part 203. The measurement controller 210 controls operations of respective parts such as the sample aspirator 220, the sample preparator 230, and the detector 240 in the measurement unit 201 based on a measurement instruction from the controller 203a. The measurement controller 210 outputs information on the reagent 12 obtained from a reader 256 described later and measurement results obtained from the detector 240 to the controller 203a.

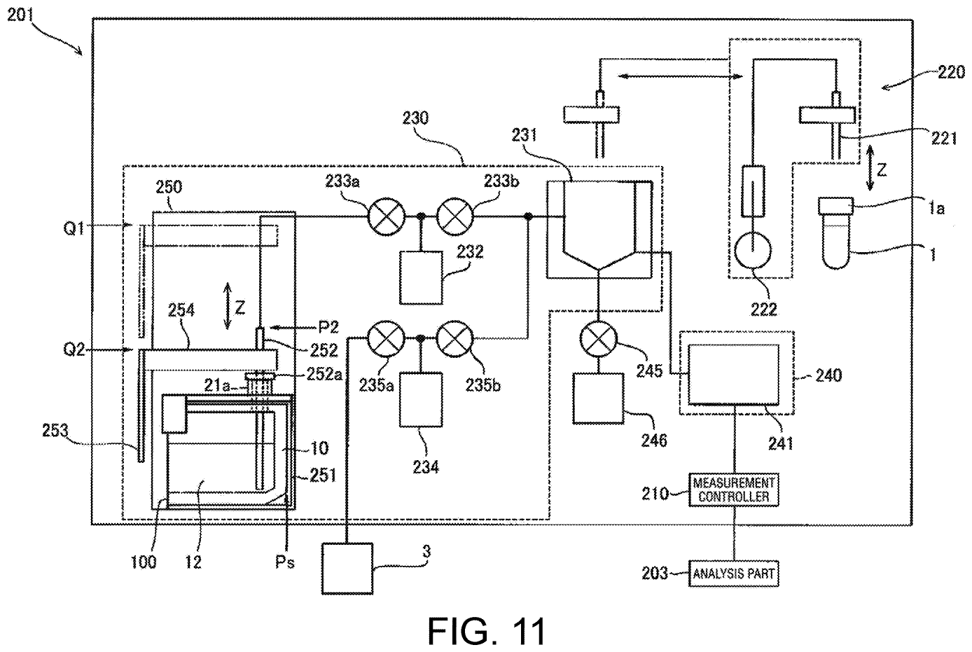

FIG. 11 is a schematic diagram for explaining a schematic configuration of the sample analyzer 300. As shown in FIG. 11, the sample aspirator 220 includes the aspiration needle 221 and a quantifying part 222. The aspiration needle 221 is formed such that a tip thereof can penetrate a sealing lid 1a of a sample container 1. Further, the aspiration needle 221 is configured to be movable by a motor between an aspiration position of a sample from the sample container 1 and a reaction chamber 231 described later. The quantifying part 222 comprises a pump and has a function of aspirating a predetermined amount of sample from the sample container 1 via the aspiration needle 221 and discharging it into the reaction chamber 231.

The sample preparator 230 comprises the reagent aspiration part 250 that aspirates the reagent 12 from the reagent container 100. The sample preparator 230 also includes a reaction chamber 231. The reaction chamber 231 is configured to mix the sample (blood) aspirated by the sample aspirator 220 with the reagent 12 supplied from the reagent aspiration part 250. Although one reaction chamber 231 is shown in FIG. 11, a plurality of reaction chambers 231 are provided according to measurement types. A plurality of types of reagents 12 (staining liquids) according to measurement items are supplied to each reaction chamber 231, and measurement samples according to various measurement items are prepared through mixing and reaction processes of the sample and the reagent 12. Then, the prepared measurement sample is supplied to the detector 240.

The sample preparator 230 includes a quantifying part 232 connected to the reagent aspiration tube 252 for quantifying and aspirating the reagent 12, and electromagnetic valves 233a and 233b for opening and closing a flow path when transferring the aspirated reagent 12 to the quantifying part 232 and the reaction chamber 231. The quantifying part 232 comprises a syringe pump, a diaphragm pump, or the like. The sample preparator 230 also includes a quantifying part 234 and electromagnetic valves 235a and 235b for transferring a reagent (hemolyzing agent, diluent) from a large-capacity reagent container 3 arranged outside the measurement unit.

The quantifying part 232 is capable of aspirating a predetermined amount of the reagent 12 in the reagent container 100 into an inside of the quantifying part 232 via the reagent aspiration tube 252 by opening the electromagnetic valve 233a and closing the electromagnetic valve 233b in a state where the reagent aspiration tube 252 is inserted into the reagent container 100. The quantifying part 232 is configured to be capable of transferring the reagent 12 quantified inside the quantifying part 232 to the reaction chamber 231 by closing the electromagnetic valve 233a and opening the electromagnetic valve 233b.

The detector 240 includes an FCM measurement part 241 that detects particles such as white blood cells (WBC) in a measurement sample by a flow cytometry method using a light source. The measurement result obtained by the detector 240 is transmitted by the measurement controller 210 to the analysis part 203 as measurement data (measurement result) of the sample.

The analysis part 203 analyzes particles based on light detected by the FCM measurement part 241. The analysis part 203 generates a scattergram by using scattered light intensity and fluorescence intensity as parameters, classifies particles in a measurement sample based on distribution of the scattergram, and counts particles in each classified type. Measurement items by the flow cytometry method include NEUT (neutrophils), LYMPH (lymphocytes), MONO (monocytes), EO (eosinophils), BASO (basophils), and the like.

The detector 240 also performs detection by a sheath flow DC detection method. The detector 240 causes particles such as cells to flow in a flow of sheath liquid passing through an aperture, and causes a direct current to flow between a pair of electrodes arranged to face each other across the aperture. The detector 240 outputs a pulse-like current change when a particle passes through the aperture as a detection result by the sheath flow DC detection method. The analysis part 203 counts particles based on the current change. A measurement item by the sheath flow DC detection method includes an RBC (red blood cell) count.

The detector 240 performs HGB detection (detection of hemoglobin in blood) by an SLS-hemoglobin method. A measurement sample in which a hemolyzing agent and a sample are mixed is irradiated with measurement light from a light source, and a transmitted light amount of the measurement sample is acquired by a light receiving part. The detector 240 outputs a change in the transmitted light amount during a process in which SLS-hemoglobin is formed as a detection result by the SLS-hemoglobin method. The analysis part 203 calculates a hemoglobin concentration (HGB) in the measurement sample based on the change in the transmitted light amount.

As described above, the reagent aspiration part 250 comprises the reagent container holder 251 configured to hold the reagent container 100, the reagent aspiration tube 252, the operation part 253, and the moving mechanism 254. The reagent aspiration tube 252 penetrates the sealing plug 21b of the reagent container 100 held in the reagent container holder 251, aspirates the reagent 12 in the reagent storage bag 10, and seals the opening 21a with the sealing body 252a. An upper end of the reagent aspiration tube 252 is connected to a flow path reaching the quantifying part 232 and the reaction chamber 231.

The operation part 253 is configured to receive a predetermined operation for moving the reagent aspiration tube 252 from a user of the sample analyzer 300. The moving mechanism 254 moves the reagent container 100 and the reagent aspiration tube 252 relative to each other in conjunction with the predetermined operation received by the operation part 253. The moving mechanism 254 is configured to cause the reagent aspiration tube 252 to enter the reagent container 100 and to retract the reagent aspiration tube 252 to an outside of the reagent container 100 by the relative movement. In the sample analyzer 300, it is not necessary for the user to perform an operation of inserting the reagent aspiration tube 252 into the opening 21a of the reagent container 100 before installing the reagent container 100, so that the reagent container 100 can be easily installed in the sample analyzer 300.

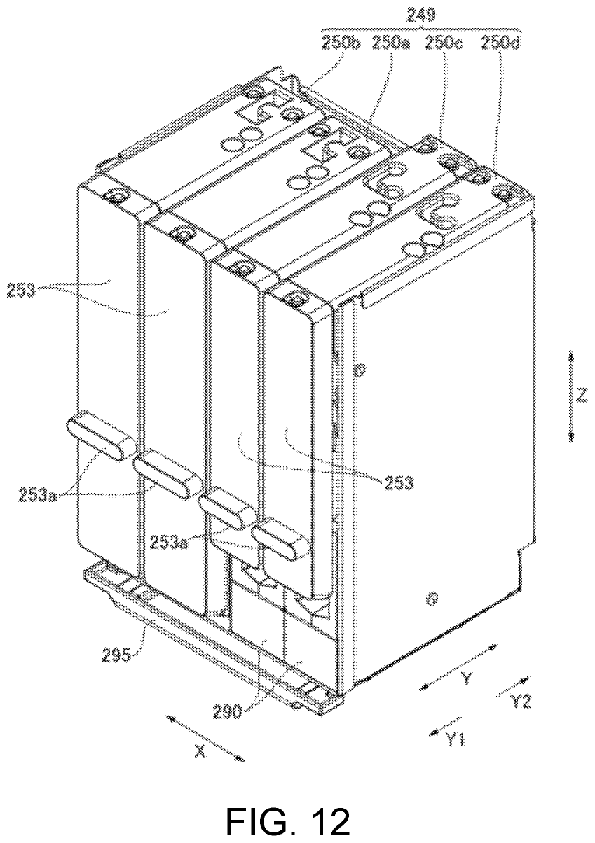

Hereinafter, the structure of the reagent aspiration part 250, particularly the structure of the reagent container holder 251 configured to hold the reagent containers 100 and 200, will be described in detail with reference to FIGS. 12 to 23.

FIG. 12 is a perspective view of a reagent aspiration unit 249. As shown in FIG. 12, the reagent aspiration unit 249 is comprises a plurality of reagent aspiration parts 250a to 250d. The reagent aspiration parts 250a to 250d are arranged side by side in the X direction with the operation part 253, which also functions as a front cover, directed toward the front (Y1 direction) of the sample analyzer 300. Although four reagent aspiration parts 250a to 250d are shown in FIG. 12, the number of reagent aspiration parts 250 in the reagent aspiration unit 249 may be three or less, or five or more.

The operation part 253 is arranged on a front surface of each of the reagent aspiration parts 250a to 250d. The operation part 253 is configured as a cover that openably covers an entrance of the reagent container holder 251. The operation part 253 is configured to be gripped by a user with a hand and moved in the vertical direction (Z direction). The operation part 253 is formed with a handle 253a protruding forward (Y1 direction). The user can move the operation part 253 in the Z direction by gripping this handle 253a and moving it in the Z direction.

The reagent aspiration unit 249 includes a liquid storage tray 295. The liquid storage tray 295 is arranged at a bottom of the reagent aspiration unit 249 so as to cover a lower side of the reagent aspiration parts 250a to 250d. The liquid storage tray 295 has a function of receiving the reagent 12 if the reagent 12 leaks from the reagent containers 100 and 200 held in the reagent container holder 251. The liquid storage tray 295 can slide in the Y direction and can be pulled out to the front of the apparatus.

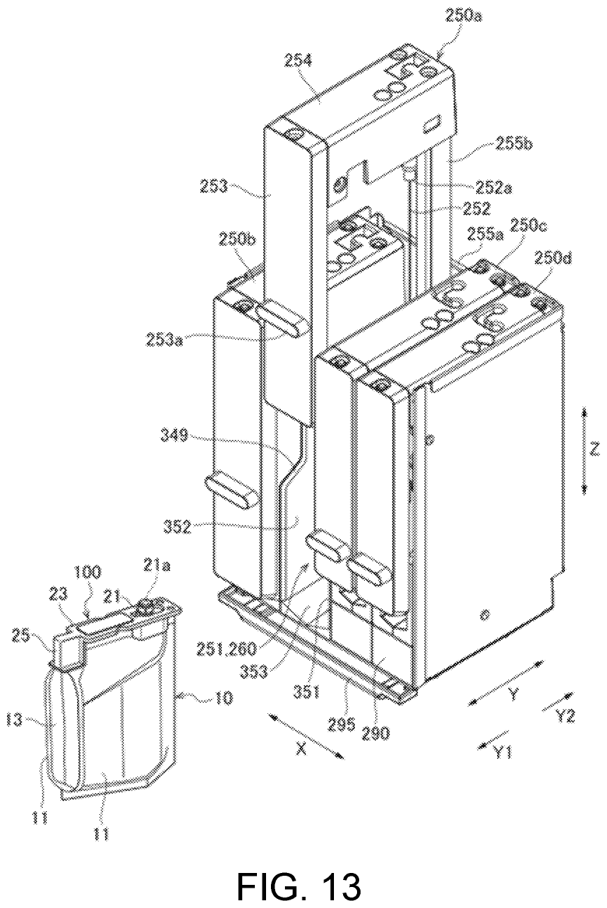

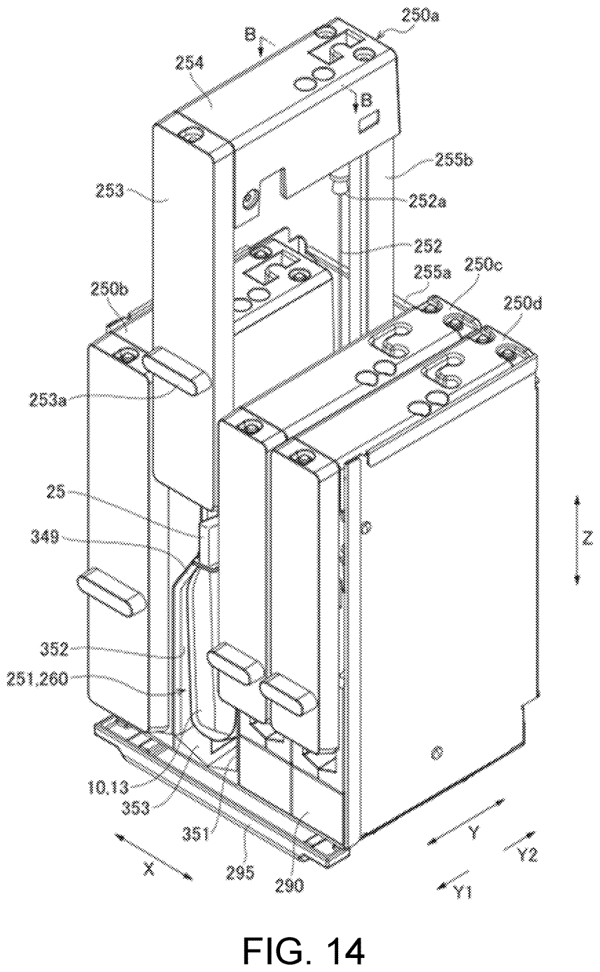

FIG. 13 is a perspective view of the reagent aspiration unit 249, showing a state where the reagent aspiration tube 252 of the reagent aspiration part 250a is at the upper position. FIG. 14 is a diagram showing a state where the reagent container 100 is held in the reagent container holder 251 of the reagent aspiration part 250a in FIG. 13. As shown in FIGS. 13 and 14, the reagent container holder 251 of the reagent aspiration part 250a is configured to hold one reagent container 100. The reagent aspiration part 250b has the same structure as the reagent aspiration part 250a and is configured to hold one reagent container 100. One reagent container 200 is held in each of the reagent container holders 251 of the reagent aspiration parts 250c and 250d.

Each of the reagent aspiration parts 250a to 250d comprises the reagent container holder 251, the reagent aspiration tube 252, and the operation part 253. On the other hand, the reagent container holder 251 of the reagent aspiration parts 250c and 250d in which the small-capacity reagent containers 200 are held has smaller vertical length and width (X-direction length) compared to the reagent container holder 251 of the reagent aspiration parts 250a and 250b in which the large-capacity reagent containers 100 are held. Spacers 290 for raising a position of a bottom surface of the reagent container holder 251 are provided in the reagent aspiration parts 250c and 250d.

In the reagent aspiration parts 250c and 250d, the height of the opening 21a of the reagent container 200 is made to coincide with the height of the opening 21a of the reagent container 100 installed in the reagent aspiration parts 250a and 250b by the spacers 290. Thereby, insertion heights of the containers when the user installs each of the reagent containers 100 and 200 can be aligned, so that installation work can be facilitated. Other structures of the reagent aspiration parts 250c and 250d are similar to those of the reagent aspiration parts 250a and 250b. Hereinafter, the structure of the reagent aspiration part 250a will be described as a representative of the reagent aspiration parts 250a to 250d.

The reagent aspiration part 250a comprises a lower chassis 255a and an upper chassis 255b, and is configured such that the upper chassis 255b is movable in the vertical direction by operation of the operation part 253. The reagent aspiration part 250a has a structure in which the reagent container holder 251 is provided in the lower chassis 255a, and the reagent aspiration tube 252 and the operation part 253 are provided in the upper chassis 255b. Further, the reagent aspiration part 250a includes the moving mechanism 254 for moving the upper chassis 255b to which the reagent aspiration tube 252 is fixed in the vertical direction.

The reagent container holder 251 is located below the reagent aspiration part 250a. The reagent container holder 251 is provided in the lower chassis 255a and does not move in the vertical direction. The reagent container holder 251 has a storage space 260 for storing the reagent container 100. The storage space 260 has an entrance opening toward the front (Y1 direction) of the reagent container holder 251 and extends in the front-rear direction (Y direction). The reagent container 100 is arranged in the storage space 260 such that the plug member 21 forming the opening 21a is located on a rear side of the storage space 260.

In the storage space 260 of the reagent container holder 251, the upper chassis 255b moves upward by a user pulling up the operation part 253, and its entrance is opened. At this time, since the reagent aspiration tube 252 also moves upward, the reagent container 100 can be inserted into the storage space 260. Since the reagent container 100 is inserted into the storage space 260 with the plug member 21 side as a front end, when the plug member 21 is inserted deep into the storage space 260, the grip part 25 is located near the entrance of the storage space 260. Therefore, when inserting the reagent container 100, it is not necessary to insert fingers deep into the storage space 260, and also when taking out the reagent container 100 from the storage space 260, the grip part 25 can be easily grasped.

Although details will be described later, the reagent container 100 is arranged in the storage space 260 in a state where the reagent storage bag 10 is hung. The storage space 260 is a space partitioned by a first side wall 351 and a second side wall 352 facing each other in the X direction, and a bottom part 353 facing a bottom portion of the reagent storage bag 10 in the Z direction. Since the reagent storage bag 10 is arranged in the storage space 260 in the hung state, the bottom portion of the reagent storage bag 10 does not contact the bottom part 353. The bottom part 353 is inclined from both sides in the width direction toward the center so that a widthwise center portion is the deepest.

Recesses 349 with a reduced wall height are formed at Y1-direction end portions (entrance side end portions of the storage space 260) of the side walls 351 and 352. The recess 349 is formed at a position facing the grip part 25 in the X direction when the reagent container 100 is arranged at the set position Ps of the reagent container holder 251. Thereby, even when the reagent container 100 is inserted deep into the reagent container holder 251, the grip part 25 is easily gripped, and it also becomes easy to take out the reagent container 100 from the reagent container holder 251.

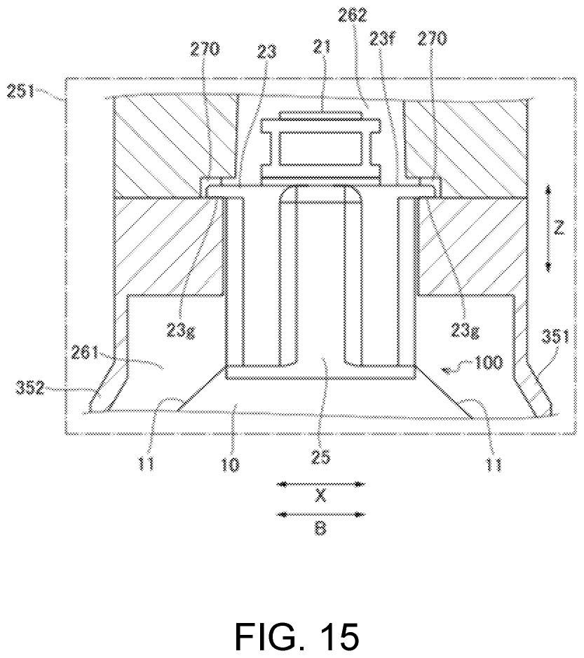

FIG. 15 is a diagram showing a part of a cross section taken along line BB in FIG. 14 (a cross section of an upper portion of the reagent container holder 251).

As shown in FIG. 15, the storage space 260 of the reagent container holder 251 includes a first storage part 261 into which the reagent storage bag 10 of the reagent container 100 is inserted, and a second storage part 262 arranged above the first storage part 261 and into which the plug member 21 and the frame member 23 of the reagent container 100 are inserted. A guide groove 270 for guiding the frame member 23 is formed in the second storage part 262. By the frame member 23 fitting into the guide groove 270, the reagent container 100 is arranged in the storage space 260 in a state where the reagent storage bag 10 is hung.

The first storage part 261 has side walls 351 and 352 facing the wall surface sheets 11 of the reagent storage bag 10 in the X direction. The first storage part 261 is a space partitioned by the side walls 351 and 352 and the bottom part 353 (see FIG. 14) and capable of storing the entire reagent storage bag 10. Note that a part of the grip part 25 of the frame member 23 is stored in the first storage part 261.

The second storage part 262 has guide grooves 270 extending in the front-rear direction (Y direction) from the entrance of the reagent container holder 251 and guiding the reagent container 100 to the set position Ps (see FIG. 1). Each guide groove 270 is formed with a depth (X-direction length) and a width (Z-direction length) that allow both widthwise end portions of the frame member 23 to fit and the frame member 23 to slide, so as to sandwich the frame member 23 from both widthwise sides. That is, a pair of guide grooves 270 is formed on both sides of the second storage part 262 in the X direction. Thereby, even with the reagent container 100 having the reagent storage bag 10 that is easily deformed, it can be accurately guided to the set position Ps by a simple operation of the user just inserting the reagent container 100 from the entrance of the storage space 260.

In the reagent container 100, the position is restricted by the frame member 23 coming into contact with the back, left and right (both sides in the X direction), and top and bottom groove walls of the guide grooves 270, and the reagent storage bag 10 is in a hung state. The reagent container 100 is accurately arranged at the set position Ps by the front end 23a of the frame member 23 coming into contact with the innermost part of the guide grooves 270. In other words, the guide groove 270 has a length in the Y direction such that the front end 23a contacts the innermost part when the reagent container 100 is inserted to the set position Ps.

A distance between the groove walls of the pair of guide grooves 270 facing each other in the X direction is slightly larger than the width of the frame member 23. Thereby, movement of the frame member 23 in the X direction of the second storage part 262 can be restricted within an allowable range. Further, the width (Z-direction length) of each guide groove 270 is slightly larger than the thickness (Z-direction length) of the frame member 23. Since the lower surface 23g of the frame member 23 is supported by the groove walls of the guide grooves 270 and the reagent storage bag 10 is in a hung state, the upper surface 23f of the frame member 23 is not in contact with the groove walls of the guide grooves 270. However, when the frame member 23 is lifted, the upper surface 23f comes into contact with the groove walls, and movement is restricted so that the frame member 23 does not move upward beyond a predetermined allowable range.

FIG. 16 is a diagram showing a state (A) before the protruding member 273 engages with the notch 23c of the frame member 23 and a state (B) where it is engaged.

As shown in FIG. 16, the reagent container holder 251 is provided with a pair of protruding members 273 that are pressed against both widthwise ends of the frame member 23 and fit into the notches 23c of the frame member 23. The pair of protruding members 273 is arranged in the guide grooves 270 so as to sandwich the frame member 23 from both sides in the X direction. Each protruding member 273 is composed of, for example, a V-shaped leaf spring, and protrudes to an inside of the second storage part 262 from an opening 273a formed in the groove wall of the pair of guide grooves 270.

As shown in (A) of FIG. 16, when the frame member 23 is inserted into the inside of the second storage part 262, each protruding member 273 is pushed to an outside of the second storage part 262 by coming into contact with the frame member 23. At this time, each protruding member 273 urges the frame member 23 toward the inside of the second storage part 262 by the elastic force of the leaf spring. As shown in (B) of FIG. 16, when the reagent container 100 is arranged at the set position Ps, the notch 23c formed in the frame member 23 reaches the position of each protruding member 273. Thereby, each protruding member 273 enters the notch 23c by the elastic force F of the leaf spring. As a result, movement of the frame member 23 in the Y direction is restricted unless an external force that overcomes the elastic force F of the protruding member 273 is applied.

By the protruding member 273 fitting into the notch 23c of the frame member 23, the frame member 23 can be held so that the opening 21a of the reagent container 100 does not move from the set position Ps. Further, since the frame member 23 stops moving at the set position Ps when the reagent container 100 is inserted into the storage space 260, the user can perceive by touch that the reagent container 100 has been installed at an appropriate position even without visually checking the position of the reagent container 100. Furthermore, since the frame member 23 receives the elastic force F from both sides in the X direction by the respective protruding members 273, the frame member 23 is positioned at the center of the second storage part 262 in the X direction.

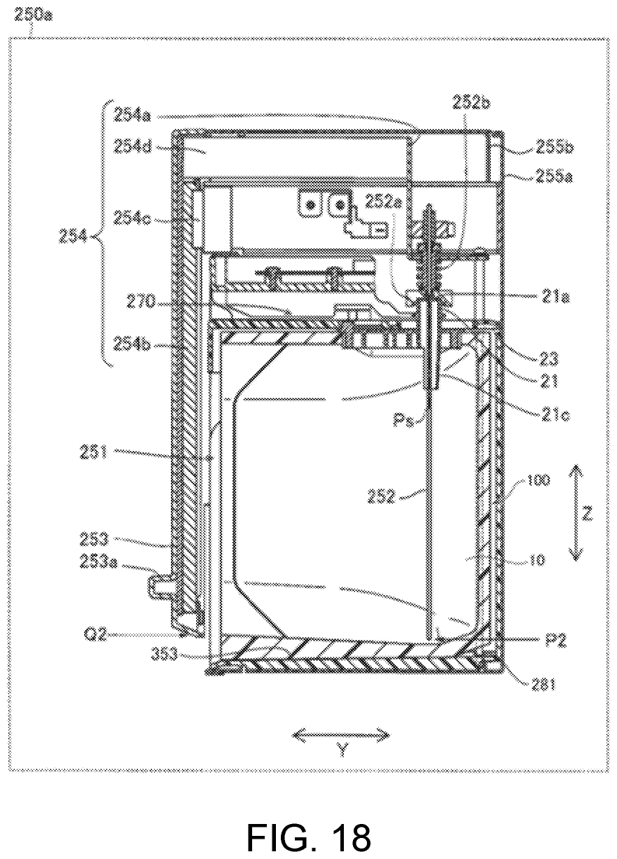

FIG. 17 is a cross-sectional view of the reagent aspiration part 250a, showing a state where the reagent container 100 is stored in the reagent container holder 251 and the reagent aspiration tube 252 is at the upper position. FIG. 18 is a diagram showing a state where the reagent aspiration tube 252 is at a lower position.

As shown in FIGS. 17 and 18, the reagent aspiration tube 252 is arranged at an upper position on the rear side (Y2-direction end portion) of the reagent container holder 251 with its tip facing downward. The reagent aspiration tube 252 is fixed to the upper chassis 255b and moved in the vertical direction (Z direction) by the moving mechanism 254. In the lower position P2 shown in FIG. 18, the reagent aspiration tube 252 enters the inside of the reagent storage bag 10 from the opening 21a of the plug member 21 of the reagent container 100 and can aspirate the reagent 12. At this time, the sealing body 252a provided on the reagent aspiration tube 252 comes into contact with the peripheral edge of the opening 21a to seal the reagent storage bag 10.

As described above, the sealing body 252a is made of elastically deformable rubber. Further, the sealing body 252a is made of a solid material that does not have air permeability. In the sealing body 252a, a ventilation hole for communicating the opening 21a to the outside is not formed in a state where the opening 21a is sealed. Further, an urging member 252b for urging the sealing body 252a toward the opening 21a is provided between the sealing body 252a and an aspiration tube holding part 254a that holds the reagent aspiration tube 252. The urging member 252b is, for example, a compression spring.

The moving mechanism 254 holds the reagent aspiration tube 252 so as to be movable in the vertical direction (Z direction) between the upper position P1 shown in FIG. 17 and the lower position P2 shown in FIG. 18. The moving mechanism 254 includes the aspiration tube holding part 254a and a linear motion mechanism composed of a linear rail 254b and a fixed slider 254c. The aspiration tube holding part 254a is connected to an upper end portion of the linear rail 254b via a connecting portion 254d extending in the Y direction. The linear rail 254b is arranged in front of the reagent aspiration part 250a and extends in the Z direction. The fixed slider 254c is fixed to the lower chassis 255a and holds the linear rail 254b so as to be movable along the Z direction. Thereby, the linear rail 254b moves in the Z direction relative to the fixed slider 254c. Along with the movement of the linear rail 254b in the Z direction, the reagent aspiration tube 252 moves in the Z direction integrally with the linear rail 254b.

As shown in FIG. 17, the upper position P1 is a position where the entire reagent aspiration tube 252 retracts above the reagent container 100 arranged at the set position Ps. When the reagent aspiration tube 252 is at the upper position P1, the reagent container 100 can be taken out from the reagent container holder 251 or the reagent container 100 can be inserted into the reagent container holder 251. As shown in FIG. 18, the lower position P2 is a position where the reagent aspiration tube 252 is inserted into the reagent storage bag 10 via the opening 21a of the reagent container 100. When the reagent aspiration tube 252 is at the lower position P2, the tip of the reagent aspiration tube 252 is located inside the reagent storage bag 10 near an inner surface of the bottom portion of the bag.

The moving mechanism 254 holds the operation part 253 so that the reagent aspiration tube 252 and the operation part 253 move in conjunction with each other. The operation part 253 is provided on a front surface of the reagent aspiration part 250a, and a rear side (Y2 direction side) of the operation part 253 is attached to the linear rail 254b. Thereby, just by moving the operation part 253 up and down, the reagent aspiration tube 252 can enter the reagent container 100 and the reagent aspiration tube 252 can retract to the outside of the reagent container 100.

The operation part 253 is configured to be movable between a removal position Q1 that allows removal of the reagent container 100 from the reagent container holder 251 and a removal prevention position Q2 that prevents removal of the reagent container 100 from the reagent container holder 251. The removal position Q1 is an upper position of the operation part 253 when the reagent aspiration tube 252 is at the upper position P1. The removal prevention position Q2 is a lower position of the operation part 253 when the reagent aspiration tube 252 is at the lower position P2. Note that if the user tries to move the operation part 253 downward without correctly inserting the reagent container 100 to the set position Ps, for example, the operation part 253 hits the grip part 25 of the reagent container 100, and the operation part 253 cannot be moved to the removal prevention position Q2.

Further, the reagent aspiration part 250a has fixing pins 280 that descend in conjunction with the movement of the reagent aspiration tube 252 by the moving mechanism 254. Each fixing pin 280 is configured to enter into the through hole 23d formed in the frame member 23 at least when the reagent aspiration tube 252 is inserted into the opening 21a, so as to fix the position of the opening 21a. Thereby, unintentional movement of the reagent container 100 while the reagent aspiration tube 252 is inserted in the opening 21a can be suppressed. Therefore, it is possible to suppress unsealing of the reagent storage bag 10 or leakage of the reagent 12 due to displacement of the opening 21a.

When the reagent aspiration tube 252 is at the lower position P2, the fixing pin 280 passes through the through hole 23d of the frame member 23, and a tip of the fixing pin 280 is inserted into a fixing hole 281 formed in the bottom part 353 of the reagent container holder 251. Thereby, while the reagent aspiration tube 252 is at the lower position P2, the frame member 23 that contacts the fixing pin 280 in the through hole 23d becomes immovable in a horizontal direction, and the position of the opening 21a can be more reliably fixed.

The reagent aspiration part 250a further comprises a reader 256 that acquires information regarding the reagent 12 from the information recording medium 28 provided on the frame member 23. The reader 256 is provided at an upper portion of the reagent container holder 251 at a path through which the information recording medium 28 passes or at a position facing the information recording medium 28 in the vertical direction when the reagent container 100 is arranged at the set position Ps. Thereby, when the reagent container 100 is inserted into the reagent container holder 251, the reader 256 can read the information of the reagent 12 from the information recording medium 28. The reader 256 comprises, for example, an RFID reader that performs wireless communication with the information recording medium 28 comprising an RFID tag and reads information from the information recording medium 28.

The information of the reagent 12 read by the reader 256 includes various information such as a type of the reagent 12, a lot number, and a storage period. The analysis part 203 acquires the information of the reagent 12 read from the information recording medium 28 by the reader 256 via the measurement controller 210, and executes a process based on the acquired information of the reagent 12. The analysis part 203 manages, for example, the storage period of the reagent 12.

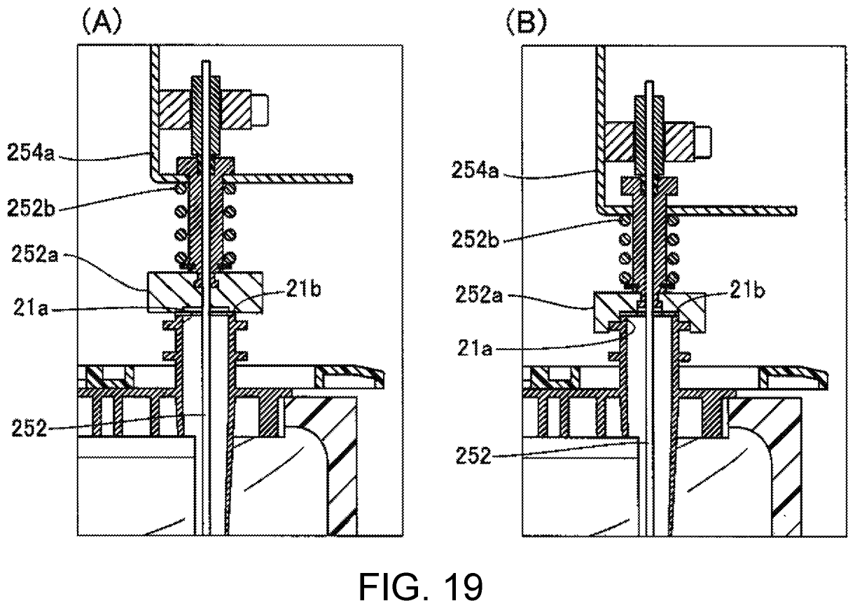

FIG. 19 is a cross-sectional view showing a state (A) before the opening 21a of the reagent container 100 is sealed and a state (B) where the opening is sealed.

As shown in (A) of FIG. 19, in the process of downward movement of the reagent aspiration tube 252, the sealing body 252a provided on the reagent aspiration tube 252 is pressed against the peripheral edge of the opening 21a. After the reagent aspiration tube 252 moves downward by the moving mechanism 254 and the sealing body 252a contacts the peripheral edge of the opening 21a, the reagent aspiration tube 252 further moves downward to the predetermined lower position P2. The reagent aspiration tube 252 moves while compressing the urging member 252b.

As shown in (B) of FIG. 19, at the lower position P2 of the reagent aspiration tube 252, the urging member 252b is compressed, so that the urging member 252b urges the sealing body 252a toward the opening 21a. Thereby, the sealing body 252a adheres to the peripheral edge of the opening 21a while being elastically deformed, and the opening 21a is more reliably sealed by the sealing body 252a.

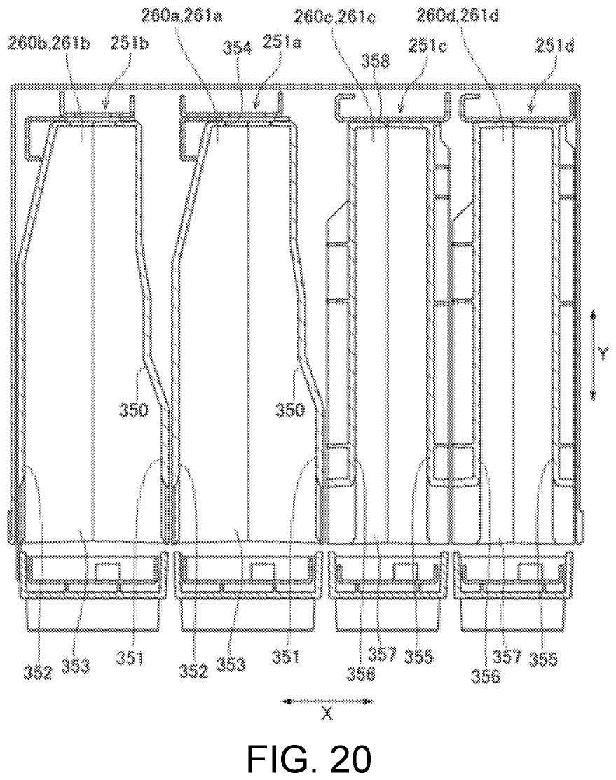

FIG. 20 is a horizontal cross-sectional view of the reagent container holders 251a to 251d of the reagent aspiration unit 249 taken along the Y direction (front-rear direction/depth direction).

As shown in FIG. 20, the reagent aspiration unit 249 includes a plurality of reagent container holders 251a to 251d. The reagent container holders 251a to 251d respectively constitute the reagent aspiration parts 250a to 250d as described above, and hold the reagent container 100 or the reagent container 200 one by one. The reagent container holders 251a and 251b hold the large-capacity reagent containers 100, and the reagent container holders 251c and 251d hold the small-capacity reagent containers 200. The storage spaces 260a and 260b of the reagent container holders 251a and 251b are larger than the storage spaces 260c and 260d of the reagent container holders 251c and 251d, but since the same frame member 23 is used for each of the reagent containers 100 and 200, the depthwise lengths of the respective storage spaces are the same.

Of the storage spaces 260a and 260b of the reagent container holders 251a and 251b, a width (X-direction length) of the first storage parts 261a and 261b, which are portions where the reagent storage bags 10 are stored, is larger than a width of the first storage parts 261c and 261d, which are portions where the reagent storage bags 110 are stored, of the storage spaces 260c and 260d of the reagent container holders 251c and 251d. While the width of the reagent storage bag 110 of the reagent container 200 is smaller than the width of the frame member 23 (see (B) of FIG. 7), the reagent storage bag 10 of the reagent container 100 bulges greatly beyond both widthwise ends of the frame member 23 (see (A) of FIG. 7). For this reason, the first storage parts 261a and 261b need to be wider than the first storage parts 261c and 261d.

The reagent container holders 251a and 251b can also hold the small-capacity reagent containers 200. For this reason, it is possible to make all the reagent container holders large enough to hold the large-capacity reagent containers 100; however, from the viewpoint of miniaturization of the sample analyzer 300, when use of the reagent containers 200 is expected to some extent, it is preferable to provide the reagent container holders 251c and 251d exclusively for the small-capacity reagent containers 200.

The reagent container holders 251a and 251b have the same structure as each other. Further, the reagent container holders 251c and 251d have the same structure as each other. Hereinafter, the structure of the reagent container holder 251a will be described as a representative of the reagent container holders 251a and 251b. In addition, the structure of the reagent container holder 251c will be described as a representative of the reagent container holders 251c and 251d.

The reagent container holder 251a has, as described above, side walls 351 and 352 facing each other in the X direction, and the bottom part 353 connecting the lower ends of the side walls 351 and 352. The reagent container holder 251a further has a rear wall 354 connecting the side walls 351 and 352 at the innermost position of the first storage part 261a. The first storage part 261a is a space partitioned by the side walls 351 and 352, the bottom part 353, and the rear wall 354, and capable of storing the entire reagent storage bag 10.

In the first storage part 261a, the reagent storage bag 10 is stored in a state of being hung without contacting the bottom part 353. That is, the reagent container holder 251a is configured to hold the reagent container 100 in a state where a bottom portion of the reagent storage bag 10 is not supported from below. Since the reagent storage bag 10 is a soft packaging material container, it deforms greatly by its own weight when placed on the bottom part 353, but such deformation of the bag can be suppressed by hanging the reagent storage bag 10. Further, the insertion of the reagent storage bag 10 into the first storage part 261a becomes smooth. The bottom part 353 faces the bottom portion of the reagent storage bag 10 in the vertical direction with a gap between itself and the bottom portion of the reagent storage bag 10. Note that the surface of the bottom part 353 facing the bottom portion of the reagent storage bag 10 is inclined so that the center portion may be deeper than both widthwise end portions of the bottom part 353.

The side wall 352 is arranged with a gap between itself and the surface of the reagent storage bag 10, similar to the bottom part 353. By the reagent storage bag 10 not contacting the side wall 352, the insertion of the reagent storage bag 10 into the first storage part 261a becomes smooth. On the other hand, the side wall 351 is arranged so as to actively contact the reagent storage bag 10. Although details will be described later, the side wall 351 has a pressing part 350 configured to press the reagent storage bag 10 with the opening 21a sealed from the outside. The reagent container holder 251a has side walls 351 and 352 arranged opposite to the surfaces of the reagent storage bag 10 on both sides in the thickness direction of the bag, and the pressing part 350 is formed on the side wall 351. The pressing part 350 corrects the shape of the reagent storage bag 10 to prevent the reagent storage bag 10 from being arranged at the set position Ps in a greatly deformed state, effectively suppressing damage to the reagent storage bag 10 by the piercing of the reagent aspiration tube 252.

The reagent container holder 251c has, similarly to the reagent container holder 251a, side walls 355 and 356 facing each other in the X direction, a bottom part 357 connecting the lower ends of the side walls 355 and 356, and a rear wall 358 connecting the side walls 355 and 356 at the innermost position of the first storage part 261c. The first storage part 261c is a space partitioned by the side walls 355 and 356, the bottom part 357, and the rear wall 358, and capable of storing the entire reagent storage bag 110.

In the first storage part 261c, the reagent storage bag 110 is stored in a state of being hung without contacting the bottom part 357. That is, the reagent container holder 251c is configured to hold the reagent container 200 in a state where a bottom portion of the reagent storage bag 110 is not supported from below. Since the reagent storage bag 110 is a soft packaging material container, it deforms greatly by its own weight when placed on the bottom part 357, but such deformation of the reagent storage bag 110 can be suppressed by hanging the reagent storage bag 110. Further, the insertion of the reagent storage bag 110 into the first storage part 261c becomes smooth. The surface of the bottom part 357 facing the bottom portion of the reagent storage bag 110 may be inclined so that the center portion is deeper than both widthwise end portions of the bottom part 357.

The side walls 355 and 356 are arranged with a gap between themselves and the reagent storage bag 110, similar to the bottom part 357. By the reagent storage bag 110 not contacting the side walls 355 and 356, the insertion of the reagent storage bag 110 into the first storage part 261c becomes smooth. The reagent container holder 251c differs from the reagent container holder 251a having the pressing part 350 in that both side walls 355 and 356 facing each other in the X direction are arranged so as not to contact the reagent storage bag 110. Since the small-capacity reagent storage bag 110 is a flat bag composed of two sheets, even if deformation occurs, it easily returns to its original shape by its own weight, and thus shape correction by the pressing part 350 is unnecessary, and the side walls 355 and 356 do not contact the reagent storage bag 110. Note that in the first storage part 261c, the pressing part 350 may be formed on either the side wall 355 or 356 as in the first storage part 261a.

In addition, while the first storage part 261a of the reagent container holder 251a has a width narrowed toward the back side than the entrance side, the first storage part 261c of the reagent container holder 251c has a constant width from the entrance to the back. The entrance side is defined as a range between the entrance of the first storage part 261c and depthwise center position Py of the first storage part 261a. The back side (rear side) is defined as a range between the depthwise center position Py of the first storage part 261a and the innermost position of the first storage part 261a.

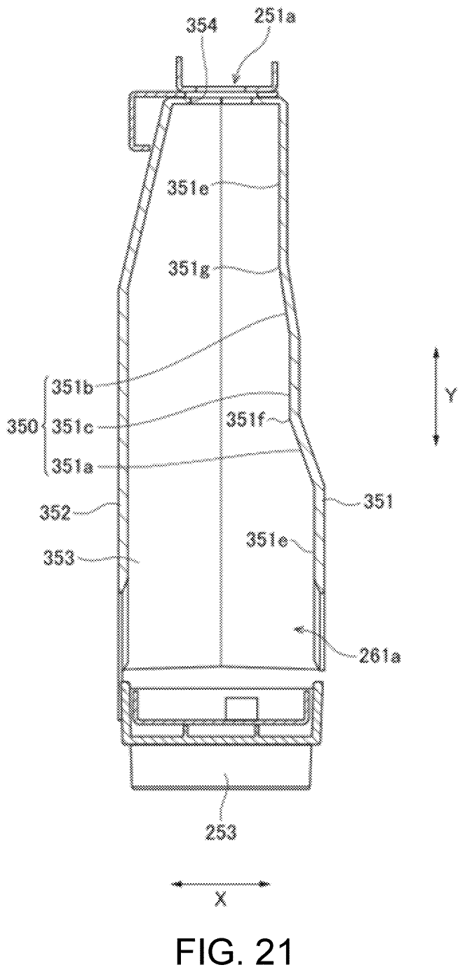

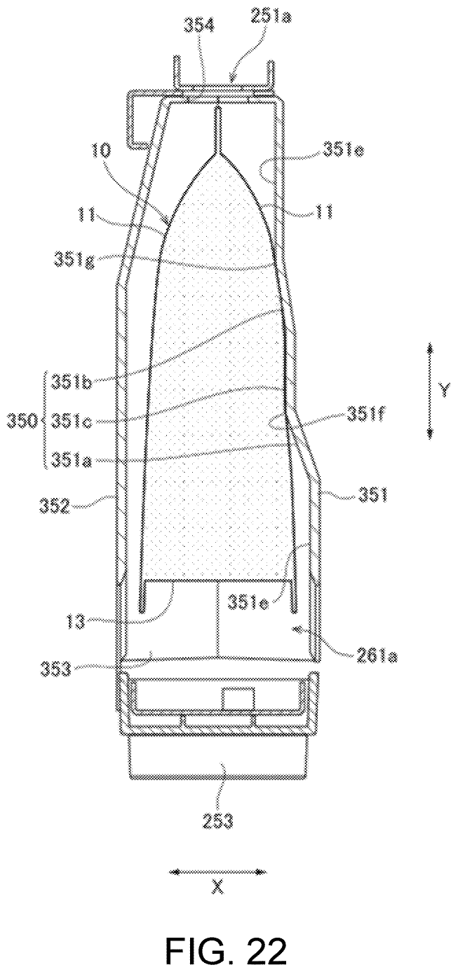

FIGS. 21 and 22 are cross-sectional views of the reagent container holder 251a. FIG. 22 shows a state where the reagent storage bag 10 is stored in the first storage part 261a.

As shown in FIGS. 21 and 22, the sample analyzer 300 comprises, in the reagent container holder 251a, the pressing part 350 that presses the reagent storage bag 10 with the opening 21a sealed from the outside. The pressing part 350 deforms the reagent storage bag 10 by pressing the reagent storage bag 10 from the outside so that the internal pressure of the reagent storage bag 10 becomes higher than before being stored in the reagent container holder 251a. That is, the pressing part 350 deforms the reagent storage bag 10 by pressing the reagent storage bag 10 from the outside so that an internal pressure of the reagent storage bag 10 increases when the reagent storage bag 10 is positioned inside the reagent container holder 251a.

The pressing part 350 is a part of the reagent container holder 251a and is formed as a part of the inner surface of the side wall 351. The inner surface of the side wall 351 is a surface facing the inside of the first storage part 261a and facing the wall surface sheet 11 of the reagent storage bag 10. Since the reagent storage bag 10 is pressed from the outside in a state where the opening 21a is sealed by the sealing plug 21b, the internal pressure of the reagent storage bag 10 rises and its shape is corrected without the reagent 12 and internal air being pushed out from the opening 21a.

Since the reagent storage bag 10 is a soft packaging material container, it is easily deformed. For example, it is expected that the wall surface sheet 11 may be deformed so as to be recessed toward the inside of the reagent storage bag 10 in the vicinity of the opening 21a into which the reagent aspiration tube 252 is inserted. If the reagent container 100 is arranged at the set position Ps with the reagent storage bag 10 deformed as such and the reagent aspiration tube 252 is inserted through the opening 21a, the tip of the reagent aspiration tube 252 may contact the wall surface sheet 11. If the tip of the reagent aspiration tube 252 contacts the wall surface sheet 11, the wall surface sheet 11 may tear and the reagent 12 may leak; therefore, it is necessary to arrange the reagent container 100 at the set position Ps in a state without such deformation. Specifically, at the set position Ps, it is necessary to ensure a state where there is no deformation such that the wall surface sheet 11 exists at a location where the reagent aspiration tube 252 of the reagent storage bag 10 passes.

Since the reagent storage bag 10 is easily deformed, its shape can be easily corrected by pressing it from the outside of the bag. That is, even if the wall surface sheet 11 is greatly recessed near the opening 21a, by pressing the reagent storage bag 10 from the outside at a position different from the recessed part, the recessed part of the wall surface sheet 11 can be made to bulge outward, and the shape of the reagent storage bag 10 can be corrected so as to retract the wall surface sheet 11 from the place where the reagent aspiration tube 252 passes.

Although details will be described later, the reagent container 100 is handled in a state of a reagent kit 450 protected by a protective member 460 in order to suppress deformation of the reagent storage bag 10 during transportation or storage; however, it is also expected that the reagent storage bag 10 may deform after being taken out from the protective member 460, for example. Therefore, it is preferable to transport the reagent container 100 in the state of the reagent kit 450 to suppress deformation of the reagent storage bag 10, and to provide the pressing part 350 in the reagent container holder 251a to correct the shape of the reagent storage bag 10.

The reagent container holder 251a has the pressing part 350 only on the side wall 351 among the side walls 351 and 352 arranged opposite to the surfaces of the reagent storage bag 10 on both sides in the thickness direction of the bag. The reagent container 100 is inserted into the reagent container holder 251a with the opening 21a side as a front end, and at this time, the wall surface sheet 11 of the reagent storage bag 10 contacts the pressing part 350 formed on the side wall 351. When the reagent container 100 is further inserted into the reagent container holder 251a from this position, the reagent storage bag 10 is pressed inward by reaction force from the pressing part 350, and the internal pressure of the reagent storage bag 10 rises and its shape is corrected. That is, the pressing part 350 presses the reagent storage bag 10 from the outside when the reagent container 100 moves relative to the reagent container holder 251a in order to insert the reagent container 100 into the reagent container holder 251a. The pressing part 350 presses a position different from below the opening 21a of the reagent storage bag 10. The reagent storage bag 10 pressed by the pressing part 350 bulges outward below the opening 21a. That is, the shape of the reagent storage bag 10 is naturally corrected by inserting the reagent container 100 into the reagent container holder 251a. Therefore, damage to the reagent storage bag 10 by the reagent aspiration tube 252 can be effectively suppressed without forcing the user to perform special work such as adjusting the shape of the reagent storage bag 10. Since the reagent storage bag 10 contains the reagent 12 and has a large weight, when the reagent storage bag 10 is pressed by the pressing part 350, the entire reagent storage bag 10 does not move to the side wall 352 side but is pressed inward, and internal pressure rises.

The pressing part 350 is formed at a position on the inner surface of the side wall 351 facing the wall surface sheet 11 where the wall surface sheet 11 can contact until the reagent container 100 reaches the set position Ps. That is, the pressing part 350 does not contact the wall surface sheet 11 for the first time when the reagent container 100 is inserted to the set position Ps, but contacts the wall surface sheet 11 and presses the reagent storage bag 10 while the reagent container 100 is moving to the set position Ps. For this reason, an end of the pressing part 350 on the entrance side of the first storage part 261a (hereinafter referred to as a “start end of the pressing part 350”) is preferably located on the entrance side of a depthwise (Y-direction) center of the first storage part 261a.

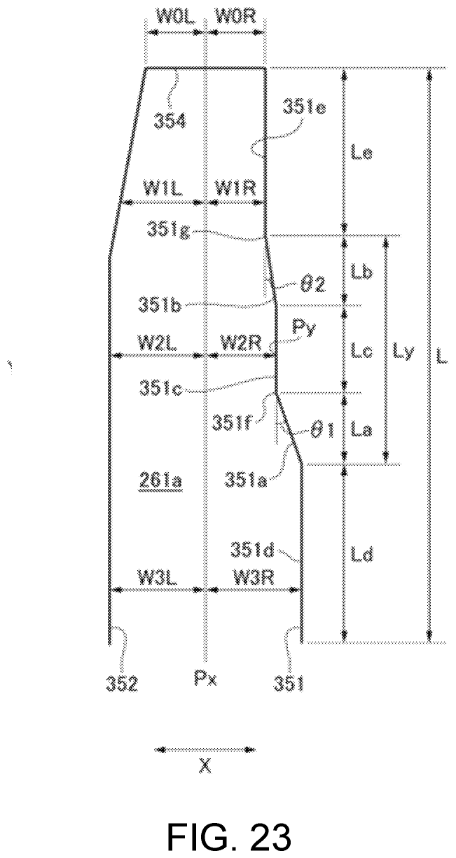

Hereinafter, FIG. 23 will be referred to as appropriate in addition to FIGS. 21 and 22. FIG. 23 is a diagram showing the inner surface portions of the side walls 351, 352 and the rear wall 354 extracted from FIG. 21. As shown in FIG. 23, the pressing part 350 is formed on the inner surface of the side wall 351 in a range of a predetermined length Ly including the depthwise center position Py of the first storage part 261a. The range of the predetermined length Ly along the depth direction of the first storage part 261a is, for example, a length range of 25% or more and 45% or less of the depthwise length L of the first storage part 261a. Since it is expected that insertion of the reagent container 100 will be hindered if the pressing part 350 is formed at the entrance of the first storage part 261a to narrow the entrance, the start end of the pressing part 350 is preferably at the depth side by a predetermined length from the entrance. A length Ld from the entrance of the first storage part 261a to the start end of the pressing part 350 is, for example, 25% or more and 40% or less of the depthwise length L of the first storage part 261a.

Furthermore, even if the pressing part 350 is formed in the vicinity of the innermost position of the first storage part 261a, the wall surface sheet 11 may not contact it, and the shape of the reagent storage bag 10 may not be corrected. For this reason, an end of the pressing part 350 on the rear side of the first storage part 261a (hereinafter referred to as a “terminal end of the pressing part 350”) is located at a position away from the rear wall 354 of the first storage part 261a. A length Le from the rear wall 354 to the terminal end of the pressing part 350 is, for example, 25% or more and 40% or less of the depthwise length L of the first storage part 261a.

As described above, the pressing part 350 is formed only on the side wall 351 and is not formed on the side wall 352 facing the side wall 351. The side wall 352 is arranged with a gap between itself and the surface of the reagent storage bag 10. Although it is possible to form the pressing part 350 on both the side walls 351 and 352, the shape of the reagent storage bag 10 can be corrected more smoothly by forming the pressing part 350 only on the side wall 351. If the pressing part 350 is formed on both the side walls 351 and 352, resistance during insertion of the reagent container 100 increases, which may hinder smooth insertion of the reagent container 100. Furthermore, pressing the reagent storage bag 10 from one side allows the reagent 12 inside the bag to move more easily, enabling quick correction of the shape of the reagent storage bag 10.

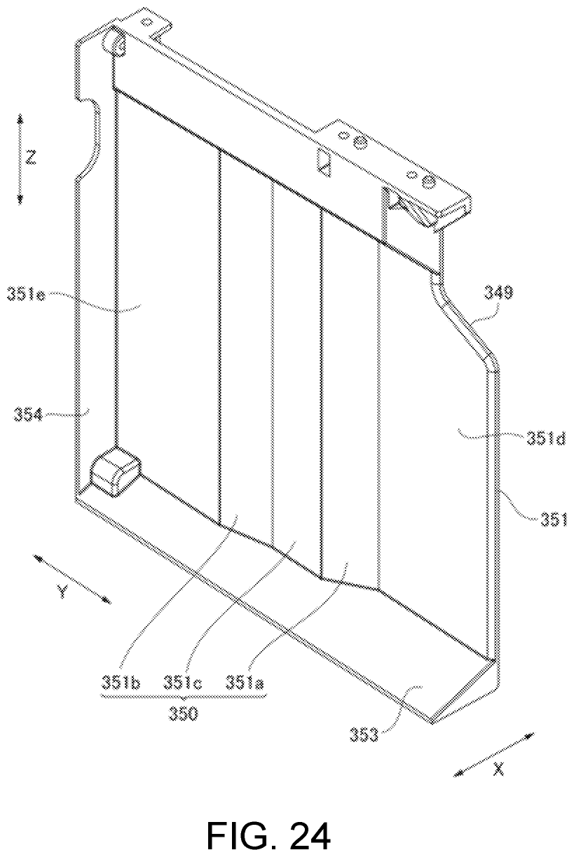

Hereinafter, FIG. 24 will be referred to as appropriate in addition to FIGS. 21 to 23. FIG. 24 is a perspective view of the inner surface of the side wall 351 on which the pressing part 350 is formed. As shown in FIGS. 21 to 24, the side wall 351 includes, as the pressing part 350, an inclined surface inclined with respect to the depth direction of the first storage part 261a so as to gradually approach the side wall 352 from the entrance side toward the rear side of the first storage part 261a. This inclined surface is formed between the entrance of the first storage part 261a and the position of the opening 21a of the reagent container 100 in a state where the reagent storage bag 10 is stored in the first storage part 261a. In other words, the side wall 351 includes, as the pressing part 350, an oblique part that is inclined with respect to an insertion direction of the reagent container 100 into the internal space of the first storage part 261a. The oblique part is formed between the entrance of the internal space and the inner area (the position of the opening 21a) of the internal space. At an area on the oblique part, the side wall 351 gradually approaches the side wall 352 toward the inner area of the internal space.

The inclined surface of the side wall 351 includes a first inclined surface 351a, and a second inclined surface 351b formed between the inner area (the position of the opening 21a) of the first storage part 261a and the first inclined surface 351a and having a smaller inclination angle with respect to the depth direction of the first storage part 261a than the first inclined surface 351a. In other words, the oblique part includes a first oblique part (the first inclined surface 351a) and a second oblique part (the second inclined surface 351b). The first oblique part is disposed at a position between the entrance of the internal space and the second oblique part. The first inclined surface 351a extends straight at a constant angle with respect to the depth direction of the first storage part 261a from a boundary position with an entrance side region 351d to a boundary position with an intermediate region 351c. Similarly, the second inclined surface 351b extends straight at a constant angle with respect to the depth direction of the first storage part 261a from the boundary position with the intermediate region 351c to a boundary position with a rear side region 351e.

On the inner surface of the side wall 351, an intermediate region 351c along the depth direction of the first storage part 261a is further formed between the first inclined surface 351a and the second inclined surface 351b. In other words, the first side wall 351 includes a region (the intermediate region 351c) parallel to the insertion direction of the reagent container 100 between the first oblique part (the first inclined surface 351a) and the second oblique part (the second inclined surface 351b). The first inclined surface 351a, the second inclined surface 351b, and the intermediate region 351c function as the pressing part 350 that presses the reagent storage bag 10 from the outside to correct the shape of the bag. The inner surface of the side wall 351 includes an entrance side region 351d located between the entrance of the first storage part 261a and the start end of the pressing part 350, and a rear side region 351e located between the innermost position of the first storage part 261a and the terminal end of the pressing part 350., The entrance side region 351d and the rear side region 351e may not contact the reagent storage bag 10.

The entrance side region 351d and the rear side region 351e extend parallel to the depth direction of the first storage part 261a and are arranged so that a predetermined gap exists between themselves and the reagent storage bag 10 when the reagent container 100 is arranged at the set position Ps. Note that although the reagent storage bag 10 does not contact the boundary position between the first inclined surface 351a and the entrance side region 351d and the vicinity thereof, this boundary position is defined as the start end of the pressing part 350.

The first inclined surface 351a largely protrudes in the direction of the side wall 352 and strongly presses the reagent storage bag 10. The reagent storage bag 10 is strongly squeezed by the first inclined surface 351a on the entrance side, and its shape is greatly corrected. Since the second inclined surface 351b has a smaller degree of protrusion than the first inclined surface 351a, the force for pressing the reagent storage bag 10 is weaker compared to the first inclined surface 351a, and contributes to the shape adjustment of the reagent storage bag 10. The first inclined surface 351a and the second inclined surface 351b may be continuous, but by forming the intermediate region 351c between the two inclined surfaces, the inner surface of the side wall 351 is greatly bent particularly at the boundary position between the first inclined surface 351a and the intermediate region 351c, and a corner 351f is formed at the boundary position.

The corner 351f formed at the boundary position between the first inclined surface 351a and the intermediate region 351c is a corner convex in the direction of the side wall 352 and strongly contacts the wall surface sheet 11 of the reagent storage bag 10. When the reagent container 100 is inserted from the entrance of the first storage part 261a, for example, the wall surface sheet 11 contacts and is pressed by the first inclined surface 351a, and subsequently contacts and is further pressed by the corner 351f. By being strongly squeezed by the first inclined surface 351a and the corner 351f that largely protrude inside the first storage part 261a, deformation of the reagent storage bag 10 is effectively corrected.

The entire first inclined surface 351a and the corner 351f are formed on the entrance side of the first storage part 261a. In this case, while the reagent container 100 is moving to the set position Ps of the reagent container holder 251a, the wall surface sheet 11 contacts and is pressed by the first inclined surface 351a and the corner 351f, and the shape of the reagent storage bag 10 is corrected. The first inclined surface 351a and the corner 351f press the front-rear direction center portion or the like of the greatly bulged reagent storage bag 10 to increase the internal pressure. Therefore, even if the front end side of the reagent storage bag 10 is deformed to be recessed, the reagent 12 flows to the front end side of the bag, and the wall surface sheet 11 is pushed out to the outside of the reagent storage bag 10.

The entire second inclined surface 351b is formed on the rear side of the first storage part 261a, and for example, further corrects the shape of the reagent storage bag 10 that could not be fully corrected by the first inclined surface 351a or the like, or applies an appropriate pressing force to maintain the corrected shape. The second inclined surface 351b has a function of adjusting the shape of the reagent storage bag 10 in the vicinity of the opening 21a.

The corner 351g formed at the boundary position between the second inclined surface 351b and the rear side region 351e is a corner convex in the direction of the side wall 352 and strongly contacts the wall surface sheet 11 of the reagent storage bag 10. Therefore, when the reagent container 100 is inserted from the entrance of the first storage part 261a, for example, the wall surface sheet 11 contacts and is pressed by the second inclined surface 351b, and subsequently contacts and is further pressed by the corner 351g; however, the degree of protrusion of the corner 351g is smaller than that of the corner 351f. The reagent storage bag 10 is, for example, additionally corrected by the corner 351g and its shape is adjusted.

The intermediate region 351c is parallel to the depth direction of the first storage part 261a. Distance between the intermediate region 351c and the side wall 352 is shorter than distance between the entrance side region 351d and the side wall 352. The intermediate region 351c contacts and presses the reagent storage bag 10, thereby functioning as the pressing part 350 that corrects the shape of the reagent storage bag 10. In particular, the intermediate region 351c is important for forming the steep corner 351f at the boundary position with the first inclined surface 351a. By interposing the intermediate region 351c without making the first inclined surface 351a and the second inclined surface 351b continuous, the multi-stage pressing part 350 including the steep corner 351f is formed on the inner surface of the side wall 351. This improves the shape correction effect of the reagent storage bag 10.

As shown in FIG. 23, an inclination angle θ1 of the first inclined surface 351a with respect to the depth direction of the first storage part 261a is, for example, 15° or more and 30° or less, and more preferably 15° or more and 25° or less. Further, a length La along the depth direction of the first inclined surface 351a is, for example, 8% or more and 20% or less of the depthwise length L of the first storage part 261a, and more preferably 10% or more and 15% or less. In this case, the effect of shape correction of the reagent storage bag 10 by the first inclined surface 351a and the corner 351f becomes more prominent.

An inclination angle θ2 of the second inclined surface 351b with respect to the depth direction of the first storage part 261a is smaller than the inclination angle of the first inclined surface 351a. In other words, an angle (θ2) between the insertion direction (the depth direction) and an inclination of the second oblique part (inclination of the second inclined surface 351b) is smaller than an angle (θ1) between the insertion direction (the depth direction) and an inclination of the first oblique part (inclination of the first inclined surface 351a). The inclination angle θ2 may be, for example, 30% or more and 70% or less, more preferably 40% or more and 60% or less of the angle θ1. Further, a length Lb along the depth direction of the second inclined surface 351b is, for example, shorter than the length La of the first inclined surface 351a and is 5% or more and 15% or less of the depthwise length L of the first storage part 261a. In this case, the effect of shape correction by the second inclined surface 351b and the corner 351g becomes more prominent.

A length Lc along the depth direction of the intermediate region 351c is, for example, 8% or more and 20% or less of the depthwise length L of the first storage part 261a. In the present embodiment, the intermediate region 351c is located at and around the depthwise center position Py of the first storage part 261a.

A distance W2R along the X direction from a widthwise center position Px of the first storage part 261a to the intermediate region 351c is smaller than a distance W2L along the X direction from the widthwise center position Px to a region of the side wall 352 facing the intermediate region 351c, for example, smaller by 10% or more. A suitable example of a ratio of the distance W2R to the distance W2L (W2R/W2L) is 60% or more and 85% or less, or 65% or more and 80% or less. In this case, the shape of the reagent storage bag 10 can be more effectively corrected while preventing the reagent storage bag 10 from contacting the side wall 352.

In the present embodiment, a distance W3R along the X direction from the widthwise center position Px to the entrance side region 351d is substantially the same as a distance W3L along the X direction from the widthwise center position Px to a region of the side wall 352 facing the entrance side region 351d. The side wall 352 is formed along the depth direction from the entrance of the first storage part 261a to a position facing the second inclined surface 351b in the X direction, and is gradually inclined inward from the position facing the second inclined surface 351b toward the rear wall 354. Then, at the innermost position of the first storage part 261a, a distance W0R along the X direction from the widthwise center position Px to the rear side region 351e is substantially the same as a distance W0L along the X direction from the widthwise center position Px to a region of the side wall 352 facing the rear side region 351e.

At the entrance of the first storage part 261a and the vicinity thereof, lengths in the X direction from the widthwise center position Px to the side walls 351 and 352 are equal. A distance between the side walls 351 and 352 at the entrance of the first storage part 261a is, for example, 103% or more and 110% or less of the maximum thickness of the reagent storage bag 10, and as an example, is 35 mm or more and 50 mm or less. Also, at the innermost position of the first storage part 261a, lengths in the X direction from the widthwise center position Px to the side walls 351 and 352 are equal. An example of the distance between the side walls 351 and 352 at the innermost position of the first storage part 261a is 20 mm or more and 28 mm or less.

A distance W1R along the X direction from the widthwise center position Px of the first storage part 261a to the rear side region 351e is, for example, 30% or more smaller than a maximum value of a distance W1L along the X direction from the widthwise center position Px to a region of the side wall 352 facing the rear side region 351e. A suitable example of a ratio of the distance W1R to the maximum value of the distance W1L (W1R/W1L) is 30% or more and 70% or less. Since the region of the side wall 352 facing the rear side region 351e is inclined so as to gradually approach the side wall 351 toward the rear wall 354, W1R/W1L gradually becomes smaller as it approaches the rear wall 354. While the width of the first storage part 261a narrows toward the rear, the reagent storage bag 10 tapers toward the front end, so the reagent storage bag 10 does not contact the side wall 352.

As shown in FIG. 24, the pressing part 350 is formed over substantially the entire length in the vertical direction of the side wall 351 in a range facing the reagent storage bag 10. Since the upper end portion and the lower end portion of the reagent storage bag 10 have small thicknesses, they are unlikely to contact the pressing part 350, but at least portions away from the upper end and the lower end of the reagent storage bag 10 contact and are pressed by the pressing part 350. The first inclined surface 351a, the second inclined surface 351b, and the intermediate region 351c are formed with a constant width along the vertical direction of the side wall 351.

The reagent container holder 251a is configured by assembling a plurality of members. For example, the side wall 351 partitioning the first storage part 261a, half of the bottom part 353, and half of the rear wall 354 are composed of an integrally molded first member. Further, the side wall 352, half of the bottom part 353, and half of the rear wall 354 are composed of an integrally molded second member, and the first storage part 261a is formed by assembling with the first member. Further, as described above, the recesses 349 for reducing the wall height to make it easy to grip the grip part 25 of the reagent container 100 are formed at the entrance side ends of the storage space 260 of the side walls 351 and 352.

The pressing part that corrects the shape of the reagent storage bag 10 only needs to be able to press the reagent storage bag 10, and may be a gentle slope or a curved surface. However, with a gentle slope or a curved surface, for example, the internal pressure of the reagent storage bag 10 rises gradually, and the reagent 12 does not flow significantly. As a result, the effect of shape correction of the reagent storage bag 10 by the pressing part may decrease. As in the present embodiment, by arranging the first inclined surface 351a with a steep slope and providing a plurality of inclined surfaces or steps to form a step-like pressing part 350 in the depth direction of the first storage part 261a, the effect of shape correction of the reagent storage bag 10 becomes more prominent. In particular, according to the pressing part 350 formed of the first inclined surface 351a, the intermediate region 351c, and the second inclined surface 351b in this order from the entrance side of the first storage part 261a, the shape of the reagent storage bag 10 can be effectively corrected while ensuring smooth insertion of the reagent storage bag 10 into the first storage part 261a.

Hereinafter, a method for setting the reagent container 100 in the reagent container holder 251a of the reagent aspiration part 250a having the above configuration will be described with reference to FIGS. 13, 14, and the like.

First, the user opens the front cover 206a (see FIG. 9), grips the handle 253a of the reagent aspiration part 250, pulls up the operation part 253, and moves it to the removal position Q1 (see FIG. 17). Thereby, the entrance of the storage space 260a of the reagent container holder 251a is opened. Note that the reagent aspiration tube 252 moves to the upper position P1 as the operation part 253 moves to the removal position Q1.

Next, the user grips the grip part 25 of the frame member 23 of the reagent container 100, and inserts the reagent container 100 into the storage space 260a of the reagent container holder 251a with the plug member 21 side as a front end. At this time, both widthwise end portions of the frame member 23 fit into the guide grooves 270 of the reagent container holder 251a, and the frame member 23 becomes slidable in the Y direction in the second storage part 262 of the storage space 260a.

When the frame member 23 reaches the installation position of the protruding members 273, the frame member 23 pushes the protruding members 273 outward in the X direction. Since the frame member 23 is urged from both sides in the width direction by the pair of protruding members 273, a center position of the frame member 23 is aligned with the center of the second storage part 262 in the X direction. Then, by the front end 23a of the frame member 23 coming into contact with the innermost groove wall of the guide groove 270, the reagent container 100 is arranged at the set position Ps where the opening 21a is located immediately below the reagent aspiration tube 252. At this time, the pair of protruding members 273 fit into the notches 23c of the frame member 23, and movement of the frame member 23 in the Y direction is restricted.

The reagent storage bag 10 of the reagent container 100 is slidable in the Y direction in the first storage part 261a of the storage space 260a. Since the thickness of the reagent storage bag 10 on the plug member 21 side is small and the pressing part 350 is not formed near the entrance of the first storage part 261a, the reagent storage bag 10 does not contact the pressing part 350 formed on the side wall 351 for a while after the reagent storage bag 10 is inserted into the first storage part 261a. Near the entrance of the first storage part 261a, since the distance between the side walls 351 and 352 located on both sides in the X direction of the reagent storage bag 10 is wide, the reagent container 100 can be inserted smoothly.

When the front end of the reagent storage bag 10 is inserted to the rear side beyond the depthwise center position Py of the first storage part 261a, the wall surface sheet 11 of the reagent storage bag 10 contacts the first inclined surface 351a of the pressing part 350 and is pressed from the outside of the reagent storage bag 10. Since the reagent storage bag 10 is pressed in a state where the opening 21a is sealed by the sealing plug 21b, the internal pressure of the reagent storage bag 10 increases without the reagent 12 and air being pushed out from the opening 21a. As a result, for example, when the wall surface sheet 11 below the plug member 21 is deformed so as to be recessed toward the inside of the reagent storage bag 10, the wall surface sheet 11 below the plug member 21 is pushed out so as to bulge outward, and the shape of the reagent storage bag 10 is corrected.

When the reagent storage bag 10 is further inserted, the reagent storage bag 10 contacts a corner 351f formed at a boundary position between the first inclined surface 351a and the intermediate region 351c, and receives a stronger pressing force. At this time, the internal pressure of the reagent storage bag 10 further increases, and the wall surface sheet 11 recessed toward the inside of the reagent storage bag 10 is pushed outward. Since the first inclined surface 351a and the corner 351f are formed between the entrance and the depthwise center of the first storage part 261a, the shape of the reagent storage bag 10 can be corrected sufficiently before the reagent container 100 reaches the set position Ps.

Before the reagent container 100 reaches the set position Ps, the reagent storage bag 10 is further pressed by the intermediate region 351c of the pressing part 350, the second inclined surface 351b, and a corner 351g formed at a boundary position between the second inclined surface 351b and the rear side region 351e. Although pressing forces from the intermediate region 351c, the second inclined surface 351b, and the corner 351g are smaller compared to the pressing forces from the first inclined surface 351a and the corner 351f, the shape of the reagent storage bag 10 is thereby adjusted and the corrected shape is maintained. Note that since the side wall 352 is arranged away from the widthwise center of the first storage part 261a, the reagent storage bag 10 does not contact the side wall 352. Therefore, insertion resistance of the reagent container 100 can be reduced, and smooth insertion is possible.

The reagent storage bag 10 bulges more on the gusset sheet 13 side arranged on the entrance side of the first storage part 261a than on the opening 21a side arranged on the rear side of the first storage part 261a. Therefore, once the reagent storage bag 10 contacts the pressing part 350, thereafter the reagent storage bag 10 is always in contact with the pressing part 350 and receives pressing force from the pressing part 350. The deformation of the reagent storage bag 10 that can be problematic is a deformation in which the wall surface sheet 11 is recessed toward the inside of the reagent storage bag 10 in the vicinity of the opening 21a into which the reagent aspiration tube 252 is inserted; however, even when a portion away from the opening 21a of the reagent storage bag 10 is pressed, the internal pressure increases, and the shape of the reagent storage bag 10 is corrected so that the wall surface sheet 11 in the vicinity of the opening 21a is pushed outward.

Thereafter, the user lowers the operation part 253 of the reagent aspiration part 250a to move it from the removal position Q1 toward the removal prevention position Q2 (see FIG. 18). Along with this, the reagent aspiration tube 252 and the fixing pin 280 move downward. First, the fixing pin 280 is inserted into the through hole 23d of the frame member 23, and then the reagent aspiration tube 252 is inserted into the opening 21a of the plug member 21. Since the aspiration tube guide part 21c is provided inside the reagent storage bag 10 below the opening 21a, even if the entry angle of the reagent aspiration tube 252 is slightly inclined with respect to the central axis of the cylindrical part 21d forming the opening 21a, the tip of the reagent aspiration tube 252 is guided toward the bottom of the reagent storage bag 10 by the aspiration tube guide part 21c without contacting the inner surface of the reagent storage bag 10.

As described above, even if the wall surface sheet 11 of the reagent storage bag 10 is greatly recessed in the vicinity of the opening 21a before insertion into the reagent container holder 251a, the shape of the reagent storage bag 10 is corrected by contacting and being pressed by the pressing part 350. The pressing force of the pressing part 350 increases the internal pressure of the reagent storage bag 10, and for example, the reagent 12 flows from the rear end side toward the front end side of the reagent storage bag 10. As a result, the recessed wall surface sheet 11 is pushed out to the outside of the reagent storage bag 10, the wall surface sheet 11 can be retracted from a place where the reagent aspiration tube 252 passes, and damage to the reagent storage bag 10 due to the reagent aspiration tube 252 contacting the wall surface sheet 11 can be effectively suppressed.

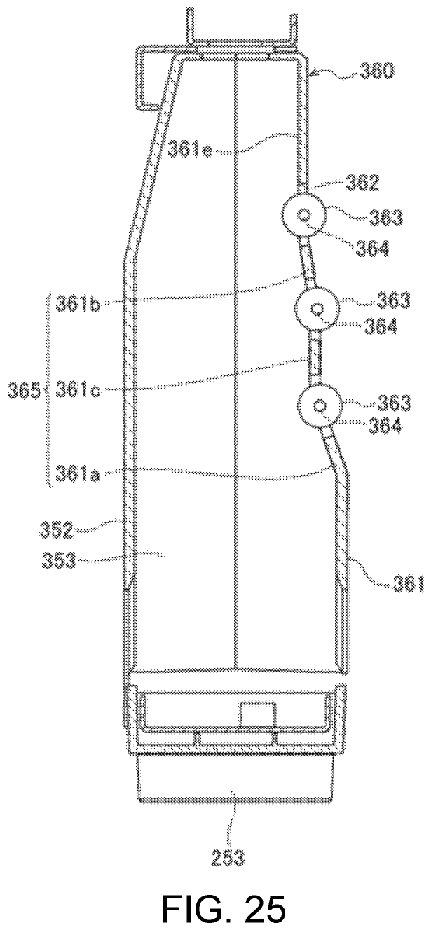

Hereinafter, modifications of the pressing part 350 will be described with reference to FIGS. 25 to 29. Hereinafter, the same reference numerals are used for the same constituent elements as those in the above embodiment, and redundant descriptions are omitted.

A pressing part 365 shown in FIG. 25 is common to the pressing part 350 of the above embodiment in that it has a first inclined surface 361a, an intermediate region 361c, and a second inclined surface 361b formed on an inner surface of a first side wall 361 of a reagent container holder 360 facing the surface of the reagent storage bag 10. On the other hand, the pressing part 365 differs from the pressing part 350 in that it has pressing rollers 363. Each pressing roller 363 includes a rotation shaft 364 along a vertical direction and is installed so as to be rotatable about the rotation shaft 364. The pressing roller 363 protrudes from the inner surface of the side wall 361, contacts the surface of the reagent storage bag 10, and presses the reagent storage bag 10 from the outside. The pressing roller 363 may rotate by contacting the reagent storage bag 10 when the reagent storage bag 10 is inserted into the reagent container holder 360, or may be driven to rotate by an electric motor or the like.

A plurality of pressing rollers 363 are installed in the reagent container holder 360. Openings 362 that allow the pressing rollers 363 to protrude into a storage space of the reagent container holder 360 are formed in the side wall 361, and the pressing rollers 363 are arranged in a state where a part of each roller protrudes into the storage space through the opening 362. Further, the pressing rollers 363 are arranged at three locations: a boundary position between the first inclined surface 361a and the intermediate region 361c, a boundary position between the intermediate region 361c and the second inclined surface 361b, and a boundary position between the second inclined surface 361b and the rear side region 361e. The pressing roller 363 may be detachable from the reagent container holder 360.

According to the pressing part 365, in addition to the first inclined surface 361a, the intermediate region 361c, and the second inclined surface 361b, the reagent storage bag 10 is further pressed from the outside by the three pressing rollers 363, and the shape of the bag is corrected. The size of the pressing roller 363, the degree of protrusion from the inner surface of the side wall 361, and the like are not particularly limited, and the pressing roller 363 may be urged toward the storage space and be movable in a horizontal direction. Further, the number and arrangement of the pressing rollers 363 are not particularly limited, and for example, two or fewer or four or more pressing rollers 363 may be installed side by side in the depth direction of the reagent container holder 360.

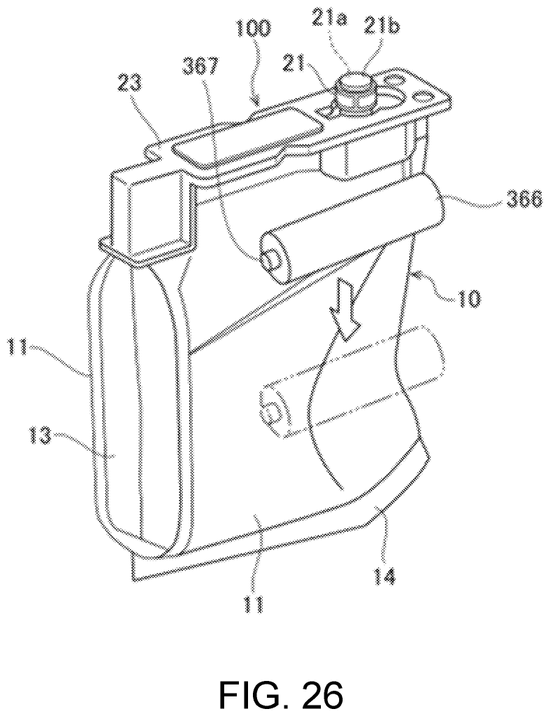

A pressing roller 366 shown in FIG. 26 differs from the pressing roller 363 shown in FIG. 25 in that it includes a rotation shaft 367 along the depth direction of the reagent container holder. Further, the pressing roller 366 is provided so as to be movable in the vertical direction. The pressing roller 366 moves in the vertical direction within the reagent container holder while pressing the reagent storage bag 10 to correct the shape of the bag. The pressing roller 366 may rotate by contacting the reagent storage bag 10 when the reagent storage bag 10 is inserted into the reagent container holder 360, or may be driven to rotate by an electric motor or the like. Further, the pressing roller 366 may be configured to move in the vertical direction in conjunction with the reagent aspiration tube 252 by the moving mechanism 254 and descend before the reagent aspiration tube 252. The pressing roller 366 may be detachable from the reagent container holder 360 or the reagent aspiration part.

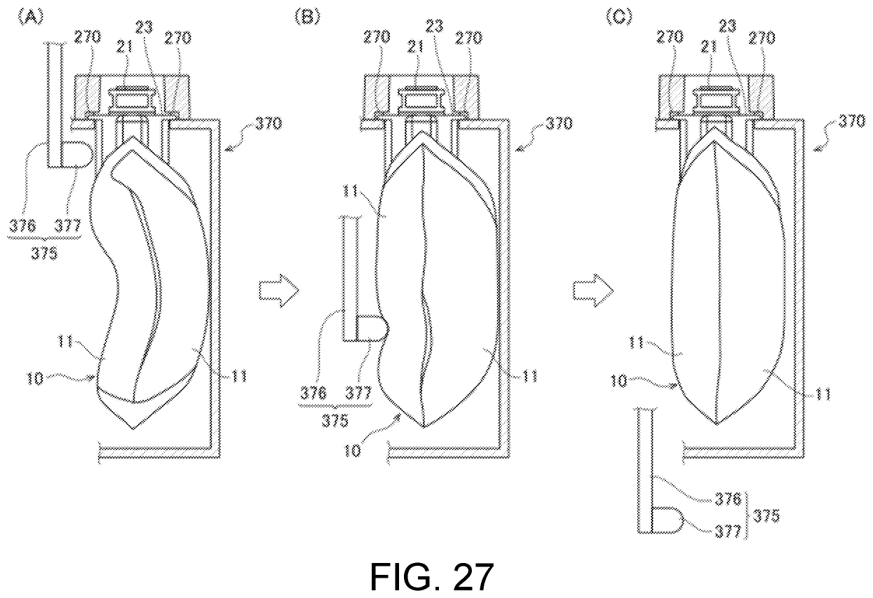

A pressing member 375 shown in FIG. 27 is common to the pressing roller 366 shown in FIG. 26 in that it functions as a pressing part that presses the reagent storage bag 10 from the outside in a reagent container holder 370 and is movable in the vertical direction. The pressing member 375 comprises a support shaft 376 that extends in the vertical direction and enters a storage space of the reagent container holder 370, and a convex portion 377 formed at a tip end of the support shaft 376. The convex portion 377 protrudes in a direction toward the reagent storage bag 10 held in the reagent container holder 370 and presses the surface of the bag from the outside. The pressing member 375 may be detachable from the reagent container holder 370 or the reagent aspiration part.

The pressing member 375 is configured, for example, to move in the vertical direction in conjunction with the reagent aspiration tube 252 by the moving mechanism 254 and to descend before the reagent aspiration tube 252. As shown in (A) to (C) of FIG. 27, the pressing member 375 comes into contact with an upper portion of the reagent storage bag 10 and presses the reagent storage bag 10 while moving from top to bottom. Thereby, the internal pressure of the reagent storage bag 10 increases and the reagent 12 as contents flows, and the recessed part of the wall surface sheet 11 is pushed out to correct the shape of the reagent storage bag 10.

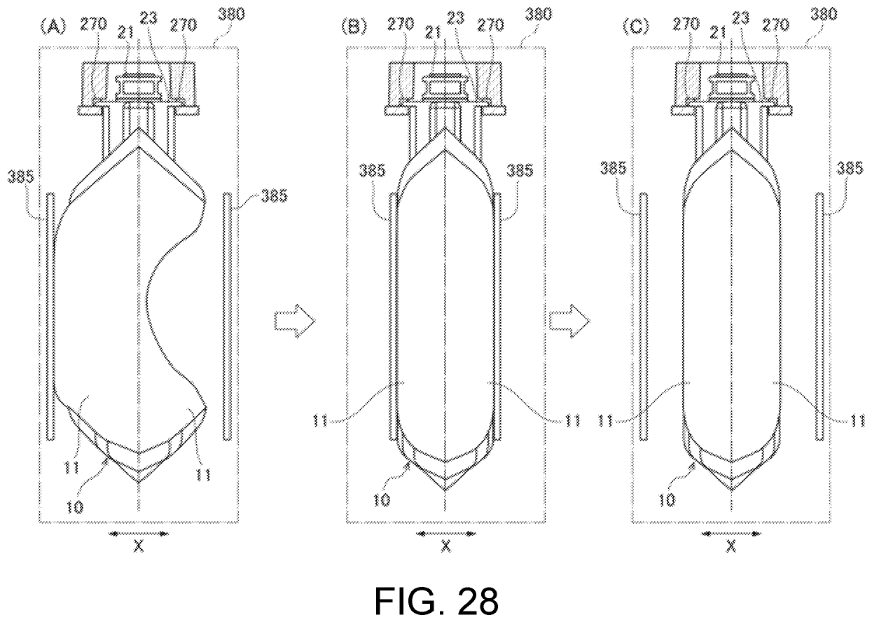

A pressing member 385 shown in FIG. 28 is provided in a reagent container holder 380 at a position facing the reagent storage bag 10 in the X direction, and presses the reagent storage bag 10 from both sides in the X direction. The pressing member 385 is, for example, a pair of moving walls that are part of walls constituting a storage space of the reagent container holder 380 and move in the X direction. The pressing member 385 may be provided so as to be movable in the X direction by an electric motor or the like, or may be urged in a direction toward the storage space. Further, the pressing member 385 may be detachable from the reagent container holder 380 or the reagent aspiration part.

As shown in (B) and (C) of FIG. 28, the pair of pressing members 385 move toward the inside of the reagent container holder 380 and press the reagent storage bag 10 from both sides in the X direction. Thereby, the internal pressure of the reagent storage bag 10 increases and the reagent 12 flows, and the recessed part of the wall surface sheet 11 is pushed out to correct the shape of the reagent storage bag 10. In the example shown in FIG. 28, the pair of moving walls provided on both sides in the X direction of the reagent container holder 380 move in the direction of the reagent storage bag 10; however, a moving wall may be provided on only one side in the X direction of the reagent container holder to press the reagent storage bag 10 from one side in the X direction. In this case as well, the internal pressure of the reagent storage bag 10 can be increased, and the shape of the reagent storage bag 10 can be corrected.

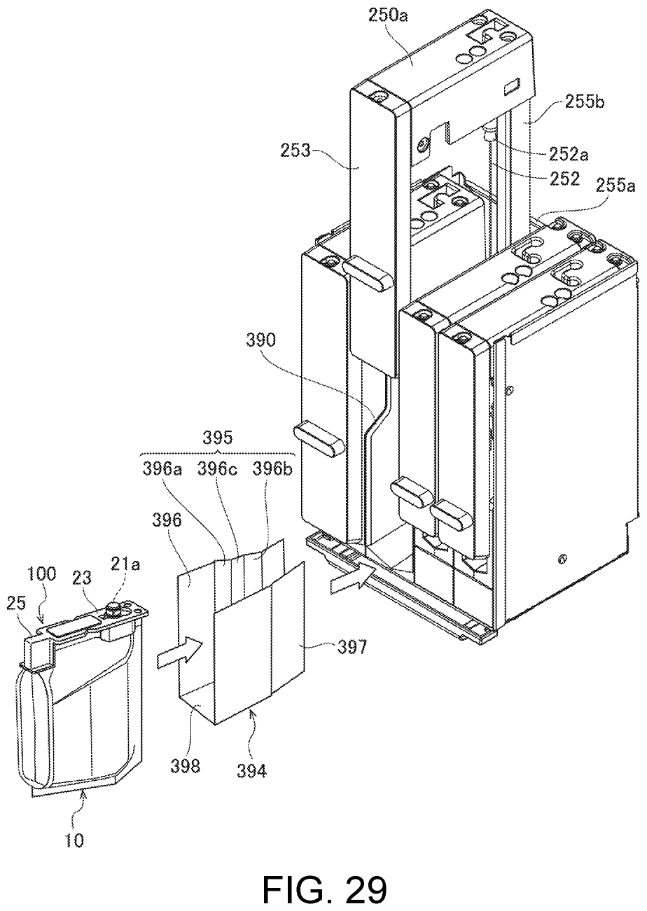

As shown in FIG. 29, the reagent container 100 may be inserted into a reagent container holder 390 in a state of being held by a pressing attachment 394. The pressing attachment 394 comprises a pressing part 395 that presses the reagent storage bag 10 from the outside, and is inserted into the reagent container holder 390 together with the reagent container 100. It can be said that the reagent container holder 390 includes the pressing attachment 394 as a detachable pressing part. The pressing attachment 394 is a holding member for the reagent container 100, having a plate-like bottom part 398 extending in a depth direction of the reagent container holder 390, and side walls 396 and 397 erected at both widthwise end portions of the bottom part 398.

The pressing attachment 394 comprises the pressing part 395 including a first inclined surface 396a, an intermediate region 396c, and a second inclined surface 396b. The pressing part 395 is formed on the side wall 396. The shapes and arrangements on the side wall 396 of the first inclined surface 396a, the intermediate region 396c, and the second inclined surface 396b respectively correspond to the shapes and arrangements of the first inclined surface 351a, the intermediate region 351c, and the second inclined surface 351b constituting the pressing part 350 of the reagent container holder 251. Note that the pressing attachment 394 may be capable of hanging the reagent container 100 similarly to a protective member of a reagent kit described later, and the protective member may also serve as the pressing attachment 394. Further, the pressing attachment may be connected to the reagent container holder and be capable of being pulled out from the reagent container holder.

Hereinafter, a structure of a reagent kit 450 as an example of an embodiment, particularly a structure of a protective member 460 for protecting the reagent container 100, will be described in detail with reference to FIGS. 30 to 36.

FIG. 30 is a perspective view of the reagent kit 450 seen from the front. Note that a direction in which a front end of the reagent container 100 (front end 23a of the frame member 23) faces is defined as a front of the reagent kit 450, and a direction in which a rear end of the reagent container 100 (rear end 23b of the frame member 23) faces is defined as a rear of the reagent kit 450.

As shown in FIG. 30, the reagent kit 450 comprises the reagent container 100 and the protective member 460 configured to protect the reagent container 100. The reagent kit 450 further comprises a storage box 451 configured to store the reagent container 100 and the protective member 460. The reagent container 100 is stored in the storage box 451 in a state of being protected by the protective member 460. The reagent container 100 includes, as described above, the reagent storage bag 10 which is a soft packaging material container, the plug member 21 joined to the reagent storage bag 10, and the frame member 23 attached to the reagent storage bag 10 via the plug member 21. The plug member 21 forms the opening 21a for taking out the reagent 12 contained in the reagent storage bag 10. Note that the opening 21a is sealed by the sealing plug 21b so that the reagent 12 does not leak out from the opening 21a.

The reagent container 100 is protected by the protective member 460 and transported and stored in a state of being stored in the storage box 451. As will be described in detail later, the protective member 460 has a container hanging structure configured to hang the reagent storage bag 10 in a state where a bottom portion of the reagent storage bag 10 is not supported from its below and the opening 21a is sealed by the sealing plug 21b. The container hanging structure includes, for example, a housing having an internal space capable of housing the reagent storage bag 10 therein, an upper end of the housing is a support part for supporting the frame member 23, and a length T1 from the upper end to a lower end of the housing is longer than a length H1 of the reagent storage bag 10 in the vertical direction. Since the reagent storage bag 10 is a soft packaging material container that easily deforms, it may deform significantly due to its own weight if, for example, it is transported or stored in a state where the bottom portion of the reagent storage bag 10 is in contact with an inner bottom surface of the storage box 451. For this reason, the protective member 460 prevents the bottom portion of the reagent storage bag 10 from contacting the inner bottom surface of the storage box 451, thereby suppressing deformation of the reagent storage bag 10.

During transportation of the reagent container 100, it is expected that a large force is applied to the reagent storage bag 10 due to impact or vibration, causing significant deformation of the reagent storage bag 10. Even if the reagent storage bag 10 is significantly deformed, the shape of the reagent storage bag 10 is corrected by the pressing part of the sample analyzer 300; however, if the reagent storage bag 10 is significantly deformed before insertion into the reagent container holder 251, it may not be possible to insert the reagent storage bag 10 smoothly. For this reason, it is desirable to suppress deformation of the bag before use of the reagent container 100. Furthermore, if deformation of the reagent storage bag 10 can be suppressed by the function of the protective member 460, damage to the reagent storage bag 10 due to piercing by the reagent aspiration tube can be effectively suppressed even when the reagent container 100 is arranged in a reagent container holder that does not have a pressing part.

The protective member 460 is a member that protects the reagent container 100 during transportation of the reagent kit 450, and alleviates impact and vibration that can act on the reagent container 100, thereby suppressing deformation of the reagent storage bag 10. As described above, the protective member 460 has a hanging structure for the reagent container 100, and holds the reagent container 100 in a state where the bottom portion of the reagent storage bag 10 does not contact the inner bottom surface of the storage box 451 but is floating from the inner bottom surface. Since the reagent storage bag 10 is a soft packaging material container, it deforms significantly due to its own weight when the bottom portion is placed on the inner bottom surface of the storage box 451; however, by hanging the reagent storage bag 10, such deformation of the bag can be suppressed and the reagent container 100 can be protected. Although details will be described later, in the present embodiment, the reagent container 100 is hung using the frame member 23. Furthermore, the protective member 460 is a self-standing object in a state of protecting the reagent container 100.

The protective member 460 has an internal space for housing the reagent storage bag 10, and a wall forming the internal space is configured with a material having higher rigidity than the reagent storage bag 10. The protective member 460 may be configured with a material having flexibility similarly to the reagent storage bag 10, but is configured with, for example, a material having a larger thickness and higher rigidity than the sheets constituting the reagent storage bag 10. The protective member 460 is formed in a cylindrical shape so as to surround the reagent storage bag 10, and has a structure in which both axial ends of the cylinder are open so that the reagent storage bag 10 can be inserted into the internal space of the cylinder. The reagent container 100 is held by the protective member 460 in a state where the reagent storage bag 10 is inserted into the internal space and the frame member 23 is placed on a cylinder wall.

The protective member 460 may be configured with resin, but is preferably configured with paper material from the viewpoints of manufacturing cost, reduction of environmental burden, and the like. Here, the “paper material” means a material configured mainly with plant fibers, and synthetic paper mainly composed of resin is not intended. Note that the paper material may contain a resin component in an amount of 5% or less as an additive. The protective member 460 is configured with, for example, cardboard or corrugated cardboard, and more preferably configured by forming a single sheet of cardboard into a cylindrical shape. The thickness of the cardboard is preferably 0.5 mm or more and 1.5 mm or less, or 0.7 mm or more and 1.2 mm or less. If the thickness of the cardboard is 0.5 mm or more, the protective member 460 can hang the reagent storage bag 10 and can be self-standing in a state of holding the reagent container 100.

The protective member 460 comprises a pair of side parts 461 as walls forming the internal space, and a rear part 462 formed so as to connect the side parts 461 to each other. The protective member 460 is configured by, for example, forming a single sheet of cardboard into a cylindrical shape, and has a tube shape corresponding to the shape of the reagent storage bag 10. As described above, the reagent storage bag 10 has a shape in which the gusset sheet 13 side bulges greatly and the thickness decreases toward the plug member 21 side. The protective member 460 has a triangular shape in a plan view according to the shape of the reagent storage bag 10. Although details will be described later, the protective member 460 is formed in an isosceles triangular shape with a sharp front end. The reagent storage bag 10 is inserted into the internal space of the protective member 460 such that the wall surface sheets 11 face the side parts 461 and the gusset sheet 13 faces the rear part 462.

The side part 461 supports the frame member 23 in a state where the reagent storage bag 10 is inserted into the internal space of the protective member 460, and supports the reagent storage bag 10 via the frame member 23. The side part 461 has a height (vertical length) such that the bottom portion of the reagent storage bag 10 does not protrude from a lower end of the side part 461 in a state where the frame member 23 is placed on an upper end of the side part 461. Thereby, the reagent storage bag 10 is hung without the bottom portion contacting an inner bottom surface of the storage box 451. The pair of side parts 461 have the same height as each other, and the lower surface 23g of the frame member 23 is placed on the upper ends of the pair of side parts 461.

A recess 465 is formed at a rear end portion of the protective member 460. The height of the upper ends of the rear part 462 and portions of the side parts 461 adjacent to the rear part 462 is lowered by one step by the recess 465. Thereby, the grip part 25 of the frame member 23 is largely exposed from the protective member 460, and the grip part 25 can be easily grasped when removing the reagent container 100 from the protective member 460. It is preferable that the rear part 462 and the portions of the side parts 461 adjacent to the rear part 462 are formed at a height such that substantially the entire grip part 25 is exposed in a state where the frame member 23 is placed on the pair of side parts 461. In other words, the recess 465 is formed by notching the rear part 462 and the portions of the side parts 461 adjacent to the rear part 462 so that substantially the entire grip part 25 is exposed.

The protective member 460 has a bent part 461a at a boundary portion between the pair of side parts 461, and has a shape that gradually tapers from the rear part 462 side toward the bent part 461a. The bent part 461a serves as a front end of the protective member 460 and forms one corner of the triangle. The pair of side parts 461 and the bent part 461a are formed by, for example, bending a single sheet of cardboard. The distance between the pair of side parts 461 gradually increases from the bent part 461a toward the rear part 462, and becomes maximum at the rear ends of the side parts 461, which are boundary portions with the rear part 462. The pair of side parts 461 have the same size as each other, and their outer shapes substantially coincide when superimposed.

The protective member 460 further has a first opening 463 formed largely from the bent part 461a at the front end toward the rear. The first opening 463 is formed across the pair of side parts 461 and is formed by largely notching the front end of the protective member 460 and the vicinity thereof. The first opening 463 reduces the rigidity of the side part 461 and imparts spring-like elasticity to the side part 461. The side part 461, for example, bends and elastically deforms when an external force in the vertical direction acts due to impact or vibration during transportation, thereby becoming able to absorb the impact or vibration. As a result, the force transmitted from the side part 461 to the reagent container 100 is alleviated, and damage to the reagent container 100 can be more effectively suppressed.

The protective member 460 further has bent parts, and is configured so that the protective member 460 deforms at the bent parts when an external force in the vertical direction is applied. In the present embodiment, two thin line-shaped bent parts 461b and 461c are formed on each of the pair of side parts 461. The bent parts 461b and 461c extend from the rear of the side part 461 toward an edge of the first opening 463, and impart elasticity to the side part 461 together with the first opening 463. Although details will be described later, the pair of side parts 461 bend at the bent parts 461b and 461c, and the protective member 460 deforms, whereby impact and vibration are absorbed.

The storage box 451 has a size capable of storing the reagent container 100 in a state of being protected by the protective member 460. The storage box 451 stores the entire reagent container 100 and the protective member 460 in a state where they are not exposed to the outside. Therefore, the storage box 451, similar to the protective member 460, protects the reagent container 100 during transportation of the reagent kit 450. However, the storage box 451 does not have a function of hanging the reagent storage bag 10 to suppress deformation of the bag like the protective member 460. The storage box 451 is, for example, a paper box having a rectangular parallelepiped shape and is composed of paper material similarly to the protective member 460.

The storage box 451 preferably has an internal space 451b of a size that can exactly store one reagent container 100. If the internal space 451b of the storage box 451 is too large, it is expected that the reagent container 100 may move due to impact or vibration during transportation and come off from the protective member 460; therefore, the internal space 451b is preferably small within a range that does not hinder storage of the reagent container 100 in a state of being protected by the protective member 460. The storage box 451 has a lid 451a, and is configured such that the reagent container 100 can be put into and taken out from the internal space 451b by opening the lid 451a.

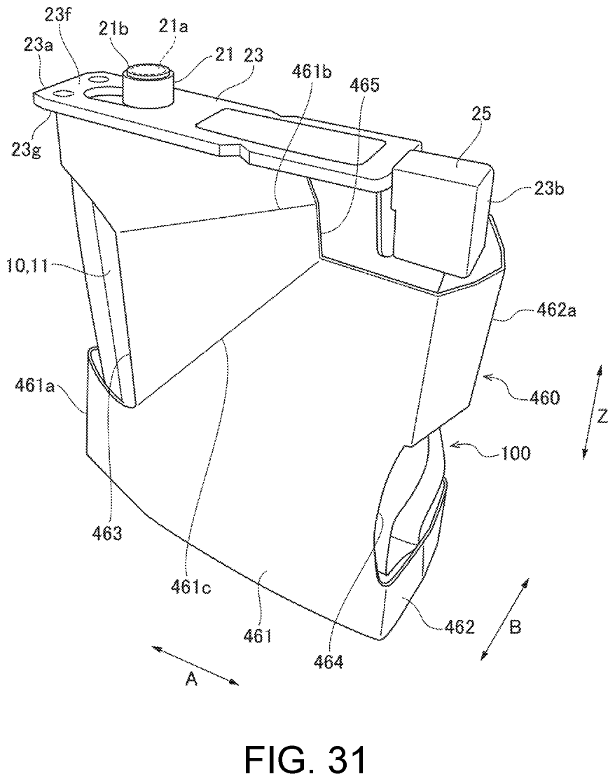

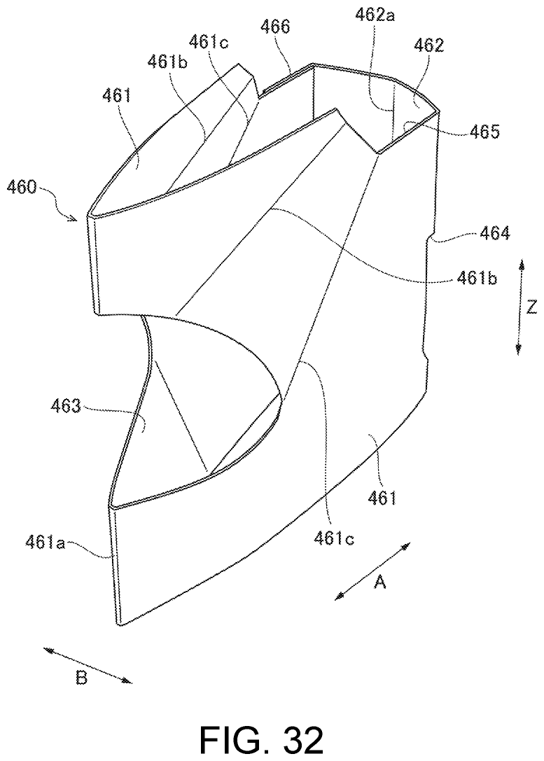

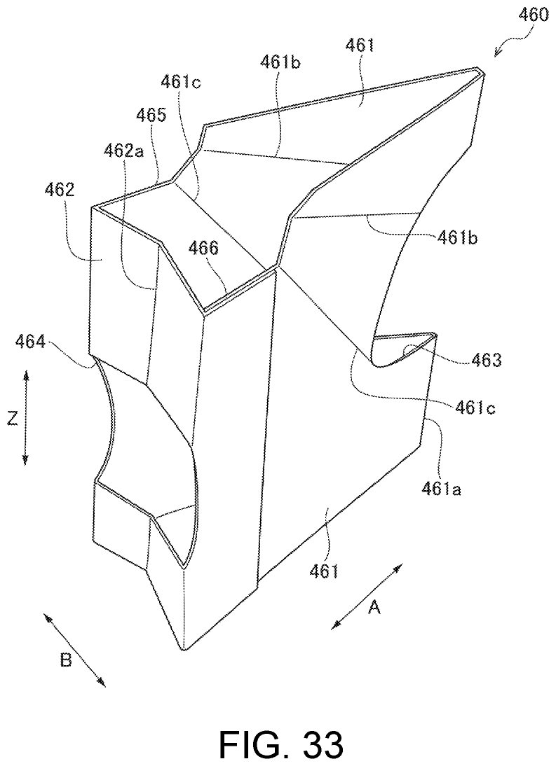

Hereinafter, the structure of the protective member 460 will be described in further detail with reference to FIGS. 31 to 34. FIG. 31 is a perspective view of the reagent kit 450 seen from the rear. FIG. 32 is a perspective view of the protective member 460 seen from the front, and FIG. 33 is a perspective view of the protective member 460 seen from the rear.

As shown in FIGS. 31 to 33, the protective member 460 includes the pair of side parts 461 and the rear part 462 connecting the rear ends of the side parts 461 to each other, and is formed in a cylindrical shape having a substantially triangular shape in a plan view. The pair of side parts 461 have the same size as each other, and since the width (B-direction length) of the rear part 462 along the B direction is smaller than the front-rear length (A-direction length) of the side part 461 along the A direction, the triangle is an isosceles triangle in which lengths of sides formed by the side parts 461 are equal. The width of the rear part 462 is, for example, 30% or more and 50% or less, and more preferably 35% or more and 45% or less of the front-rear length of the side part 461.

The protective member 460 is composed of a single sheet of cardboard and has a joint 466 for maintaining the cylindrical shape. The joint 466 is formed by forming a single sheet of cardboard into a cylindrical shape, superimposing end portions of the cardboard, and bonding them using an adhesive. A length of the joint 466 along the circumferential direction of the cylinder wall (overlapping width of cardboard) is, for example, 10 mm or more and 40 mm or less, or 15 mm or more and 35 mm or less. Further, the joint 466 is formed over the entire axial length of the cylinder wall at the portion where the joint 466 is formed.

The joint 466 is formed on the rear side of the protective member 460 away from the first opening 463. Although the position of the joint 466 is not particularly limited, a preferred example is a portion of the side part 461 adjacent to the rear part 462. Since the joint 466 is formed by superimposing two sheets of cardboard, it has higher rigidity compared to other portions and is less likely to deform. For this reason, it is preferable to form the joint 466 at the rear portion of the side part 461 rather than the front portion of the protective member 460 where elasticity is desired to be imparted by forming the first opening 463 and the bent parts 461b and 461c. Note that the joint 466 can also be formed using adhesive tape, a stapler, or the like.

The upper end position of the side part 461 is not constant as described above, and is lowered by one step in a range of a predetermined length from the rear end of the side part 461 by the recess 465 exposing the grip part 25. The predetermined length is set, for example, slightly longer than the length of the grip part 25 in the front-rear direction. Since the frame member 23 is placed on a portion of the side part 461 located between the front end and the recess 465, the upper end positions of the portions are preferably aligned. It is also preferable that the lower end positions of the side parts 461 are aligned, and in the present embodiment, the lower end positions of the pair of side parts 461 are aligned over the entire length. Further, the height of the pair of side parts 461 is constant from the front end of the side part 461 to the portion where the recess 465 is formed. In this case, the reagent container 100 can be supported more stably, and self-standing stability of the protective member 460 is also improved. The lower end position of the rear part 462 may be above the lower end positions of the side parts 461, or may be aligned with the lower end positions of the side parts 461.

As described above, the first opening 463 and the bent parts 461b and 461c are formed in the protective member 460. The first opening 463 is a large opening formed across the pair of side parts 461 at the front end of the protective member 460, and largely exposes the reagent storage bag 10. Further, the bent parts 461b and 461c are formed on each of the pair of side parts 461, one for each, making a total of four. The first opening 463 and the bent parts 461b and 461c are formed so as to overlap in the width direction (B direction) in the pair of side parts 461. That is, when the pair of side parts 461 are superimposed, the edges of the first opening 463 formed in each of them coincide, and the respective bent parts also coincide.

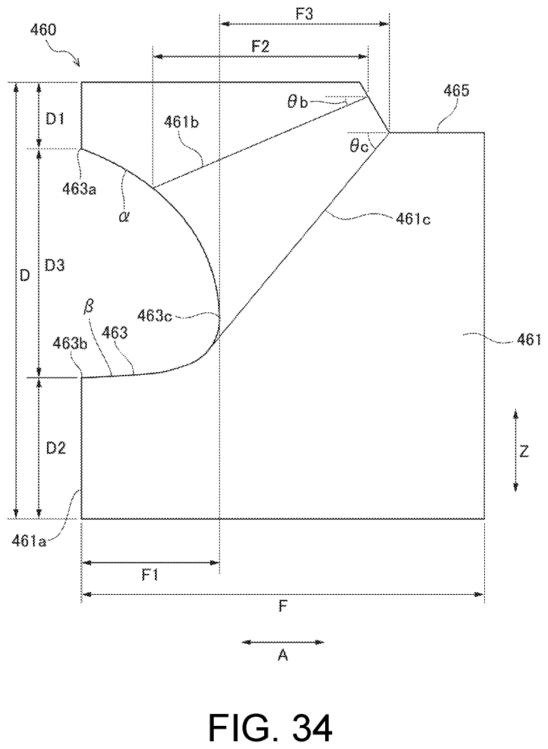

Hereinafter, FIG. 34 will be referred to as appropriate. FIG. 34 is a side view of the protective member 460. As shown in FIG. 34, the first opening 463 is formed in a substantially U-shape in a side view of the protective member 460. The first opening 463 gradually expands toward the front of the protective member 460 and becomes longer in the vertical direction. At intersection points of the bent part 461a and the edge of the first opening 463, there exist a first front edge 463a on the upper end side of the side part 461 and a second front edge 463b on the lower end side of the side part 461. A distance D1 between the upper end of the side part 461 and the first front edge 463a is the same as a distance D2 between the lower end of the side part 461 and the second front edge 463b, or the distance D1 is shorter than the distance D2. Further, at the edge of the first opening 463, a rear edge 463c closest to the rear part 462 is located between the lower end and the vertical center position of the side part 461.

The edge of the first opening 463 is formed in an arc shape. An arc α connecting the first front edge 463a and the rear edge 463c and an arc β connecting the second front edge 463b and the rear edge 463c differ in curvature, and the arc α has a larger degree of curvature than the arc β and has a larger average curvature. By curving the arc α more largely than the arc β, it is possible to more effectively absorb external force acting in the vertical direction due to impact or vibration during transportation of the reagent kit 450.

The vertical length D3 of the first opening 463 becomes maximum at the front end of the protective member 460. The maximum value of the vertical length D3 of the first opening 463 is, for example, 40% or more and 70% or less of the vertical length D of the side part 461, and more preferably 45% or more and 65% or less, or 50% or more and 60% or less, and may be larger than 50%. Further, the maximum value of the front-rear length F1 of the first opening 463 is, for example, 25% or more and 50% or less, and more preferably 30% or more and 45% or less of the front-rear length F of the side part 461. If the size of the first opening 463 is within this range, the reagent container 100 can be stably supported and impacts and vibrations that can act on the reagent container 100 can be more effectively absorbed.

As shown in FIGS. 31 to 33, the bent part 461b is slightly bent so as to be convex toward the inside of the protective member 460. The bent part 461b is a bent part that is long in the front-rear direction of the side part 461 and extends linearly, and is formed by putting a crease line in the side part 461. The bent part 461b is a portion that is valley-folded when viewed from the outside of the side part 461, and the side part 461 bends so as to be convex toward the inside at the bent part 461b when an external force in the vertical direction is applied, thereby absorbing the external force. The side part 461 can absorb the external force acting in the vertical direction by a change in the degree of bending at the bent part 461b.

The bent part 461c is slightly bent so as to be convex toward the outside of the protective member 460. The bent part 461c is a bent part extending linearly in a direction intersecting the front-rear direction and the vertical direction of the side part 461, and is formed by putting a crease line in the side part 461. The bent part 461c is a portion that is mountain-folded when viewed from the outside of the side part 461, and the side part 461 bends so as to be convex toward the outside at the bent part 461c when an external force in the vertical direction is applied, thereby absorbing the external force. The side part 461 can absorb the external force acting in the vertical direction by a change in the degree of bending at the bent part 461c.

The bent part 461b is inclined from the rear of the side part 461 toward the edge of the first opening 463 such that it is located lower as it approaches the first opening 463. The bent part 461b extends straight from the portion of the side part 461 where the recess 465 is formed over the arc α forming the edge of the first opening 463. Similarly, the bent part 461c is inclined from the rear of the side part 461 toward the edge of the first opening 463 such that it is located lower as it approaches the first opening 463. The bent part 461c extends straight from a portion of the side part 461 where the recess 465 is formed and which is at a position lower than the bent part 461b over a portion close to the rear edge 463c of the first opening 463 or the rear edge 463c of the arc β.

As shown in FIG. 34, an inclination angle θb of the bent part 461b with respect to the front-rear direction of the protective member 460 is smaller than an inclination angle θc of the bent part 461c. The angle θb is, for example, 10° or more and 30° or less, and more preferably 15° or more and 25° or less. An intersection of the bent part 461b and the arc α is located, for example, at a longitudinal center of the arc α, within a range of ±20% of the front-rear length F1 of the first opening 463 (length of the arc α) from the longitudinal center position of the arc α. Further, the angle θc is, for example, 30° or more and 70° or less, and more preferably 40° or more and 60° or less.

The bent part 461b extends from a vertical intermediate position of the recess 465 to the arc α of the first opening 463. Further, the bent part 461c extends from a lower end of the recess 465 to the rear edge 463c of the first opening 463 or the arc β. A front-rear length F2 of the bent part 461b is, for example, 40% or more and 65% or less of the front-rear length F of the side part 461, and may be larger than 50%. A front-rear length F3 of the bent part 461c is, for example, shorter than the front-rear length F2 of the bent part 461b, and is 30% or more and 55% or less of the front-rear length F of the side part 461, and may be less than 50%.

The bent parts 461b and 461c are inclined with respect to the front-rear direction so that a distance between them gradually increases from the rear toward the front of the protective member 460 as described above, and are connected to the edge of the first opening 463. By forming such bent parts 461b and 461c together with the first opening 463, spring-like elasticity can be imparted to the pair of side parts 461 supporting the reagent container 100, and external force acting in the vertical direction due to impact or vibration during transportation of the reagent kit 450 can be more effectively absorbed.

As shown in FIGS. 31 to 33, the protective member 460 further has a second opening 464. The second opening 464 opens toward the rear of the protective member 460 and is formed by notching the rear part 462. By forming the second opening 464, the rigidity of the rear portion of the protective member 460 can be moderately reduced, and spring-like elasticity can also be imparted to the rear portion. The second opening 464 is formed, for example, slightly on the lower end side of the rear part 462 with a vertical length of 30% or more and 60% or less of the vertical length of the rear part 462, or a vertical length of less than 50%.

The second opening 464 has a substantially rectangular shape when viewed from the rear of the rear part 462, and is formed over the entire width of the rear part 462. Further, vertically extending edges of the second opening 464 are formed at portions of the pair of side parts 461 adjacent to the rear part 462. That is, the second opening 464 is formed beyond the range of the rear part 462. The vertically extending edges of the second opening 464 are gently curved so as to be convex toward the front of the protective member 460. Thereby, the rear end portion of the protective member 460 easily bends when receiving an external force in the vertical direction, making it easy to absorb the external force.

A bent part 462a extending in the vertical direction is formed on the rear part 462. The bent part 462a extends straight in the vertical direction at a widthwise center of the rear part 462. Further, the bent part 462a is formed from an upper end of the rear part 462 to an upper edge of the second opening 464, and further from a lower edge of the second opening 464 to a lower end of the rear part 462. The bent part 462a enables folding of the rear part 462. If the rear part 462 can be folded, a bulk of the protective member 460 is significantly reduced, which is effective in transportation and storage of the protective member 460.

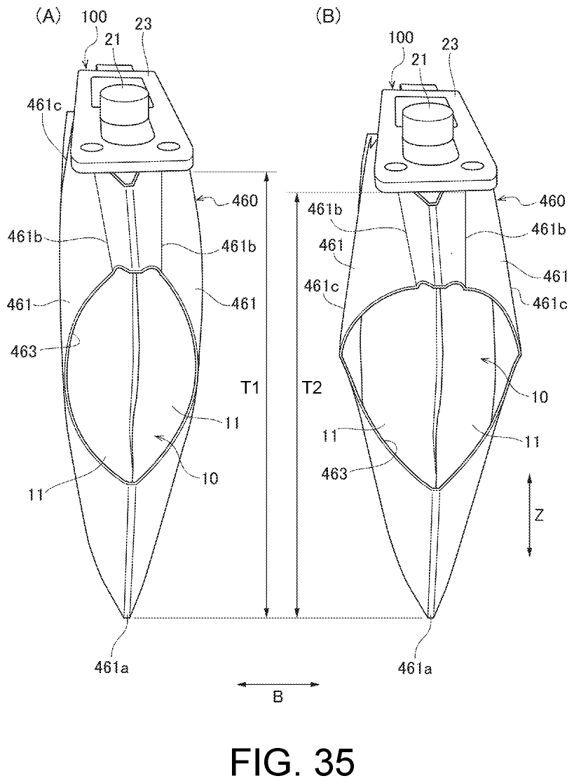

FIG. 35 is a view of the reagent kit 450 seen from the front, showing a stationary state (A) and a state (B) where an external force in the vertical direction is applied.

As shown in (A) of FIG. 35, the protective member 460 has a first shape configured to hang the reagent container 100 at a first height position T1 higher than a vertical length (height position) H1 of the reagent storage bag 10. As described above, the protective member 460 includes a container hanging structure. The container hanging structure includes a housing (the pair of side parts 461 and the rear part 462) having an internal space capable of housing the reagent storage bag 10 therein, an upper end of the housing is a support part (upper ends of the pair of side parts 461) configured to support the frame member 23, and a length T1 from the upper end to a lower end of the housing is longer than the vertical length H1 of the reagent storage bag 10. In the reagent container 100, as described above, the frame member 23 is placed on the upper ends of the pair of side parts 461, and the reagent storage bag 10 is hung in a state where a bottom portion of the reagent storage bag 10 is floating without protruding from the lower ends of the side parts 461. Here, the first height position T1 means a height of a portion of the side part 461 on which the frame member 23 is placed (the same applies to a second height T2 described later). When the protective member 460 has the first shape, that is, when the side part 461 is at the height position T1, the first opening 463 has a substantially elliptical shape elongated in the vertical direction when the protective member 460 is seen from the front. Note that the second height (length) T2 may be longer or shorter than the vertical length H1 of the reagent storage bag 10. However, from the viewpoint of effectively suppressing deformation or damage of the reagent storage bag 10, the second length T2 is preferably longer than the length H1.

As shown in (B) of FIG. 35, the protective member 460 is deformable into the first shape shown in (A) of FIG. 35 and a second shape configured to hang the reagent container 100 at a second height position T2 different from the first height position T1. The second shape of the protective member 460 is, for example, a shape in which the pair of side parts 461 supporting the reagent container 100 bend and the height becomes lower when an external force in the vertical direction is applied due to impact or vibration during transportation of the reagent kit 450. Further, the protective member 460 is elastically deformable like a spring, and when an external force in the vertical direction acts, it absorbs the external force by repeatedly deforming from the first shape to the second shape and returning to the first shape again.

In the second shape, compared to the first shape, the pair of side parts 461 bend largely at the bent parts 461b and 461c, and the first opening 463 expands in the B direction. In this way, by the elastic deformation of the protective member 460, impacts and vibrations during transportation of the reagent kit 450 can be absorbed. The protective member 460 is deformed into the first shape and the second shape by a change in degree of bending at the bent parts 461b and 461c. Further, even when the protective member 460 is deformed into the second shape, the hung state in which the reagent storage bag 10 is floating from the inner bottom surface of the storage box 451 is ensured. That is, according to the protective member 460, the impact and vibration transmitted to the reagent storage bag 10 are alleviated, and the hung state of the reagent storage bag 10 is always ensured. As a result, deformation and damage of the reagent storage bag 10 are effectively suppressed.

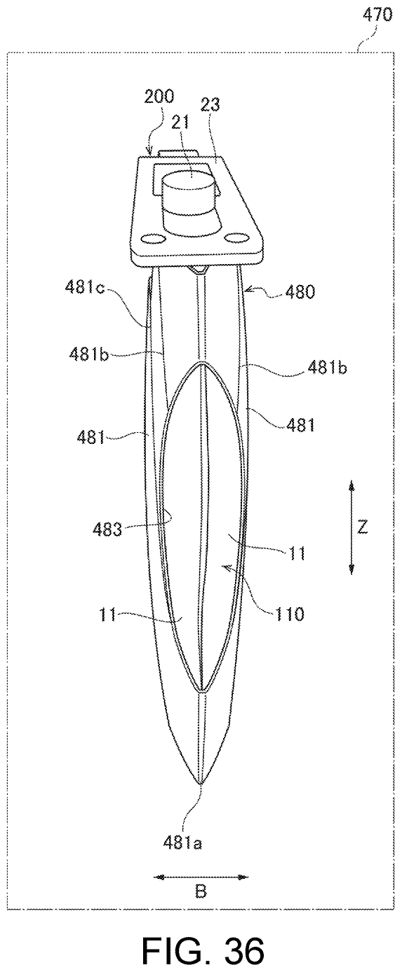

FIG. 36 is a view of a small-capacity reagent kit 470 as an example of an embodiment seen from the front.

As shown in FIG. 36, the reagent kit 470 comprises the reagent container 200 and a protective member 480 configured to protect the reagent container 200, similar to the reagent kit 450. The reagent kit 470 may further comprise a storage box configured to store the reagent container 200 and the protective member 480. The protective member 480 has a container hanging structure configured to hang the reagent storage bag 110 in a state where a bottom portion of the reagent storage bag 110 is not supported from its below and the opening 21a is sealed by the sealing plug 21b, thereby suppressing deformation of the reagent storage bag 110. Further, the protective member 480 is a self-standing object in a state of protecting the reagent container 200.

The protective member 480 has a similar shape to the protective member 460 of the reagent kit 450, but since the reagent storage bag 110 is smaller compared to the reagent storage bag 10 of the reagent container 100, the size of the protective member 480 is overall smaller than the protective member 460. In particular, since the reagent storage bag 110 has a small thickness, a maximum width (B-direction length) of the protective member 480 is equal to or smaller than the width of the frame member 23.

The protective member 480, similar to the protective member 460, comprises a pair of side parts 481 and a rear part formed so as to connect the side parts 481 to each other. The protective member 480 is configured by, for example, forming a single sheet of cardboard into a cylindrical shape, and has a tube shape that is triangular in a plan view. Further, the protective member 480 has a first opening 483 formed largely from a bent part 481a at a front end toward the rear. The first opening 483 is formed across the pair of side parts 481, appropriately reduces rigidity of the side part 481, and imparts spring-like elasticity to the side part 481. The pair of side parts 481 further have bent parts 481b and 481c inclined with respect to the front-rear direction so that a distance between them gradually increases from the rear toward the front of the protective member 480, and connected to an edge of the first opening 483.

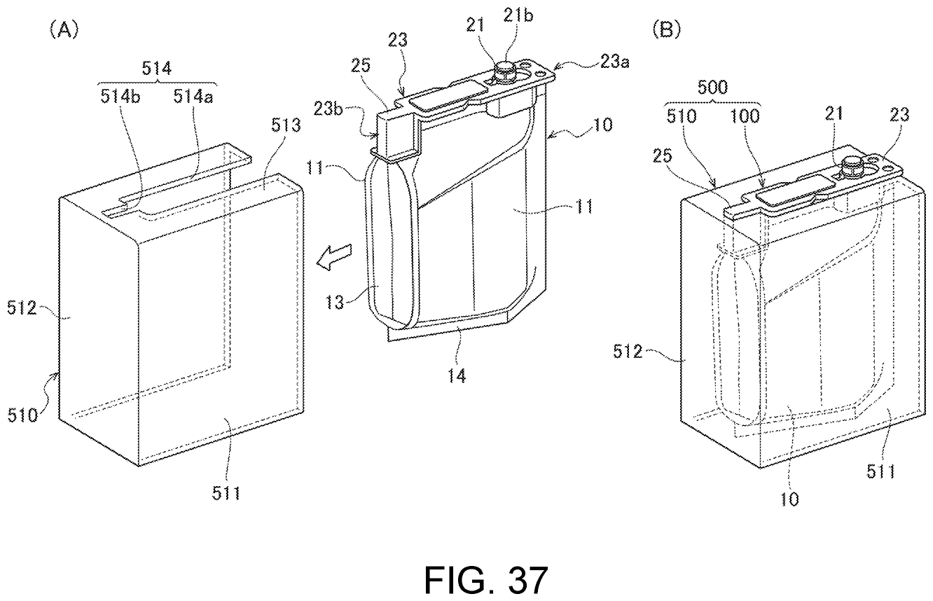

Hereinafter, modifications of the protective member 460 will be described with reference to FIGS. 37 to 41. Hereinafter, the same reference numerals are used for the same constituent elements as those in the above embodiment, and redundant descriptions are omitted.

A protective member 510 shown in FIG. 37 is common to the protective member 460 of the above embodiment in that it has a container hanging structure configured to hang the reagent storage bag 10 in a state where the bottom portion of the reagent storage bag 10 is floating. Further, the protective member 510, similar to the protective member 460, has a pair of side parts 511 and a rear part 512 connecting the side parts 511 to each other. On the other hand, the protective member 510 differs from the protective member 460 in that it has an upper part 513 connected to the pair of side parts 511 and the rear part 512 and does not have a cylindrical shape, whereas the protective member 460 is formed in a cylindrical shape as a whole and the reagent storage bag 10 is inserted into the internal space within the cylinder from an opening at one axial end.

As shown in (A) of FIG. 37, a groove-shaped opening 514 extending from a front end on an opposite side to the rear part 512 to a vicinity of the rear part 512 is formed in the upper part 513 of the protective member 510. The upper part 513 has a rectangular shape in a plan view elongated in the front-rear direction. The opening 514 extends straight along a longitudinal direction of the upper part 513 and narrows in the vicinity of the rear part 512. The opening 514 includes a first area 514a formed from the front end of the upper part 513 with a width that allows insertion of an upper portion of the reagent storage bag 10, and a second area 514b formed in the vicinity of the rear part 512 with a width that allows insertion of the grip part 25 of the frame member 23. A width of the first area 514a is smaller than the width of the frame member 23, so that when the upper portion of the reagent storage bag 10 is inserted into the first area 514a, both widthwise ends of the frame member 23 are supported on edges of the first area 514a of the upper part 513.

As shown in (B) of FIG. 37, in the reagent container 100, the reagent storage bag 10 is hung and held by the protective member 510 in a state where the bottom portion is floating from an inner bottom surface of the storage box 451 (see FIG. 30) or the like by inserting the upper portion of the reagent storage bag 10 into the opening 514 from the front end side of the upper part 513 with the grip part 25 of the frame member 23 as a leading end. The pair of side parts 511 has a height such that the bottom portion of the reagent storage bag 10 does not contact the inner bottom surface of the storage box 451 in a state where the upper portion of the reagent storage bag 10 is inserted into the opening 514 and the frame member 23 is supported by the upper part 513. According to the reagent kit 500 comprising the protective member 510, deformation of the reagent storage bag 10 during transportation or the like can be effectively suppressed, similar to the case of the reagent kit 450.

The protective member 510 may be made of hard resin or paper material. Further, a bent part for absorbing impact and vibration during transportation of the reagent kit 500 may be formed on the pair of side parts 511. The bent part imparts spring-like elasticity to the side part 511. The protective member 510 is deformed into a first shape and a second shape configured to hang the reagent container 100 at height positions different from each other, for example, by a change in degree of bending at the bent part.

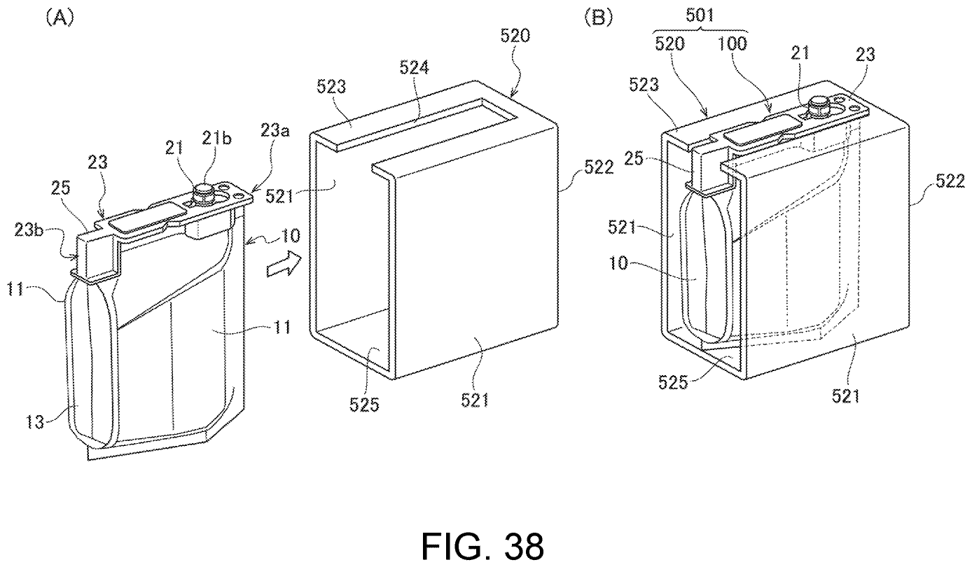

A protective member 520 shown in FIG. 38 includes a pair of side parts 521, a rear part 522, and an upper part 523, and has a structure similar to the protective member 510 as a whole. The protective member 520 has a bottom part 525 facing the upper part 523, but the bottom part 525 may be omitted. As shown in (A) of FIG. 38, a groove-shaped opening 524 extending from a front end on an opposite side to the rear part 522 to a vicinity of the rear part 522 is formed in the upper part 523. A width of the opening 524 is of a size that allows insertion of the upper portion of the reagent storage bag 10. The width of the opening 524 is smaller than the width of the frame member 23, so that when the upper portion of the reagent storage bag 10 is inserted into the opening 524, both widthwise ends of the frame member 23 are supported on edges of the opening 524 of the upper part 523.

As shown in (B) of FIG. 38, in the reagent container 100, the reagent storage bag 10 is hung and held by the protective member 520 in a state where the bottom portion is floating from the inner bottom surface of the storage box 451 or the like by inserting the upper portion of the reagent storage bag 10 into the opening 524 from the front end side of the upper part 523 with the plug member 21 side of the frame member 23 as a leading end. The pair of side parts 521 has a height such that the bottom portion of the reagent storage bag 10 does not contact the inner bottom surface of the storage box 451 in a state where the upper portion of the reagent storage bag 10 is inserted into the opening 524 and the frame member 23 is supported by the upper part 523. According to the reagent kit 501 comprising the protective member 520, deformation of the reagent storage bag 10 during transportation or the like can be effectively suppressed.

The protective member 520 differs from the protective member 510 in that the width of the opening 524 is constant over its entire length, and the plug member 21 side of the frame member 23 is arranged toward the rear part 522 side of the opening 524. In this case, when taking out the reagent container 100 from the protective member 520, the grip part 25 of the frame member 23 is arranged at the largely opened front end side of the protective member 520, which makes it easy to grasp the grip part 25 and facilitates handling of the reagent container 100. Note that the protective member 520 may be made of hard resin or paper material. Further, a bent part may be formed on the pair of side parts 521.

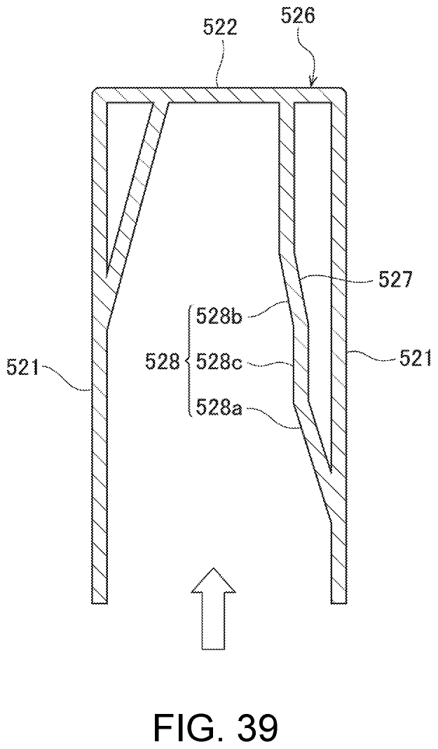

FIG. 39 is a cross-sectional view showing a protective member 526, which is a modification of the protective member 520. As shown in FIG. 39, the protective member 526 differs from the protective member 520 in that it has an inner wall 527 inside the side part 521, the inner wall 527 being formed with a pressing part 528 configured to press the reagent storage bag 10 from the outside. Note that the pressing part 528 may be formed on the side part 521, or an attachment having the pressing part 528 may be inserted into the protective member 520.

The pressing part 528 includes a first inclined surface 528a, an intermediate region 528c, and a second inclined surface 528b, and has a function of correcting the shape of the reagent storage bag 10. The shapes, arrangements, and the like of the first inclined surface 528a, the intermediate region 528c, and the second inclined surface 528b respectively correspond to the shapes, arrangements, and the like of the first inclined surface 351a, the intermediate region 351c, and the second inclined surface 351b constituting the pressing part 350 of the reagent container holder 251.

The protective member 526 has a container hanging structure configured to hang the reagent storage bag 10 in a state where a bottom portion of the reagent storage bag 10 is not supported from its below and the opening 21a is sealed by the sealing plug 21b, and a container pressing structure configured to press the reagent storage bag 10 from an outside. According to the protective member 526, the frame member 23 is supported by the upper part 523 to hang the reagent storage bag 10, and the reagent storage bag 10 is pressed from the outside by the pressing part 528. In this case, for example, the shape of the reagent storage bag 10 corrected by the pressing part 528 can be maintained.

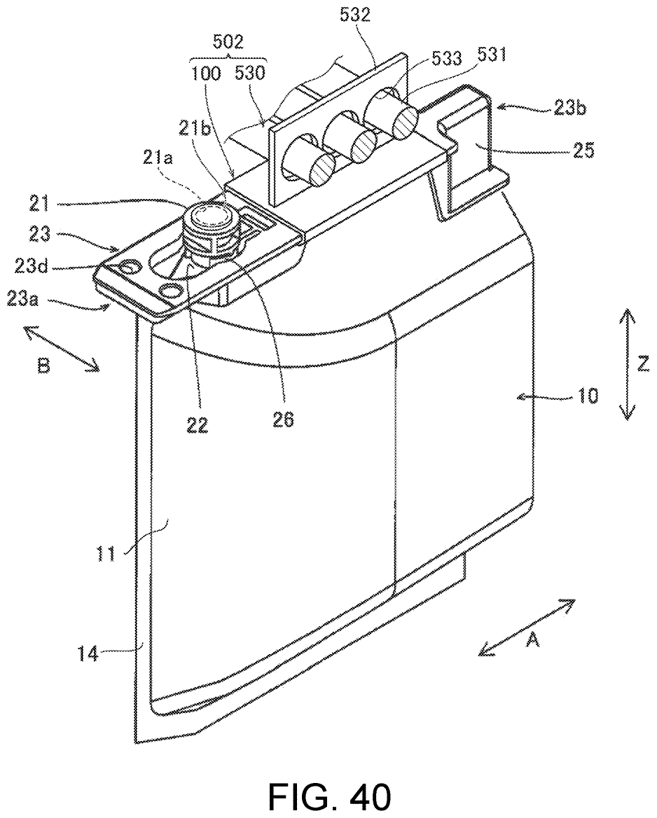

A protective member 530 shown in FIG. 40 has a plurality of support bars 531 for hanging and holding the reagent container 100. A hanging plate 532 formed with through holes 533 through which the support bars 531 are inserted is attached to the frame member 23 of the reagent container 100. The protective member 530 has three support bars 531, and three through holes 533 through which the support bars 531 are inserted one by one are formed in the hanging plate 532. The hanging plate 532 is, for example, detachably attached to the frame member 23 so that a portion where the through holes 533 are formed stands upright on the frame member 23 and the through holes 533 open in the B direction. According to the reagent kit 502 comprising the protective member 530, deformation of the reagent storage bag 10 during transportation or the like can be effectively suppressed.

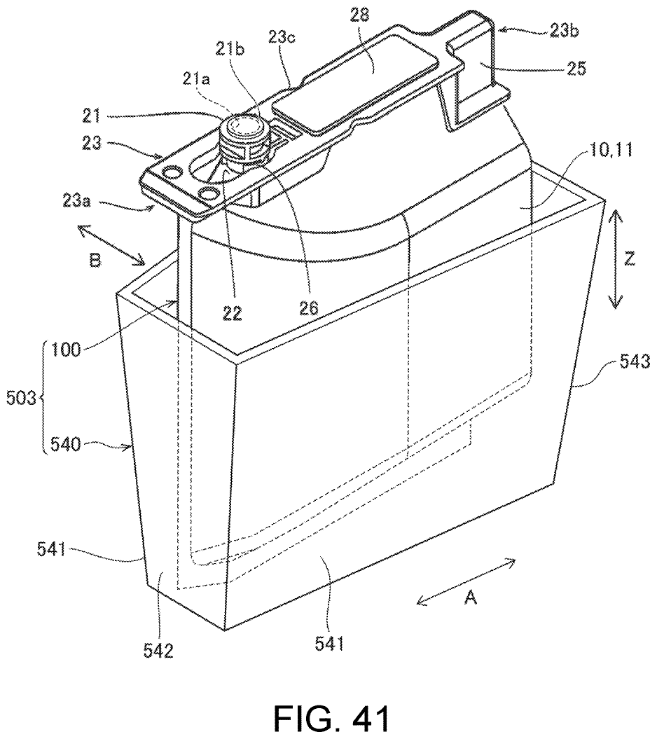

A protective member 540 shown in FIG. 41 has a container pressing structure configured to press the reagent storage bag 10 from an outside, while it does not have a hanging structure for the reagent storage bag 10. The protective member 540 has a pair of side parts 541 arranged to face each other, a front part 542, and a rear part 543 arranged to face the front part 542, and is formed in a rectangular tube shape as a whole. Note that the protective member 540 may have a bottom part and be formed in a bottomed cylindrical shape. The pair of side parts 541 are inclined so as to approach each other toward lower ends, and a peripheral length of the protective member 540 gradually decreases toward the lower ends. Further, a width (B-direction length) of the front part 542 is smaller than a width (B-direction length) of the rear part 543, and the protective member 540 tapers from the rear toward the front.

The pair of side parts 541 are configured to contact the surfaces of the reagent storage bag 10 and press the reagent storage bag 10 from the outside. The pair of side parts 541 are configured such that a distance between them at upper ends is larger than a maximum thickness of the reagent storage bag 10 and at lower ends is smaller than the maximum thickness of the reagent storage bag 10. Therefore, when the reagent storage bag 10 is inserted into the protective member 540 from above, the pair of side parts 541 sandwich the reagent storage bag 10 from both sides in the thickness direction (both sides in the B direction). Thereby, internal pressure of the reagent storage bag 10 increases, and deformation of the reagent storage bag 10 is suppressed. Therefore, according to the reagent kit 503 comprising the protective member 540, deformation of the reagent storage bag 10 during transportation or the like can be effectively suppressed.

Note that the design of the above-described embodiments and modifications can be changed as appropriate without impairing the object of the present disclosure. For example, in the above embodiment, the reagent container 100 is provided in a state of a reagent kit protected by a protective member, and the protective member is removed before the reagent container 100 is installed in the sample analyzer 300; however, it may be installed in the sample analyzer 300 in the state protected by the protective member. The reagent container 100 may comprise a second frame member used for hanging by the protective member, in addition to the frame member 23 that fits into the guide groove 270 of the sample analyzer 300. In this case, it is possible to install the reagent container 100 in the sample analyzer 300 while the reagent container 100 is protected by the protective member.

The reagent container 100 may also be provided without being held by the protective member; for example, it may be supplied in a state in which it is stored directly inside the storage box 451. In this case, the reagent storage bag 10 of the reagent container 100 may be significantly deformed during transportation, and its shape will be corrected by the pressing part of the analyzer 300.

Further, in the above embodiment, a seal film penetrable by the reagent aspiration tube 252 has been exemplified as the sealing plug 21b for the opening 21a of the reagent container 100, but the sealing plug may be a cap that is not penetrated by the reagent aspiration tube 252. In this case, it is preferable that a user removes the sealing plug before installing the reagent container 100 in the sample analyzer 300.

Further, in the above embodiment, a blood cell counter is exemplified as the sample analyzer, but the sample analyzer is not limited to this. The sample analyzer may be any apparatus that performs measurement of a sample using a flexible reagent storage bag and includes a pressing part configured to press the reagent storage bag from an outside in a reagent container holder. The sample analyzer may be, for example, a coagulation analyzer that performs blood coagulation analysis or an immunoassay apparatus. However, measurement by a blood cell counter is the most frequently performed test among blood tests, and the number of samples is larger than those of a coagulation analyzer and an immunoassay apparatus. Therefore, the consumption of the reagent is also large, and it is desired to increase the capacity of the reagent container. Since increasing the capacity of the reagent container lengthens a period of use after opening, it becomes more important to suppress deterioration of the reagent due to inflow of air into the reagent container. Therefore, the sample analyzer is preferably a blood cell counter. The reagent contains analytes according to a measurement principle of a sample by the sample analyzer, and is not limited to a staining liquid. However, for the same reason as above, the reagent is preferably a reagent for measurement by a blood cell counter.

What is claimed is:

1. A sample analyzer comprising:
a measurement sample preparator comprising a sample aspiration tube configured to aspirate a sample from a sample container and a reagent aspiration tube configured to aspirate a reagent from a reagent container, the measurement sample preparator configured to prepare a measurement sample from the sample aspirated by the sample aspiration tube and the reagent aspirated by the reagent aspiration tube;
a detector configured to detect signals corresponding to analytes in the measurement sample;
a controller comprising a processor, the controller configured to analyze the signals detected by the detector; and
a reagent container holder configured to hold the reagent container inserted therein, wherein the reagent container includes:
a reagent storage bag configured to contain the reagent, the reagent storage bag being made of flexible material and having an opening that allows the reagent aspiration tube to enter the reagent storage bag, and
a sealing plug configured to seal the opening, the sealing plug being penetrable by the reagent aspiration tube, and
the sample analyzer further comprises:
a pressing part configured to press the reagent storage bag from an outside in a state where the reagent storage bag is in the reagent container holder and the opening is sealed by the sealing plug.

2. The sample analyzer according to claim 1, wherein
the pressing part is configured to deform the reagent storage bag by pressing the reagent storage bag from outside so that an internal pressure of the reagent storage bag increases when the reagent storage bag is positioned inside the reagent container holder.

3. The sample analyzer according to claim 1, wherein
the pressing part is a part of the reagent container holder.

4. The sample analyzer according to claim 3, wherein
the pressing part is configured to press the reagent storage bag from outside while the reagent container is moving relative to the reagent container holder for inserting the reagent container into the reagent container holder.

5. The sample analyzer according to claim 3, wherein
the reagent container holder includes a first side wall and a second side wall opposite to the first side wall, wherein the first side wall and the second side wall constitute an internal space therebetween and an entrance of the internal space at one horizontal end of the first and second side walls,
the reagent container is inserted into the internal space until the opening is positioned on an inner area closer to the other horizontal end of the first and second side walls than the entrance of the internal space, and
the pressing part is a part of the first side wall and/or the second side wall.

6. The sample analyzer according to claim 5, wherein
the pressing part is not a part of the second side wall but a part of the first side wall.

7. The sample analyzer according to claim 6, wherein
the first side wall and the second side wall are configured such that the second side wall is disposed with a gap from a side surface of the reagent storage bag that has been inserted into the internal space.

8. The sample analyzer according to claim 6, wherein
the first side wall includes, as the pressing part, an oblique part that is inclined with respect to an insertion direction of the reagent container into the internal space, and
the oblique part is formed between the entrance of the internal space and the inner area of the internal space, whereby
at an area on the oblique part, the first side wall gradually approaches the second side wall toward the inner area of the internal space.

9. The sample analyzer according to claim 8, wherein
the oblique part includes a first oblique part and a second oblique part, wherein the first oblique part is disposed at a position closer to the entrance of the internal space than the second oblique part, and
an angle between the insertion direction and an inclination of the second oblique part is smaller than an angle between the insertion direction and an inclination of the first oblique part.

10. The sample analyzer according to claim 9, wherein
the first side wall includes a region parallel to the insertion direction of the reagent container between the first oblique part and the second oblique part.

11. The sample analyzer according to claim 10, wherein
the position on which the first oblique part is disposed is between the entrance of the internal space and a horizontal intermediate position of the first side wall.

12. The sample analyzer according to claim 1, wherein
the pressing part is detachably configured from the reagent container holder.

13. The sample analyzer according to claim 1, wherein
the reagent container further comprises a frame member provided on an upper portion of the reagent storage bag, and
the reagent container holder includes a guide configured to guide the frame member for inserting the reagent container into the reagent container holder.

14. The sample analyzer according to claim 1, wherein
the reagent aspiration tube has rigidity enabling the reagent aspiration tube to penetrate the sealing plug.

15. The sample analyzer according to claim 1, wherein
the reagent aspiration tube includes a sealing body configured to seal the opening when the reagent aspiration tube is fully inserted in an interior of the reagent storage bag.

16. The sample analyzer according to claim 15, wherein
the reagent container holder is configured to hold the reagent container in a state where a bottom portion of the reagent storage bag is not supported from below and the opening is sealed by the sealing plug.

17. The sample analyzer according to claim 1, wherein
the reagent container holder is disposed at a position accessible from a front side of the sample analyzer.

18. The sample analyzer according to claim 1, comprising
a plurality of the reagent container holders;
a plurality of the reagent aspiration tubes, the plurality of the reagent aspiration tubes corresponding respectively to the plurality of the reagent container holders; and
a plurality of the pressing parts, the plurality of the pressing parts corresponding respectively to the plurality of the reagent container holders.

19. The sample analyzer according to claim 1, wherein
the detector is configured to detect the signals corresponding to blood cells as the analytes in the measurement sample, and
the controller is configured to analyze the signals detected by the detector to count the blood cells.

20. A reagent container to be held in the reagent container holder of the sample analyzer according to claim 1, the reagent container comprising:
the flexible reagent storage bag, and
the sealing plug.
